(19) United States
(12) Patent Application Publication
(10) Pub. No.: US 2017/0164214 A1
(43) Pub. Date: Jun. 8, 2017

(54) COMMUNICATION SYSTEM, MOBILE TERMINAL, AND COMMUNICATION METHOD

(71) Applicant: FUJITSU LIMITED, Kawasaki-shi (JP)

(72) Inventor: Yasushi Hara, Kunitachi (JP)

(73) Assignee: FUJITSU LIMITED, Kawasaki-shi (JP)

(21) Appl. No.: 15/345,624

(22) Filed: Nov. 8, 2016

(30) Foreign Application Priority Data
Dec. 4, 2015 (JP) 2015-237871

(51) Int. Cl. H04W 24/02; H04W 76/02; H04B 17/318; H04B 7/155; H04W 4/00; H04W 76/00; H04L 29/08

(52) U.S. Cl. CPC H04W 24/02; H04W 76/002; H04W 76/021; H04L 67/06; H04B 7/15507; H04W 4/008; H04B 17/318; H04W 84/12

(57) ABSTRACT

A communication system includes: a first relay device; a transmitter; and a mobile terminal. The first relay device communicates via a first wireless communication scheme. The transmitter forms a signal reachable range set such that the signal reachable range coincides with a possible communication range of the first relay device, via a third wireless communication scheme, and broadcasts a signal including identification information. The mobile terminal includes: a first communication circuit configured to connect with the first relay device via the first wireless communication scheme; a third communication circuit configured to receive a signal including the identification information used by the transmitter via the third wireless communication scheme; and a control circuit configured to instruct the first communication circuit to start operation, when the signal including the identification information used by the transmitter is received via the third wireless communication scheme.

### CROSS-REFERENCE TO RELATED APPLICATION

This application is based upon and claims the benefit of priority of the prior Japanese Patent Application No. 2015-237871, filed on Dec. 4, 2015, the entire contents of which are incorporated herein by reference.

### FIELD

The embodiments discussed herein are related to a communication system, a mobile terminal, and a communication method.

### BACKGROUND

Wireless gigabit (WiGig) is the communication standard that uses a millimetre waveband of 60 GHz. WiGig is capable of high-speed wireless transmission up to 7 Gbps. A possible communication distance of WiGig is approximately 10 m. Thanks to such a high speed, WiGig enables transmission of uncompressed moving images for high-definition television broadcasting.

FIG. 1 is an example of a communication system in which WiGig is used. A communication system P100 includes a WiFi AP P2, a WiGig AP P4, and a controller P5. The possible communication distance of the WiFi AP P2 is 30 m, for example. Since the possible communication distance of WiGig is shorter than that of WiFi, multiple WiGig APs P4 are deployed in the possible communication range of the WiFi AP P2. The communication system P100 provides a service to download a certain moving image file to a mobile terminal P1 when the mobile terminal P1 enters the possible communication range of each WiGig AP P4.

To receive the service provided by the communication system P100, for example, the mobile terminal P1 is set to be on in automatic download of a desired moving image file is by a predetermined application. When entering the possible communication range of the WiFi AP P2 and establishing connection with the WiFi AP P2, the mobile terminal P1 switches on a WiGig module. When a user of the mobile terminal P1 moves and enters the possible communication range of any of the WiGig APs P4, the mobile terminal P1 detects the WiGig AP P4, establishes connection with the WiGig AP P4, and downloads a moving image file targeted for automatic download by way of WiGig.

For example, WiGig enables download of a moving image file of ultra high-definition television (8K) of 30 seconds at a WiGig communication speed of 2 Gbps to be completed in approximately 1 second.

As an example of the related art, Japanese Laid-open Patent Publication No. 2006-319878 is known.

### SUMMARY

According to an aspect of the invention, a communication system includes: a mobile terminal; a first relay device configured to communicate via a first wireless communication scheme; and a transmitter configured to form a signal reachable range set such that the signal reachable range coincides with a possible communication range of the first relay device, via a third wireless communication scheme, and to broadcast a signal including identification information. The mobile terminal includes: a first communication circuit configured to connect with the first relay device via the first wireless communication scheme; a third communication circuit configured to receive a signal including the identification information used by the transmitter via the third wireless communication scheme; and a control circuit configured to instruct the first communication circuit to start operation, when the signal including the identification information used by the transmitter is received via the third wireless communication scheme.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an example of a communication system in which WiGig is used,

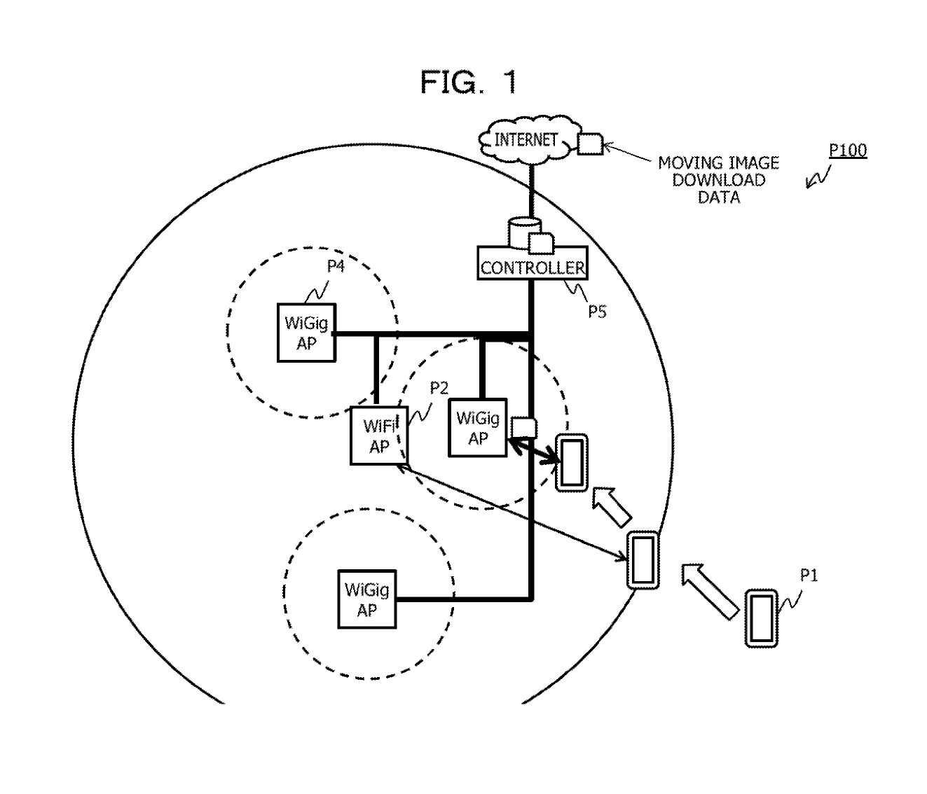

FIG. 2 is a diagram illustrating an example of a system configuration of a communication system according to a first embodiment;

FIG. 3 is a diagram illustrating an example of a timing chart of operation of each communication module of a mobile terminal according to the first embodiment;

FIG. 4 is a diagram illustrating an example of a hardware configuration of the mobile terminal;

FIG. 5 is a diagram illustrating an example of a hardware configuration of a BLE terminal;

FIG. 6 is a diagram illustrating an example of a functional configuration of the communication system according to the first embodiment;

FIG. 7 is a diagram illustrating an example of an index stored in a download data cache of a controller;

FIG. 8 is an example of a BLE-WiGig association table held by the controller;

FIG. 9A is an example of a flow chart of processing of a control unit of a mobile terminal;

FIG. 9B is an example of a flow chart of processing of the control unit of the mobile terminal;

FIG. 10 is a diagram illustrating an example of a pre-order process of a download file of the mobile terminal;

FIG. 11A is an example of a flow chart of processing after authentication of a mobile terminal of a controller is completed;

FIG. 11B is an example of a flow chart of processing when the controller receives communication from the mobile terminal;

FIG. 12 is an example of a flow chart of processing when a WiGig AP receives communication from the controller;

FIG. 13 is an example of a flow chart of processing when the WiGig AP receives a download request from the mobile terminal;

FIG. 14A is a diagram illustrating an example of a sequence of a service provision process in the communication system according to the first embodiment;

FIG. 14B is a diagram illustrating an example of the sequence of the service provision process in the communication system according to the first embodiment;

FIG. 15A is a diagram illustrating an example of the sequence of the service provision process in the communication system according to the first embodiment;

FIG. 15B is a diagram illustrating an example of the sequence of the service provision process in the communication system according to the first embodiment;

FIG. 16 is a diagram illustrating an example of processing in a communication system according to a variation of the first embodiment;

FIG. 17 is an example of a flow chart of processing of a mobile terminal according to the variation of the first embodiment;

FIG. 18 is a diagram illustrating an example of a sequence of a service provision process in the communication system according to the variation of the first embodiment;

FIG. 19 is a diagram illustrating an example of a timing chart of operation of each communication module of a mobile terminal according to a second embodiment;

FIG. 20 is a diagram illustrating an example of a functional configuration of a communication system according to the second embodiment;

FIG. 21 is a diagram illustrating an example of an index to be stored in a download data cache of a controller according to the second embodiment;

FIG. 22 is an example of a BLE-WiGig association table held by the controller according to the second embodiment;

FIG. 23A is an example of a flow chart of processing of a control unit of a mobile terminal;

FIG. 23B is an example of a flow chart of processing of the control unit of the mobile terminal;

FIG. 24A is an example of a flow chart of processing to be performed by a controller according to the second embodiment after authentication of the mobile terminal is completed;

FIG. 24B is an example of a flow chart of processing of the controller according to the second embodiment when receiving communication from a BLE terminal;

FIG. 25 is an example of a flow chart of processing of the BLE terminal;

FIG. 26A is a diagram illustrating an example of a sequence of a service provision process in the communication system according to the second embodiment;

FIG. 26B is a diagram illustrating an example of a sequence of the service provision process in the communication system according to the second embodiment;

FIG. 26C is a diagram illustrating an example of a sequence of the service provision process in the communication system according to the second embodiment;

FIG. 27A is a diagram illustrating an example of a sequence of the service provision process in the communication system according to the second embodiment;

FIG. 27B is a diagram illustrating an example of a sequence of the service provision process in the communication system according to the second embodiment;

FIG. 28A is an example of a flow chart of processing to be performed by a controller according to a variation of the second embodiment after authentication of a mobile terminal is completed;

FIG. 28B is an example of a flow chart of processing of the controller according to the variation of the second embodiment when receiving communication from a BLE terminal;

FIG. 29 is a flow chart of processing of the BLE terminal according to the variation of the second embodiment when receiving communication from the controller;

FIG. 30 is an example of a flow chart of processing of the BLE terminal according to the variation of the second embodiment when receiving a BLE beacon;

FIG. 31 is an example of a BLE beacon reception list according to the variation of the second embodiment;

FIG. 32A is a diagram illustrating an example of a sequence of a service provision process of a communication system according to the variation of the second embodiment; and

FIG. 32B is a diagram illustrating an example of a sequence of a service provision process of a communication system according to the variation of the second embodiment.

### DESCRIPTION OF EMBODIMENTS

The conventional technology described above has a problem that WiGig entails large power consumption for transmission and reception of data. WiGig has high directionality due to high-speed communications, and a transmission side and a reception side perform beamforming to become in phase with each other. Beamforming is one factor for an increase in the power consumption for data transmission and reception of WiGig. For example, power consumption for reception of a WiGig chip is 960 mW. For example, power consumption for transmission of the WiGig chip is 1190 mW. Compared with power consumption for reception of a WiFi chip of 400 mW, for example, it is seen that the power consumption for transmission and reception of WiGig is large. For example, when a mobile terminal P1 stays for 30 minutes in a possible communication range of a WiFi AP P2 of a communication system P100, the WiGig chip consumes electric power of at least 480 mWh since the WiGig chip performs at least reception operation of AP detection for 30 minutes. The electric energy of 480 mWh is equivalent to approximately 4% of the battery capacity of a general mobile terminal.

Although power consumption (W) for data transmission is large, WiGig may consume small electric energy (Wh) data transmission, since a time period for data transmission is short as described above. On the other hand, WiGig may consume large electric energy (Wh) for data reception, since a time period for data reception is long due to detection of the possible communication range of WiGig AP. Note that this problem is not limited to WiGig but may occur in wireless communication standards with large power consumption for data transmission and reception.

As one aspect of the present embodiment, provided are solutions for being able to reduce power consumption of a mobile terminal for detection of a possible communication range in a wireless communication scheme.

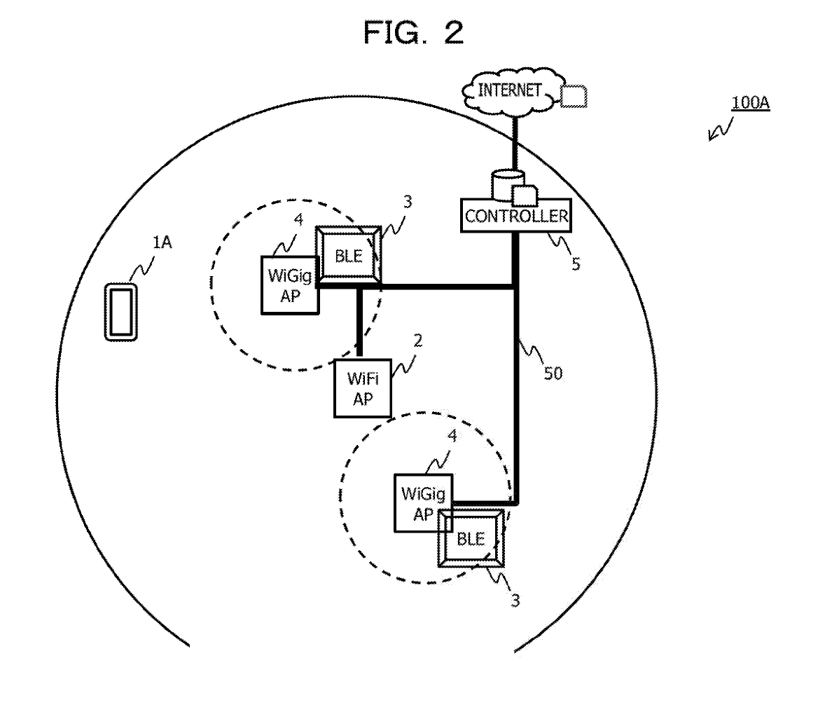

Embodiments of the present disclosure are described hereinafter with reference to the drawings. Configurations of the following embodiments are illustrative and the present disclosure is not limited to the configurations of the embodiments.

<First Embodiment> FIG. 2 is a diagram illustrating an example of a system configuration of a communication system according to a first embodiment. A communication system 100A includes a mobile terminal 1A, a WiFi AP 2, a BLE terminal 3, a WiGig AP 4, and a controller 5. The WiGig AP 4 and the BLE terminal 3 are installed at an almost same position. For example, the WiGig AP 4 and the BLE terminal 3 are installed on a same steel pole. A plurality of pairs of the WiGig AP 4 and the BLE terminal 3, and the mobile terminal 1A are present in the communication system 100A. The WiFi AP 2, the WiGig AP 4, and the controller 5 are connected by way of a LAN 50, for example.

The communication system 100A provides the mobile terminal 1A file download service by way of the WiGig AP 4. The file download service by WiGig is hereinafter referred to as WiGig service.

The BLE terminal 3 is a terminal configured to broadcast a BLE beacon. Bluetooth low energy (hereinafter BLE) is one of the Bluetooth (registered trademark) 4.0 standards, which is one of wireless personal area network (PAN) technologies. The BLE terminal 3 may be a stationary standalone device, an external device to be connected to the WiGig AP 4 through Universal Serial Bus (USB) connection, or a device incorporated in the WiGig AP 4, for example. In the first embodiment, it does not matter whether or not the BLE terminal 3 is connected to the LAN 50.

The mobile terminal 1A is a smart phone, a tablet terminal, a wearable terminal, for example. The mobile terminal 1A has a communication capability under WiFi, WiGig, and Bluetooth (registered trademark). With a reception capability of Bluetooth, the mobile terminal 1A receives a BLE beacon broadcasted from the BLE terminal 3.

A reachable range of a BLE beacon (BLE beacon reachable range) is approximately 10 m. A possible communication range of WiGig is also approximately 10 m. The BLE beacon reachable range and the WiGig beacon are of almost same size. The reachable range of the WiGig beacon is equal to the possible communication range of WiGig. In the first embodiment, the BLE beacon is used to detect the possible communication range of the WiGig AP 4, by taking advantage of the fact that the BLE beacon reachable range is of almost same size as the possible communication range of WiGig.

More specifically, in the first embodiment, the BLE terminal 3 and the WiGig AP 4 are installed at a same position, and the center axes of the possible communication range of the WiGig AP 4 and the BLE beacon reachable range of the BLE terminal 3 are set at the same position. Also in the first embodiment, strengths of broadcasted signals of the possible communication range of the WiGig AP 4 and the BLE beacon reachable range of the BLE terminal 3 are set so that the possible communication range of the WiGig AP 4 and the BLE beacon reachable range of the BLE terminal 3 are of same size.

With this, the possible communication range of the WiGig AP 4 almost coincides with the BLE beacon reachable range of the BLE terminal 3. The possible communication range of the WiGig AP 4 and the BLE beacon reachable range of the BLE terminal 3 being set to be same, reception of the BLE beacon from the BLE terminal 3 indicates that the mobile terminal is present in the possible communication range of the WiGig AP 4.

Therefore, in the first embodiment, when the mobile terminal 1A receives the BLE beacon broadcasted from the BLE terminal 3, which is installed at the same position as the WiGig AP 4, the mobile terminal 1A causes operation of the WiGig module to start. With this, when the mobile terminal 1A causes the operation of the WiGig module to start, the mobile terminal 1A is present in the possible communication range of the WiGig AP 4, and a time period for the mobile terminal 1A to detect the WiGig AP 4 may be made shorter. More specifically, the period time for the mobile terminal 1A to cause the WiGig module to operate may be reduced, and power consumption of the mobile terminal 1A may be reduced.

In addition, the possible communication range of the WiGig AP 4 or the WiFi AP 2 and the BLE beacon reachable range are respectively a range in which a beacon signal of each wireless communication scheme is received at received signal strength of a value larger than a threshold that is recognized as being capable of communication. Note that the possible communication range of the WiGig AP 4 and the BLE beacon reachable range of the BLE terminal 3 may not coincide with each other perfectly. The possible communication range of the WiGig AP 4 and the BLE beacon reachable range of the BLE terminal 3 may differ in size within a predetermined allowable range as far as one may encompass the other.

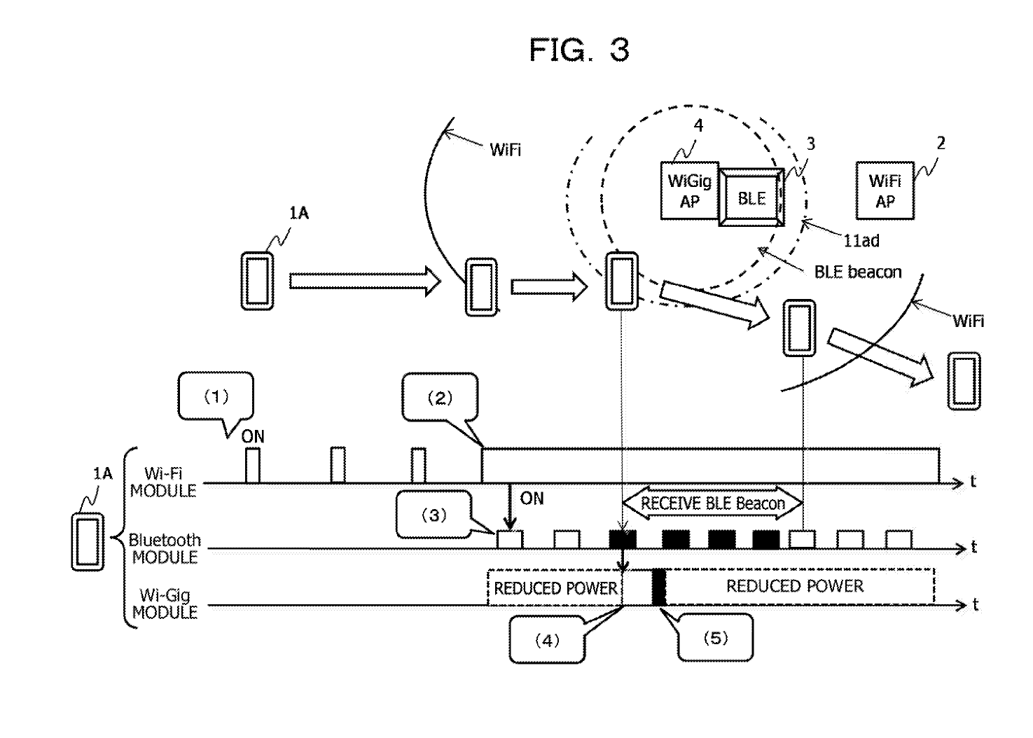

FIG. 3 is a diagram illustrating an example of a timing chart of operation of each communication module of the mobile terminal 1A according to the first embodiment. In FIG. 3 is illustrated a timing chart of operation of three modules of a WiFi module, a Bluetooth module, and a WiGig module, as a communication module of the mobile terminal 1A.

In FIG. 3, the WiFi AP 2, and the pair of the BLE terminal 3 and the WiGig AP 4 of the communication system 100A of FIG. 2, and one mobile terminal 1A are extracted and illustrated. Arcs by solid lines in FIG. 3 represent the possible communication range of the WiFi AP 2. A circle by a dashed line in FIG. 3 represents the BLE beacon reachable range broadcasted by the BLE terminal 3. An arc by a dot-and-dash line in FIG. 3 represents the possible communication range of the WiGig AP 4. While the BLE beacon reachable range and the possible communication range of the WiGig AP 4 are set so that center axes and size of the circles are almost same, for convenience, FIG. 3 illustrates so that the possible communication range of the WiGig AP 4 encompasses the BLE beacon reachable range.

(1) When the mobile terminal 1A is present out of the possible communication range of the WiFi AP 2, the WiFi module searches for WiFi AP 2 in a predetermined cycle. A cycle in which the mobile terminal 1A searches for a WiFi AP of the WiFi module is a fixed or variable cycle from 10 seconds to 3 minutes, for example. Triggered by a screen switching ON, the cycle of the search for a WiFi AP may change to 10 seconds, 20 seconds, 60 seconds, or 180 seconds, for example, every time the search is performed.

(2) When it is detected that the mobile terminal 1A enters the possible communication range of the WiFi AP 2, a connection sequence is started between the mobile terminal 1A and the WiFi AP 2, and authentication of the mobile terminal 1A is performed. In the first embodiment, the controller 5 shall operate as an authentication server. In the first embodiment, authentication of WiGig is also performed together with authentication of WiFi for the mobile terminal 1A. After the connection sequence starts, the WiGig module is continuously in an ON state.

When the authentication of the mobile terminal 1A succeeds and connection with the WiFi AP 2 is established, the controller 5 notifies the mobile terminal 1A of a WiGig service environment notice indicating that the WiGig service is provided in the possible communication range of the WiFi AP 2. A WiGig service environment notice is notified by way of the WiFi AP 2. The WiGig service environment notice includes information identifying a source broadcasting a BLE beacon such as an UUID or the like used by the BLE terminal 3. The BLE beacon includes identification information of the broadcast source that makes it possible for a device that receives a BLE beacon to identify presence of a possible communication range.

(3) When receiving the WiGig service environment notice, the mobile terminal 1A causes reception operation of the Bluetooth module to start. The reception operation of the Bluetooth module is, for example, an intermittent operation to turn ON a reception state of the Bluetooth module for a predetermined time length at a predetermined cycle. A cycle of the intermittent reception operation of the Bluetooth module is 300 mS, for example, and operating time per session is 30 mS. Note that the reception operation of the Bluetooth module is not limited to the intermittent operation, and may also be a steady operation that maintains the ON state on a steady basis.

(4) When a user of the mobile terminal 1A moves to a direction approaching the BLE terminal 3 and the mobile terminal 1A enters the BLE beacon reachable range of the BLE terminal 3, the mobile terminal 1A receives a BLE beacon broadcasted from the BLE terminal 3. When receiving the BLE beacon broadcasted from the BLE terminal 3, the mobile terminal 1A detects that the mobile terminal 1A enters the possible communication range of the WiGig AP 4, and causes operation of the WiGig module to start. Since the mobile terminal 1A is already present in the possible communication range of the WiGig AP 4 when the mobile terminal 1A causes the operation of the WiGig module to start. Thus, when the mobile terminal 1A searches for WiGig, the mobile terminal 1A detects the WiGig AP 4. Then, a connection sequence between the mobile terminal 1A and the WiGig AP 4 is started.

(5) When the connection is established between the mobile terminal 1A and the WiGig AP 4, the mobile terminal 1A starts downloading data such as a moving image file, or the like. When the downloading is completed, the mobile terminal 1A stops the reception operation of the WiGig module.

Then, when the mobile terminal 1A detects exit from the possible communication range of the WiFi AP 2, the mobile terminal 1A stops the reception operation of the Bluetooth module.

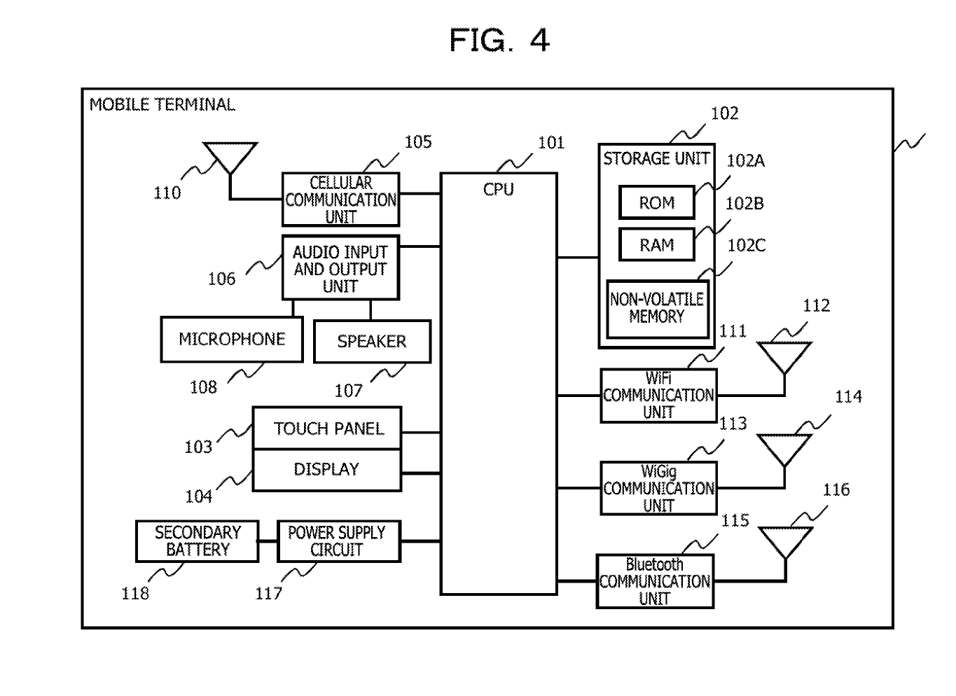

In the first embodiment, the WiGig module enters the ON state and operates from (4) when the mobile terminal 1A enters the possible communication range of WiGig till (5) the downloading is completed. Thus, the operating time of the WiGig module may be reduced. In addition, power consumption for the reception operation of the WiGig module is 960 mW, for example. On the other hand, power consumption for the reception operation of the Bluetooth module is 100 mW, for example. The power consumption may be kept low by using the Bluetooth module instead of WiGig, to detect the possible communication range of WiGig.

<Device Configuration> FIG. 4 is a diagram illustrating an example of a hardware configuration of the mobile terminal 1A. The mobile terminal 1A is a smart phone, a tablet terminal, a wearable terminal, or the like, for example. The mobile terminal 1A includes a central processing unit (CPU) 101, a storage unit 102, a touch panel 103, a display 104, a cellular communication unit 105, an audio input and output unit 106, a speaker 107, a microphone 108, a cellular antenna 110, a WiFi communication unit 111, a WiFi antenna 112, a WiGig communication unit 113, a WiGig antenna 114, a Bluetooth communication unit 115, a Bluetooth antenna 116, a power supply circuit 117, and a secondary battery 118. The mobile terminal 1A is an example of a “mobile terminal”. Each unit included in the mobile terminal 1A may be formed as a circuit or circuitry, which may incorporate one or more of electronic devices such as a processor, a memory device.

The storage unit 102 includes a read only memory (ROM) 102A, a random access memory (RAM) 102B, and a non-volatile memory 102C. The RAM 102B is a volatile memory and provides the CPU 101 a working area. The ROM 102A is non-volatile and stores an OS, a preinstalled application, system data, or the like. The non-volatile memory 102C is a flash memory, for example.

The non-volatile memory 102C stores an application acquired through user manipulation, user data, or the like. In the non-volatile memory 102C is stored a service benefit program for receiving service that detects a possible communication range of WiGig, using a BLE and downloads data from WiGig. The service benefit program is downloaded and acquired from an application download site, for example.

The touch panel 103 is one of position input devices, is arranged on a surface of the display 104, and is configured to input coordinates of a position touched by a finger that corresponds to the screen of the display 104. The touch panel 103 may be any of an electrostatic capacitance type, a resistive type, a surface acoustic wave type, an infrared type, or an electromagnetic induction type or the like.

The display 104 is a liquid crystal display (LCD), for example. The display 104 displays screen data according to a signal to be inputted from the CPU 101.

The cellular communication unit 105 is connected with the cellular antenna 110. The WiFi communication unit 111 is connected with the WiFi antenna 112. The WiGig communication unit 113 is connected with the WiGig antenna 114. The Bluetooth communication unit 115 is connected with the Bluetooth antenna 116 and complies with the Bluetooth 4.0 standard. The cellular communication unit 105, the WiFi communication unit 111, the WiGig communication unit 113, and the Bluetooth communication unit 115, are a module including an electronic circuit that is configured to make an exchange with a wireless signal and an electric signal, depending on each communication standard. The cellular communication unit 105 is an electronic circuit associated with any one or more of wireless communication networks of carriers of, for example, the third-generation mobile communication system, the second-generation mobile communication system, Long-Term Evolution (LTE), or the like. In the first embodiment, a description is given on the assumption that the cellular communication unit 105 and the cellular antenna 110 are associated with the LTE. WiGig is an example of a “first wireless communication scheme”. The WiGig communication unit 113 is an example of a “first communication unit”. WiFi is an example of a “second wireless communication scheme”. The WiFi communication unit 111 is an example of a “second communication unit”. The Bluetooth 4.0 is an example of a “third wireless communication scheme”. The Bluetooth communication unit 115 is an example of a “third communication unit”. Note that the second wireless communication scheme may be a various wireless communication scheme developed by the 3GPP (3rd Generation Partnership Project) such as LTE (Long-Term Evolution) and 5G. The second communication unit may be the cellular communication unit 105.

The audio input and output unit 106 is connected with the speaker 107 as a voice-output device and the microphone 108 as a voice-input device. The audio input and output unit 106 converts an audio signal inputted from the microphone 108 into an electric signal and outputs the electric signal to the CPU 101, or converts an electric signal inputted from the CPU 101 into an audio signal and outputs the audio signal to the speaker 107.

The CPU 101 performs various processes by unrolling a program stored in the ROM 102A or the non-volatile memory 102C in the RAM 102B and executing an unrolled instruction. The CPU 101 receives input from any of the touch panel 103, the cellular communication unit 105, the audio input and output unit 106, the WiFi communication unit 111, the WiGig communication unit 113, or the Bluetooth communication unit 115 and performs a predetermined process. The CPU 101 outputs a result of the predetermined process to any of the storage unit 102, the display 104, the cellular communication unit 105, the audio input and output unit 106, the WiFi communication unit 111, the WiGig communication unit 113, or the Bluetooth communication unit 115. The CPU 101 is an example of a “control unit” of a “mobile terminal”.

The power supply circuit 117 connects to other hardware element (not illustrated) and supplies electric power from the secondary battery 118 to the other hardware element. The secondary battery 118 is a lithium-ion battery, for example.

Note that a hardware configuration of the mobile terminal 1A is not limited to the hardware configuration illustrated in FIG. 4, and may be appropriately subjected to a change such as addition, replacement, deletion, or the like. For example, the mobile terminal 1A may include a portable recording medium drive device configured to drive a portable recording medium, in addition to the configuration illustrated in FIG. 4. A portable recording medium is an SD card, a microSd card or the like, for example. The mobile terminal 1A is an example of a “mobile terminal”.

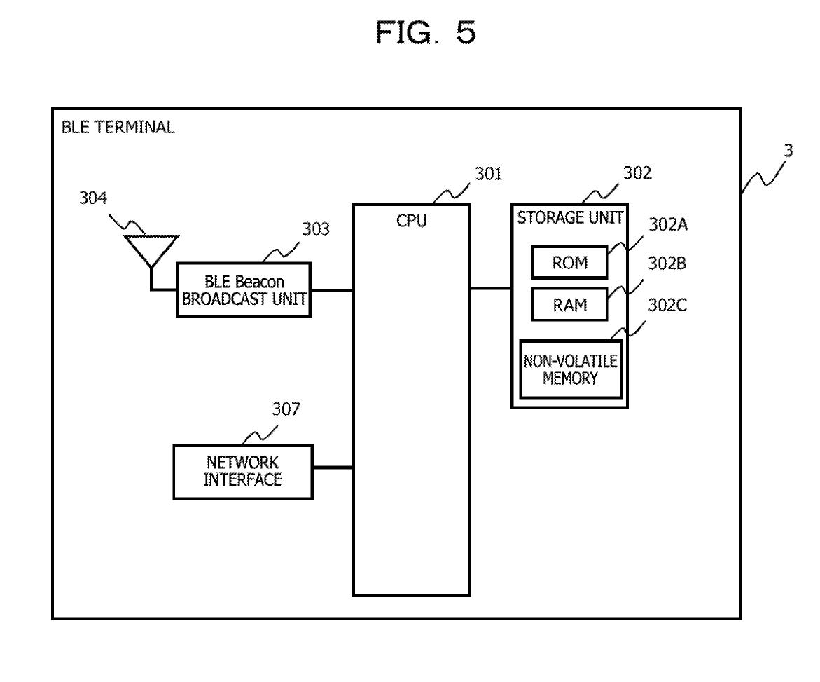

FIG. 5 is a diagram illustrating an example of a hardware configuration of the BLE terminal 3. FIG. 5 illustrates the hardware configuration of the BLE terminal 3 as a standalone device. The BLE terminal 3 includes a CPU 301, a storage unit 302, a BLE communication unit 303, a Bluetooth antenna 304, and a network interface 307. The storage unit 302 includes a ROM 302A, a RAM 302B, and a non-volatile memory 302C. A description of the CPU 301 and the storage unit 302 is similar to a description of the CPU 101 and the storage unit 102 in FIG. 4 and thus omitted. The BLE communication unit 303 is a module including a broadcast circuit and a reception circuit of a BLE beacon. The network interface 307 is an interface connecting to the LAN 50, and is a network interface card (NIC), for example.

The hardware configuration of the BLE terminal 3 is not limited to FIG. 5 and may be appropriately subjected to a change such as addition, replacement, deletion, or the like, according to an embodiment. Note that if the BLE terminal 3 is a device that does not perform any process other than broadcasting of a BLE beacon, the network interface 307 may not be provided desirably. In addition, if the BLE 3 is a device that performs any process other than broadcasting of a BLE beacon, a Bluetooth module that complies with the Bluetooth 4.0 and includes a BLE module may be provided, in place of the BLE communication unit 303. The BLE terminal 3 is an example of a “transmitter”.

The hardware configuration of the WiFi AP 2 and the WiGig AP 4 is a configuration having a CPU, a RAM, a ROM, a non-volatile memory, a WiFi communication unit or a WiGig communication unit, a WiFi antenna or a WiGig antenna, and a network interface, for example. The controller 5 is a dedicated or general-purpose computer. The hardware configuration of the controller 5 is a configuration having a CPU, a RAM, a ROM, a non-volatile memory, and a network interface, for example. The controller 5 stores in the non-volatile memory a service provision program for providing the mobile terminal 1A with information in the communication system 100A. The WiFi AP 2 is an example of a “second relay device”. The WiGig AP 4 is an example of a “first relay device”. The controller 5 is an example of a “management device”.

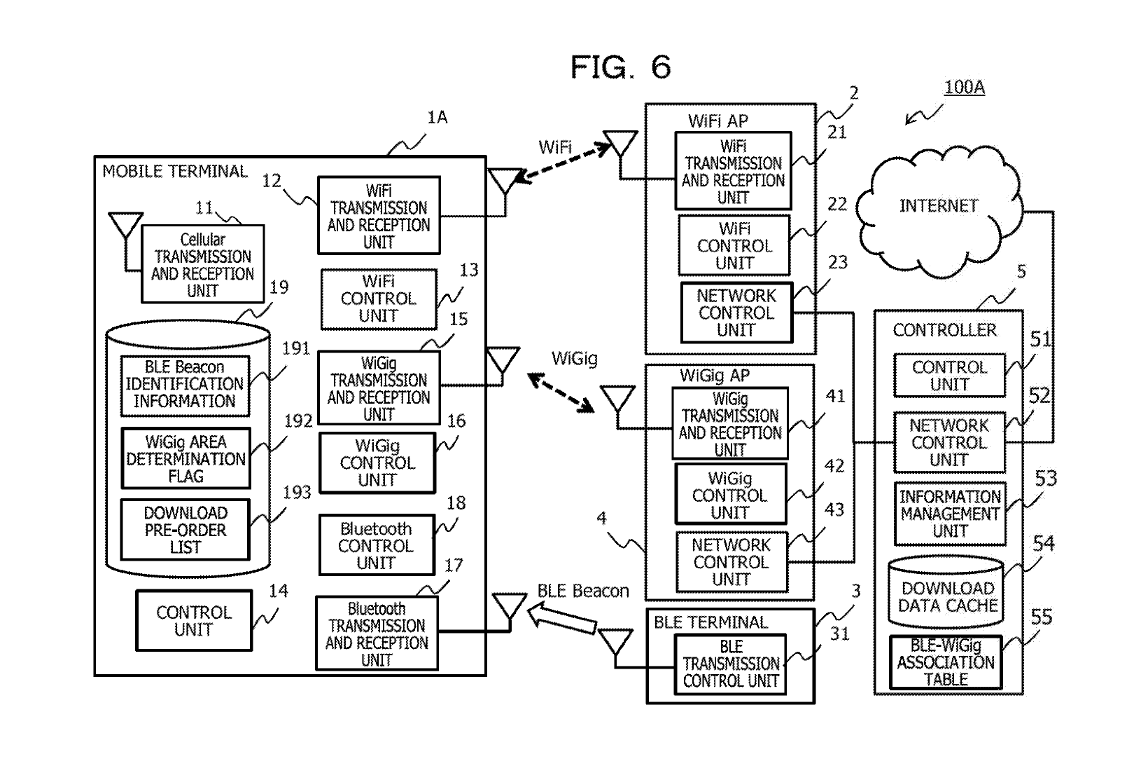

FIG. 6 is a diagram illustrating an example of a functional configuration of the communication system 100A according to the first embodiment. The mobile terminal 1A includes, as a functional configuration, a cellular transmission and reception unit 11, a WiFi transmission and reception unit 12, a WiFi control unit 13, a control unit 14, a WiGig transmission and reception unit 15, a WiGig control unit 16, a Bluetooth transmission and reception unit 17, a Bluetooth control unit 18, and an information storage unit 19. The cellular transmission and reception unit 11 has a functional configuration corresponding to the cellular communication unit 105 and the cellular antenna 110. The WiFi transmission and reception unit 12 has a functional configuration corresponding to the WiFi communication unit 111 and the WiFi antenna 112. The WiGig transmission and reception unit 15 has a functional configuration corresponding to the WiGig communication unit 113 and the WiGig antenna 114. The Bluetooth transmission and reception unit 17 has a functional configuration corresponding to the Bluetooth communication unit 115 and the Bluetooth antenna 116.

The WiFi control unit 13 has a functional configuration that is achieved by the CPU 101 executing a WiFi-related module included in an OS. The WiFi control unit 13 controls the WiFi transmission and reception unit 12. More specifically, the WiFi control unit 13 gives an instruction to perform scanning to the WiFi transmission and reception unit 12, detects entry or exit from the possible communication range of the WiFi AP 2, relays data between the WiFi transmission and reception unit 12 and other functional configurations, or the like. When detecting any of the entry and exit to and from the possible communication range of the WiFi AP 2, the WiFi control unit 13 notifies the control unit 14.

The WiGig control unit 16 has a functional configuration that is achieved by the CPU 101 executing a WiGig-related module included in an OS. The WiGig control unit 16 controls the WiGig transmission and reception unit 15. More specifically, the WiGig control unit 16 instructs the WiGig transmission and reception unit 15 to perform scanning and perform a process to connect with and disconnect from the WiGig AP 4, and relays data between the WiGig transmission and reception unit 15 and other functional configurations, or the like.

The Bluetooth control unit 18 has a functional configuration that is achieved by the CPU 101 executing a Bluetooth-related module included in an OS. The Bluetooth control unit 18 controls the Bluetooth transmission and reception unit 17. More specifically, the Bluetooth control unit 18 performs a process related to establishment of connection with other Bluetooth compatible devices, relays data between the Bluetooth transmission and reception unit 17 and other functional configurations, or the like.

The control unit 14 has a functional configuration that is achieved by the CPU 101 executing a service benefit program. The control unit 14 controls starting and stopping of operation of the Bluetooth transmission and reception unit 17 and the WiGig transmission and reception unit 15. More specifically, if a starting condition or stopping condition of Bluetooth reception operation is satisfied, the control unit 14 instructs the Bluetooth control unit 18 to start or stop the reception operation of the Bluetooth transmission and reception unit 17.

The starting condition of the Bluetooth reception operation is, for example, that connection with the WiFi AP 2 is established, and that there is a WiGig service environment in the possible communication range of the WiFi AP 2. The stopping condition of the Bluetooth reception operation is, for example, that connection with the WiFi AP 2 is disconnected.

When a starting condition or stopping condition of a WiGig operation is satisfied, the control unit 14 instructs the WiGig control unit 16 to start or stop an operation of the WiGig transmission and reception unit 15. The starting condition of the WiGig operation is that the mobile terminal 1A is present in the possible communication range of the WiGig AP 4, and that download pre-order of a predetermined file is set. In the first embodiment, presence in the possible communication range of the WiGig AP 4 is synonymous with reception of a BLE beacon from the BLE terminal 3 corresponding to the WiGig service. However, the starting condition of WiGig reception operation is not limited to this, and setting of download pre-order of a predetermined file may not be included in the condition.

The stopping condition of the WiGig reception operation in the first embodiment is completion of downloading of a pre-ordered file. However, the stopping condition of the WiGig reception operation is not limited to this, and may be presence out of the possible communication range of the WiGig AP 4. In the first embodiment, presence out of the possible communication range of the WiGig AP 4 is synonymous with no longer receiving a BLE beacon from the BLE terminal 3 associated with the WiGig service.

In addition, if download pre-order is set, the control unit 14 transmits to the controller 5 information on a download target file when receiving a notice that connection with the WiFi AP 2 is established and there is the WiGig service environment in the WiFi AP 2. With this, the controller 5 acquires the download target file before the mobile terminal 1A enters the possible communication range of the WiGig AP 4. In addition, even if download pre-order is not set, the control unit 14 transmits to the controller 5 the information on the download target file provided that the connection with the WiFi AP 2 is established and there is the WiGig service environment when the download pre-order is made through user manipulation. The information on the download target file is transmitted to the controller 5 by download file information or a download start notice. Details of the download file information or the download start notice are described below.

The information storage unit 19 has a functional configuration corresponding to the non-volatile memory 102C. The information storage unit 19 stores BLE beacon identification information 191, a WiGig area determination flag 192, and a download pre-order list 193. The BLE beacon identification information 191 is information that is for identifying a broadcast source and that is included in a BLE beacon broadcasted from the BLE terminal 3 associated with the WiGig service. The BLE beacon identification information 191 is stored in the control unit 14, when the control unit 14 is notified upon establishment of connection with the WiFi AP 2 via WiFi that the WiGig service environment is in the possible communication range of the WiFi AP 2.

The BLE beacon identification information 191 is UUID, Major, or Minor, for example. UUID is a 128-bit identification number that is used in BLE and unique to an organization. Major and Minor are respectively 16-bit identification numbers indicating a major classification and a minor classification within an UUID organization. For example, in a shopping mall, UUID, Major, and Minor are respectively used to identify a shopping mall, identify a shop in the shopping mall, and identify a BLE transmitter in the shop. A combination of UUID, Major, and Minor is identification information of a broadcast source of a BLE beacon. A BLE beacon is an example of a “signal via a third wireless communication scheme”. Identification information of a BLE beacon is an example of “identification information identifying a broadcast source of a signal via the third wireless communication scheme”.

The WiGig area determination flag 192 is a flag indicating whether or not the mobile terminal 1A is present in the possible communication range of the WiGig AP 4. For example, when the WiGig area determination flag 192 is 1, it indicates that the mobile terminal 1A is present in the possible communication range of the WiGig AP 4. When the WiGig area determination flag 192 is 0, it indicates that the mobile terminal 1A is present out of the possible communication range of the WiGig AP 4. The WiGig area determination flag 192 is controlled by the control unit 14.

The download pre-order list 193 holds information on a download target file. For example, information on a download target file includes a file name of the download target file, a URL for the file, or the like. A download target file is displayed on the display 104 through execution of the service benefit program and specified by a user.

The WiFi AP 2 includes, as a functional configuration, a WiFi transmission and reception unit 21, a WiFi control unit 22, and a network control unit 23. The WiFi transmission and reception unit 21 corresponds to a WiFi antenna and a circuit for WiFi processing. The WiFi control unit 22 and the network control unit 23 are respectively a functional configuration that is achieved by a CPU of the WiFi AP 2 executing an OS. The WiFi control unit 22 relays between the network control unit 23 and the WiFi transmission and reception unit 21. The network control unit 23 relays between an interface of the LAN 50 and the WiFi control unit 22.

The BLE terminal 3 has a BLE transmission control unit 31 as a functional configuration. The BLE transmission control unit 31 has a functional configuration that is achieved by a CPU 301 of the BLE terminal 3 executing an OS installed in the BLE terminal 3. The BLE transmission control unit 31 controls a transmission circuit of a BLE beacon. More specifically, the BLE transmission control unit 31 broadcasts a BLE beacon including preset BLE beacon identification information in a predetermined cycle. BLE beacon identification information is stored in a non-volatile memory installed in the BLE terminal 3. A broadcasting cycle of BLE beacons is 100 ms, for example, and a time period for broadcast per session is a few milliseconds.

The WiGig AP 4 includes, as a functional configuration, a WiGig transmission and reception unit 41, a WiGig control unit 42, and a network control unit 43. The WiGig transmission and reception unit 41 corresponds to a WiGig antenna and a circuit for WiGig processing. The WiGig control unit 42 and the network control unit 43 are respectively a functional configuration that is achieved by a CPU of the WiGig AP 4 executing an OS. The WiGig control unit 42 relays between the network control unit 43 and the WiGig transmission and reception unit 41. The network control unit 43 relays between an interface with the LAN 50 and the WiGig control unit 42.

The controller 5 includes, as a functional configuration, a control unit 51, a network control unit 52, an information management unit 53, a download data cache 54, and a BLE-WiGig association table 55. The network control unit 52 is a function to be achieved by a CPU executing an OS. The network control unit 52 controls a network interface.

The control unit 51 and the information management unit 53 are a functional configuration that is achieved by a CPU executing a service provision program in a non-volatile memory. The control unit 51 performs an authentication process as an authentication server, as one of processes to be performed. The control unit 51 receives an authentication request of the mobile terminal 1A by way of the WiFi AP 2, and transmits a WiGig service environment notice notifying the mobile terminal 1A that there is the WiGig service environment in the possible communication range of the WiFi AP 2.

A WiGig service environment notice is delivered to the mobile terminal 1A through the LAN 50 and the WiFi AP 2. The WiGig service environment notice includes, for example, BLE beacon identification information used by the BLE terminal 3 that is installed at an almost same position as the WiGig AP 4. When there is a plurality of WiGig APs 4 within the communication system 100A, the WiGig service environment notice includes the BLE beacon identification information used by each of the BLE terminals 3 installed at the same position for all WiGig APs 4.

In addition, when receiving information on a download target file from the mobile terminal 1A through the WiFi AP 2, the control unit 51 acquires a target file from the corresponding server. In order to cache data acquired from the corresponding server, the control unit 51 transfers the data to the WiGig AP 4 in the possible communication range of which the mobile terminal 1A is present.

If the WiGig AP 4 in the possible communication range of which the mobile terminal 1A is present is not known, the control unit 51 stores a file acquired from the corresponding server in a download data cache 54 through the information management unit 53. Then, when receiving a download start notice from the mobile terminal 1A, the control unit 51 reads a target file from the download data cache 54 and transmits the file to the WiGig AP 4.

The control unit 51 notifies the information management unit 53 of terminal identification information and an IP address of the mobile terminal 1A WiFi authentication of which succeeds. The terminal identification information of the mobile terminal 1A is a MAC address, for example. The information management unit 53 stores in the download data cache 54 the terminal identification information and the IP address of the mobile terminal 1A that are received from the control unit 51. Then, when receiving a download target file from the control unit 51, the information management unit 53 relates the download target file to the terminal identification information and the IP address of the mobile terminal 1A and stores the download target file in the download data cache 54.

The download data cache 54 is created in a non-volatile memory of the controller 5. The download data cache 54 is managed by the information management unit 53. The download data cache 54 relates a download target file to the terminal identification information and the IP address of the mobile terminal 1A and holds the download target file. When transmission of the download target file to the mobile terminal 1A is completed, the association of the terminal identification information and the IP address of the mobile terminal 1A with the download target file is deleted from the download data cache 54 by the information management unit 53. Then, the file itself may be left in the download data cache 54.

The BLE-WiGig association table 55 is stored in advance in a non-volatile memory. The BLE-WiGig association table 55 holds association of identification information of the WiGig AP 4 with identification information of the BLE terminal 3 that is arranged at a same position as the WiGig AP 4. In the first embodiment, as identification information of the BLE terminal 3, BLE beacon identification information used by the BLE terminal 3 is used.

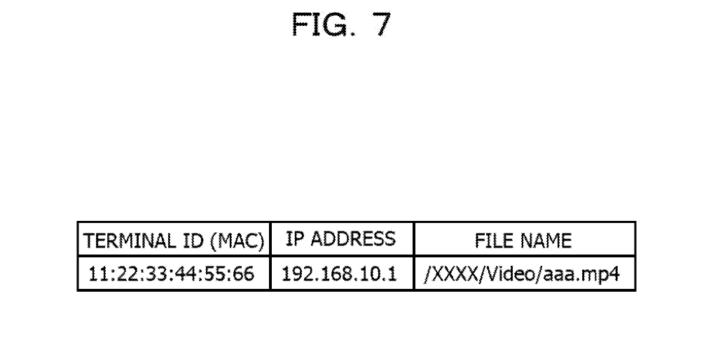

FIG. 7 is a diagram illustrating an example of an index stored in the download data cache 54 of the controller 5. Association of terminal identification information and IP address of the mobile terminal 1A with a download target file is performed in an index of the download data cache 54.

In the first embodiment, in an index of the download data cache 54, terminal identification information of the mobile terminal 1A authenticated by the controller 5, an IP address of the mobile terminal 1A, and a download target file name of the mobile terminal 1A are associated and stored. In the first embodiment, a MAC address is used for the terminal identification information of the mobile terminal 1A. The terminal identification information and the IP address of the mobile terminal 1A are acquired by an authentication process of the mobile terminal 1A. The file name of the download target file is acquired from a notice of information on the download target file from the mobile terminal 1A.

Note that information included in the download data cache 54 illustrated in FIG. 7 is an example, and information included in the download data cache 54 is not limited to the information illustrated in FIG. 7.

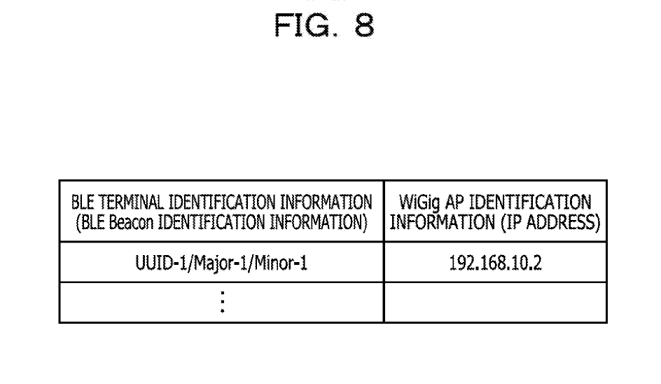

FIG. 8 is an example of the BLE-WiGig association table 55 held by the controller 5. The BLE-WiGig association table 55 stores association of identification information of the BLE terminal 3 with identification information of WiGig AP at a same position of which the BLE terminal 3 is arranged.

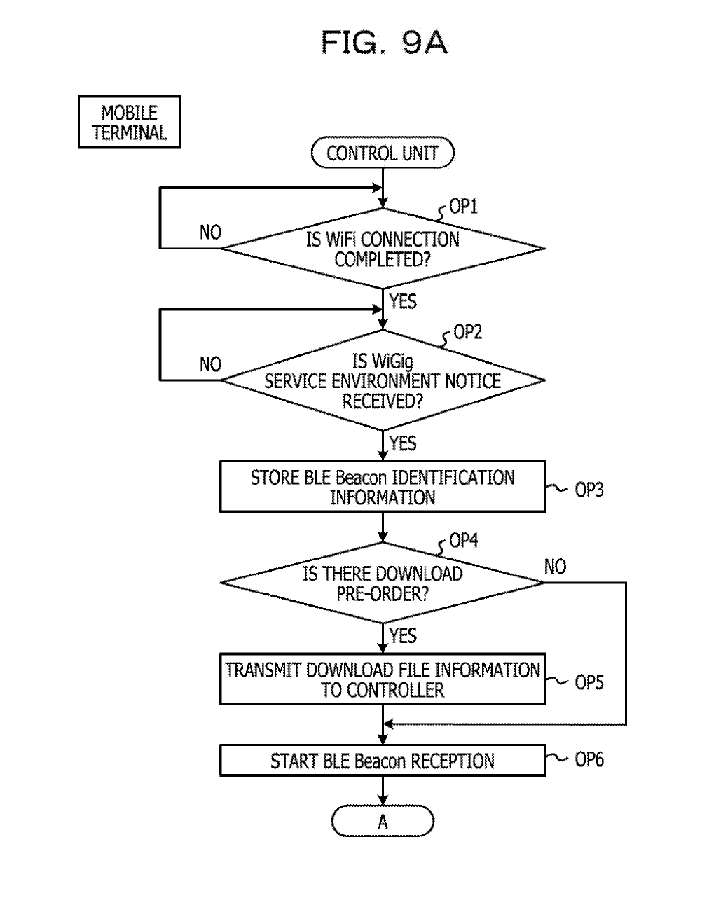

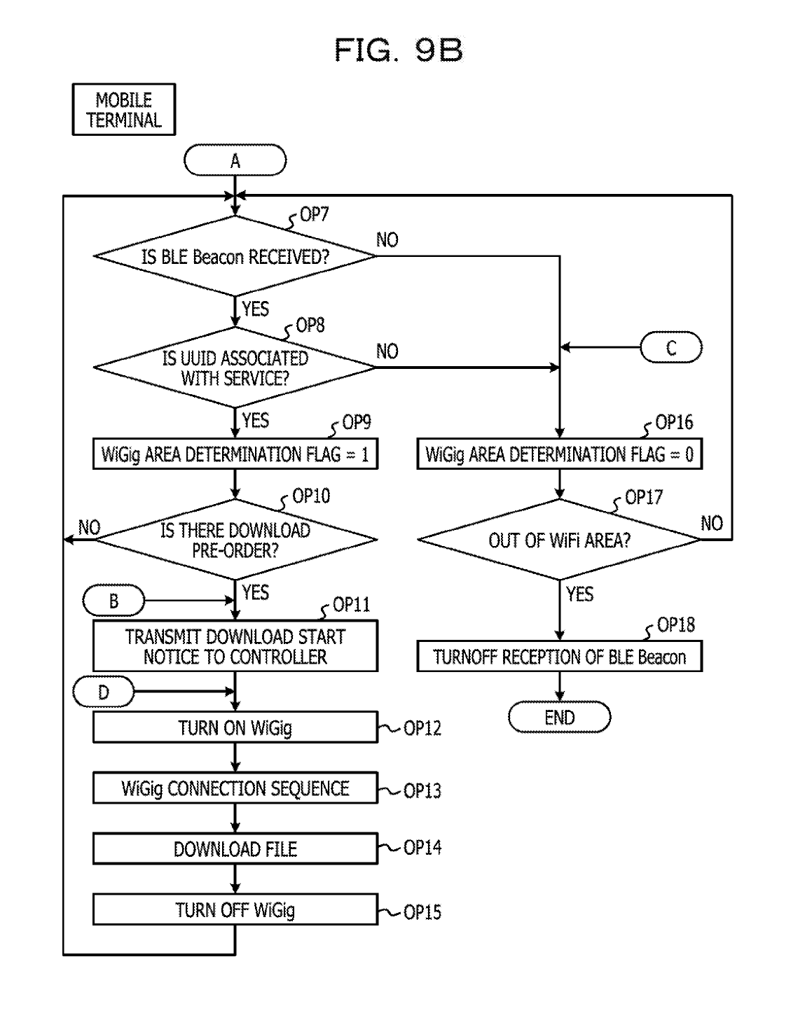

In the first embodiment, BLE beacon identification information is used as identification information of the BLE terminal 3. BLE beacon identification information is a combination of UUID, Major, and Minor. An IP address assigned to the WiGig AP 4 is used as WiGig AP identification information. Information included in the BLE-WiGig association table 55 is registered in advance in the communication system 100A by an administrator. The BLE-WiGig association table 55 makes it possible to identify the WiGig AP 4 arranged at a same position as the BLE terminal 3 from the identification information of the BLE terminal 3.

<Process Flow> FIGS. 9A and 9B are an example of a flow chart of processing of the control unit 14 of the mobile terminal 1A. Processing illustrated in FIGS. 9A and 9B is started when the WiFi control unit 13 notifies the control unit 14 of establishment of connection with the WiFi AP 2. Note that while a main entity of processing illustrated in FIGS. 9A and 9B is the CPU 101 that executes a service benefit program, for convenience, a description is given, assuming that the control unit 14, which has a functional configuration achieved by the CPU 101 executing the service benefit program, is a main entity. In the following, the same also applies to a flow chart for processing of the control unit 14 of the mobile terminal 1A.

In OP1, the control unit 14 is in a state waiting for reception of a notice from the WiFi control unit 13 that establishment of connection with the WiFi AP 2 is completed. When the control unit 14 is notified by the WiFi control unit 13 that establishment of connection with the WiFi AP 2 is completed (OP1: YES), processing proceeds to OP2.

In OP2, the control unit 14 waits for reception of a WiGig service environment notice from the controller 5 by way of WiFi. When the control unit 14 receives the WiGig service environment notice by way of the WiFi control unit 13 (OP2: YES), processing proceeds to OP3. For example, when the WiGig service environment notice is not received even if predetermined time elapses after establishment of connection with the WiFi AP 2 is completed, processing illustrated in FIG. 9A ends (OP2: NO).

In OP3, the control unit 14 stores BLE beacon identification information included in the received WiGig service environment notice, as BLE beacon identification information 191, in the information storage unit 19.

In OP4, the control unit 14 determines whether or not there is setting of download pre-order. This determination is made depending on whether or not information on a download target file is stored in the download pre-order list 193 in the information storage unit 19. When there is setting of download pre-order (OP4: YES), processing proceeds to OP5. When there is no setting of download pre-order (OP4: NO), processing proceeds to OP6.

In OP5, since there is setting of download pre-order, the control unit 14 reads information on a download target file held in the download pre-order list 193 and transmits the information on the download target file as download file information from the WiFi transmission and reception unit 12 to the controller 5. The download file information includes a file name of the download target file, URL, or the like.

In OP6, the control unit 14 instructs the Bluetooth control unit 18 to start Bluetooth reception operation. Upon receiving the instruction from the control unit 14, the Bluetooth control unit 18 causes reception operation of the Bluetooth transmission and reception unit 17 to start. The reception operation of the Bluetooth transmission and reception unit 17 is an intermittent operation in which reception operation is continuously performed for 30 ms in a session in a cycle of 300 ms, for example.

In OP7 of FIG. 9B, the control unit 14 waits for reception of a BLE beacon. When the control unit 14 is notifies of reception of the BLE beacon by the Bluetooth control unit 18 (OP7: YES), processing proceeds to OP8. When no BLE beacon is received even after a predetermined time elapses (OP7: NO), processing proceeds to OP16.

In OP8, since a BLE beacon is received, the control unit 14 determines whether or not BLE beacon identification information included in the BLE beacon is associated with WiGig service. This determination is made depending on whether or not the BLE beacon identification information included in the received BLE beacon matches the BLE beacon identification information 191. The BLE beacon identification information 191 is notified as BLE beacon identification information associated with the WiGig service by the controller 5. When the BLE beacon identification information included in the BLE beacon is associated with the WiGig service (OP8: YES), processing proceeds to OP9. When the BLE beacon identification information included in the BLE beacon is not associated with the WiGig service (OP8: NO), processing proceeds to OP16.

In OP9, since it is indicated that the BLE beacon identification information included in the BLE beacon is associated with the WiGig service and that the mobile terminal 1A is present in the possible communication range of the WiGig AP 4, the control unit 14 sets the WiGig area determination flag 192 to 1.

In OP10, the control unit 14 determines whether or not there is setting of download pre-order. When there is setting of download pre-order (OP10: YES), processing proceeds to OP11. When there is no setting of download pre-order (OP10: NO), processing proceeds to OP7.

In OP11, the control unit 14 transmits a download start notice from the WiFi transmission and reception unit 12 to the controller 5. In the first embodiment, the download start notice includes a name of a download target file, a URL, and BLE beacon identification information included in a BLE beacon.

In OP12, the control unit 14 instructs the WiGig control unit 16 to start operation of the WiGig transmission and reception unit 15. Upon receiving the instruction from the control unit 14, the WiGig control unit 16 causes the operation of the WiGig transmission and reception unit 15. The WiGig transmission and reception unit 15 first searches the WiGig AP 4.

In OP13, the WiGig transmission and reception unit 15 performs a connection sequence with the WiGig AP 4. When connection with the WiGig AP 4 is established, the control unit 14 receives a notice of establishment of connection with the WiGig AP 4 from the WiGig control unit 16.

In OP14, the control unit 14 downloads a target file through the WiGig transmission and reception unit 15. Downloading of the target file is performed according to the Hypertext Transfer Protocol (HTTP) or the File Transfer Protocol (FTP), for example. More specifically, the control unit 14 transmits a download request from the WiGig transmission and reception unit 15 and receives the target file from the WiGig AP 4.

In OP15, when downloading of the target file is completed, the control unit 14 instructs the WiGig control unit 16 to stop operation of the WiGig transmission and reception unit 15. The WiGig control unit 16 receives the instruction from the control unit 14 and stops the operation of the WiGig transmission and reception unit 15. Then, processing proceeds to OP7.

In OP16, since no BLE beacon is received or the BLE beacon identification information included in the received BLE beacon is not associated with the WiGig service, the control unit 14 sets the WiGig area determination flag 192 to 0. This is because it is indicated that the mobile terminal 1A is present out of the possible communication range of the WiGig AP 4 when no BLE beacon is received or the BLE beacon identification information included in the received BLE beacon is not associated with the WiGig service.

In OP17, the control unit 14 determines whether or not the mobile terminal 1A is present out of the possible communication range of the WiFi AP 2. This determination is made depending on whether or not the control unit 14 is notified by the WiFi control unit 13 of disconnection of connection with the WiFi AP 2. When the mobile terminal 1A is present out of the possible communication range of the WiFi AP 2 (OP17: YES), processing proceeds to OP18. When the mobile terminal 1A is present in the possible communication range of the WiFi AP 2 (OP17: NO), processing proceeds to OP7.

In OP18, since the mobile terminal 1A is present out of the possible communication range of the WiFi AP 2, the control unit 14 instructs the Bluetooth control unit 18 to stop the Bluetooth reception operation. Upon receiving the instruction of the control unit 14, the Bluetooth control unit 18 stops the reception operation of the Bluetooth transmission and reception unit 17. Then, processing illustrated in FIG. 9B ends.

Note that processing illustrated in FIGS. 9A and 9B is an example and order of performing processing relies on an embodiment. For example, the instruction to start the Bluetooth reception operation in OP6 may be performed immediately after the processing in OP3. For example, the instruction to start the operation of the WiGig transmission and reception unit 15 in OP12 may be performed immediately after OP9.

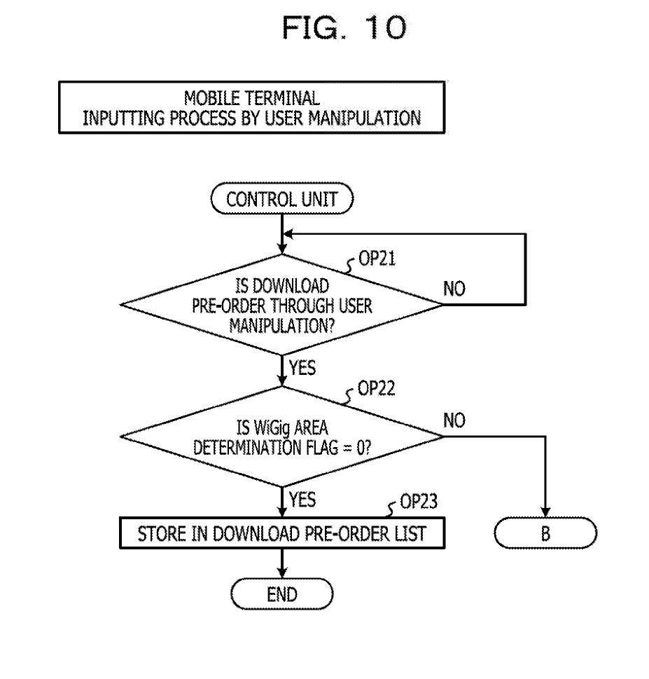

FIG. 10 is a diagram illustrating an example of a pre-order process of a download file of the mobile terminal 1A. Processing illustrated in FIG. 10 is started when a user selects pre-order of downloading from a menu of a service benefit program.

In OP21, the control unit 14 waits for input of setting of download pre-order through user manipulation. What is the user manipulation is determined by the control unit 14, for example, from touch positions on a display screen and the touch panel 103. When setting of download pre-order through user manipulation is inputted (OP21: YES), processing proceeds to OP22.

In OP22, the control unit 14 determines whether the WiGig area determination flag 192 is 0 or 1. When the WiGig area determination flag 192 is 0 (OP22: YES), processing proceeds to OP23. When the WiGig area determination flag 192 is 1 (OP22: NO), processing proceeds to OP11 in FIG. 9B as the mobile terminal 1A is already present in the possible communication range of the WiGig AP 4, and then downloading of a file targeted for setting of download pre-order is started.

In OP23, since the mobile terminal 1A is present out of the possible communication range of the WiGig AP 4, the control unit 14 adds information on the file pre-ordered for downloading to the download pre-order list 193. Then, processing illustrated in FIG. 10 ends.

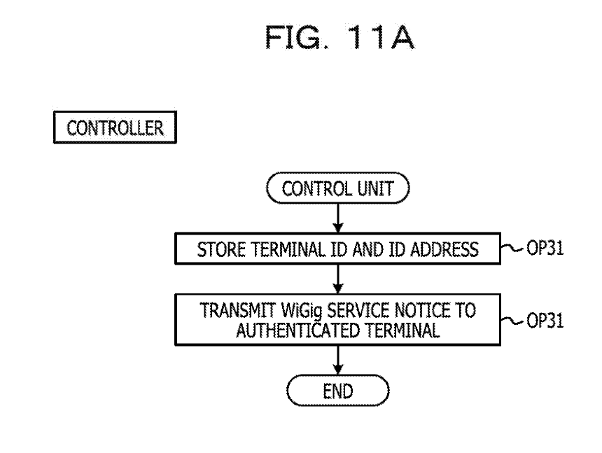

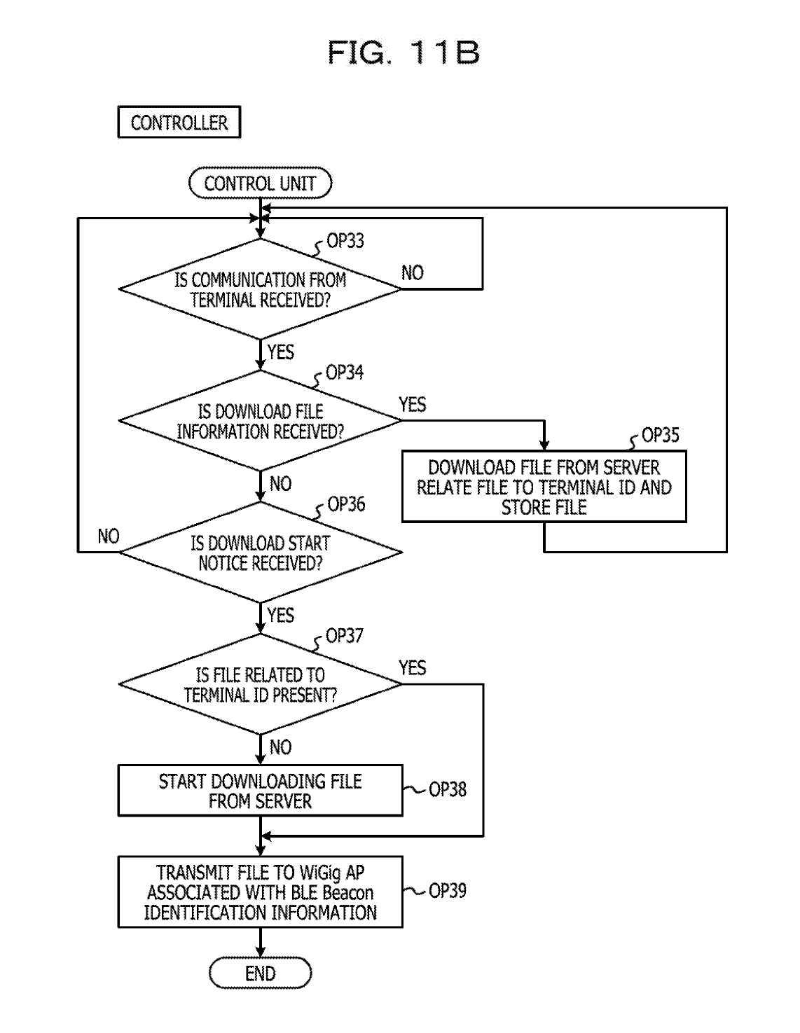

FIG. 11A is an example of a flow chart of processing after authentication of the mobile terminal 1A of the controller 5 is completed. Processing illustrated in FIG. 11A is started when the authentication of the mobile terminal 1A succeeds. Note that while a main entity of processing illustrated in FIG. 11A is a CPU of the controller 5, for convenience, a description is given, assuming that the control unit 51, which has a functional configuration achieved by the CPU of the controller 5 executing a service provision program, is the main entity. In the following, the same also applies to a flow chart for processing of the controller 5.

In OP31, the control unit 51 relates terminal identification information and an IP address of the mobile terminal 1A authentication of which succeeds and stores the terminal identification information and the IP address in an index of the download data cache 54. The terminal identification information of the mobile terminal 1A is a MAC address, for example.

In OP32, the control unit 51 transmits a WiGig service environment notice to the mobile terminal 1A. The WiGig service environment notice includes BLE beacon identification information used by the BLE terminal 3 associated with the WiGig service. The WiGig service environment notice is delivered to the mobile terminal 1A by way of the WiFi AP 2. Then, processing illustrated in FIG. 11A ends. Note that order of performing the processing in OP31 and OP32 is not limited to the example illustrated in FIG. 11A and processing in OP32 may be performed first.

FIG. 11B is an example of a flow chart of processing when the controller 5 receives communication from the mobile terminal 1A. Processing illustrated in FIG. 11B is started when the controller 5 receives communication from the mobile terminal 1A.

In OP33, the control unit 51 waits for communication from the mobile terminal 1A. When the control unit 51 receives communication from the mobile terminal 1A (OP33: YES), processing proceeds to OP34.

In OP34, the control unit 51 determines whether or not the communication from the mobile terminal 1A is download file information. When the control unit 51 receives the download file information (OP34 YES), processing proceeds to OP35. The download file information includes a file name of a download target file of the mobile terminal 1A, a URL, or the like. When the communication from the mobile terminal 1A is the download file information (OP34: NO), processing proceeds to OP36.

In OP35, the control unit 51 acquires a file with the file name included in the received download file information from the URL included in the download file information. The acquired file is related to terminal identification information and an IP address of the mobile terminal 1A and stored in the download data cache 54. Then, processing proceeds to OP33.

In OP36, the control unit 51 determines whether or not communication from the mobile terminal 1A is a download start notice. In the first embodiment, a download start notice includes a file name of a download target file, a URL, and BLE beacon identification information included in a BLE beacon received by the mobile terminal 1A. When the communication from the mobile terminal 1A is the download start notice (OP36: YES), processing proceeds to OP37. When the communication from the mobile terminal 1A is not the download start notice (OP36: NO), processing proceeds to OP33.

In OP37, the control unit 51 determines whether or not a file related to the terminal identification information included in the download start notice is stored in the download data cache 54. This determination is made by determining whether or not an index of the download data cache 54 has a file name associated with terminal identification information that matches the terminal identification information included in the download start notice. When the file related to the terminal identification information included in the download start notice is present in the download data cache 54 (OP37: YES), processing proceeds to OP39. When the file related to the terminal identification information included in the download start notice is not present in the download data cache 54 (OP37: NO), processing proceeds to OP38.

In OP38, the control unit 51 downloads a file with the file name included in the download start notice from the URL included in the download start notice.

In OP39, the control unit 51 identifies the WiGig AP 4 associated with the BLE terminal 3 that uses the BLE beacon identification information included in the download start notice, and transmits a target file to the identified WiGig AP 4. The WiGig AP 4 associated with the BLE terminal 3 that uses the BLE beacon identification information included in the download start notice is identified based on the BLE-WiGig association table 55. In addition, the WiGig AP 4 is notified of an IP address of the mobile terminal 1A together with the file. Then, processing illustrated in FIG. 11B ends.

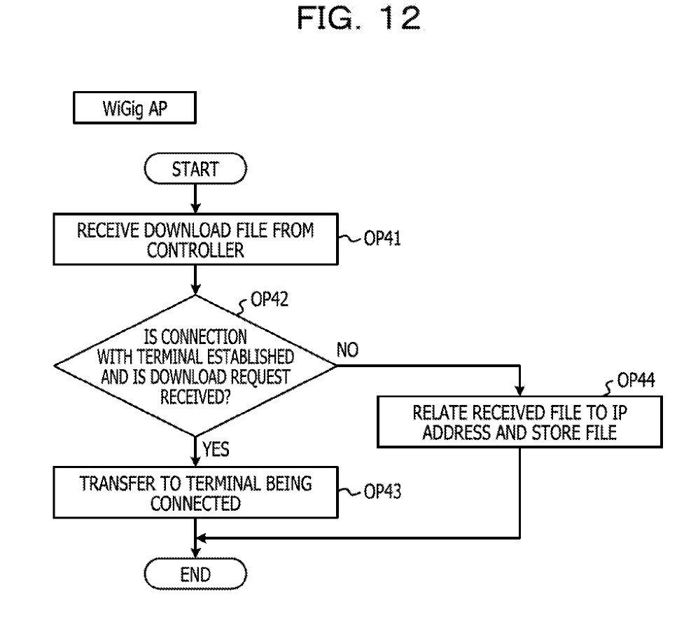

FIG. 12 is an example of a flow chart of processing when the WiGig AP 4 receives communication from the controller 5. Processing illustrated in FIG. 12 is started when the WiGig AP 4 receives communication from the controller 5. Note that while a main entity of processing illustrated in FIG. 12 is a CPU of the controller 5, for convenience, a description is given, assuming that the WiGig control unit 42, which has a functional configuration, is a main entity. In the following, the same also applies to a description of a flow chart.

In OP41, the WiGig control unit 42 a download target file of the mobile terminal 1A from the controller 5.

In OP42, the WiGig control unit 42 determines whether or not connection with the mobile terminal 1A is established and a download request is received from the mobile terminal 1A. When the connection with the mobile terminal 1A is established and the download request is received from the mobile terminal 1A (OP42: YES), processing proceeds to OP43. When the connection with the mobile terminal 1A is not established or the download request is not received from the mobile terminal 1A (OP42: NO), processing proceeds to OP44.

In OP43, since the connection with the mobile terminal 1A is established and the download request is received from the mobile terminal 1A, the WiGig control unit 42 transmits to the mobile terminal 1A the file received from the WiGig transmission and reception unit 41. Then, processing illustrated in FIG. 12 ends.

In OP44, since the connection with the mobile terminal 1A is not established or the download request is not received from the mobile terminal 1A, the WiGig control unit 42 associates the IP address of the mobile terminal 1A with the received file and stores the IP address and the received file in a cache in a non-volatile memory. The IP address of the mobile terminal 1A is notified together with the file. Then, processing illustrated in FIG. 12 ends.

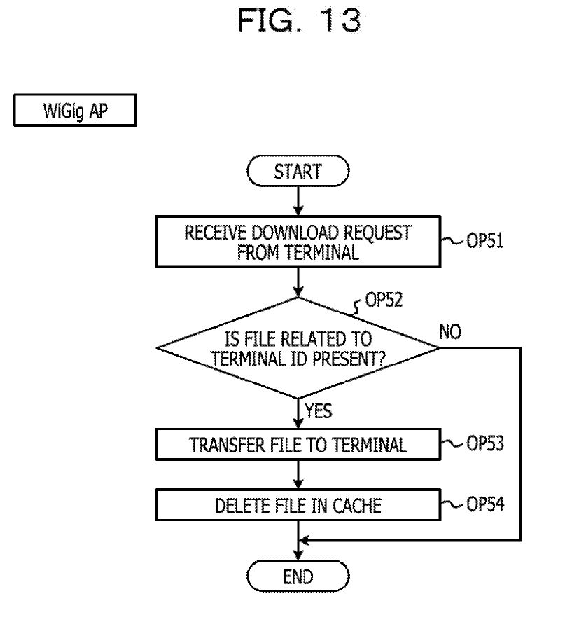

FIG. 13 is an example of a flow chart of processing when the WiGig AP 4 receives a download request from the mobile terminal 1A. Processing illustrated in FIG. 13 is started when the WiGig AP 4 receives the download request from the mobile terminal 1A.

In OP51, the WiGig control unit 42 receives a download request from the mobile terminal 1A. In OP52, the WiGig control unit 42 determines whether or not a file related to terminal identification information of the mobile terminal 1A which is a transmission source of the download request is present in a cache. Note that the terminal identification information of the mobile terminal 1A used by the WiGig AP 4 is an IP address, for example. When the file related to the terminal identification information of the mobile terminal 1A is present in the cache (OP52: YES), processing proceeds to OP53. When the file related to the terminal identification information of the mobile terminal 1A is not present in the cache (OP52: NO), the download request from the mobile terminal 1A is buffered and the mobile terminal 1A enters a state waiting for a target file from the controller 5. Then, processing illustrated in FIG. 13 ends, and when the mobile terminal 1A receives the file from the controller 5, the processing in FIG. 12 is started.

In OP53, the WiGig control unit 42 transmits a file related to the IP address of the mobile terminal 1A in the cache from the WiGig transmission and reception unit 41 to the mobile terminal 1A. In OP54, the WiGig control unit 42 deletes the file related to the IP address of the mobile terminal 1A from the cache. Then, processing illustrated in FIG. 13 ends.

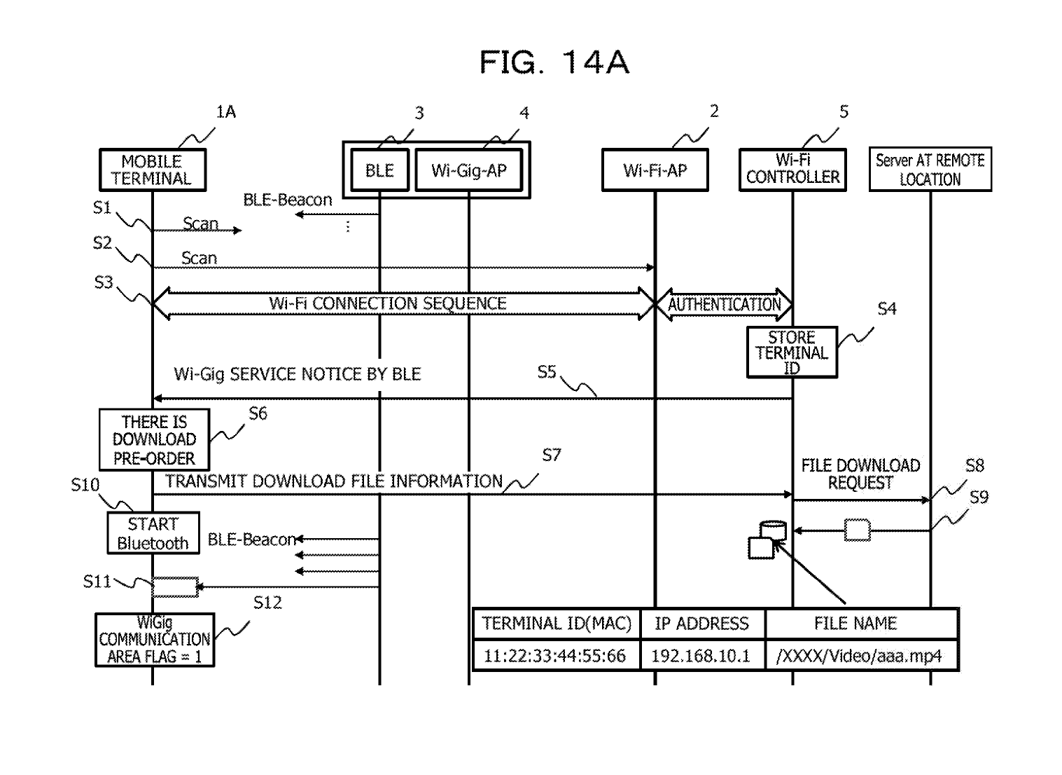

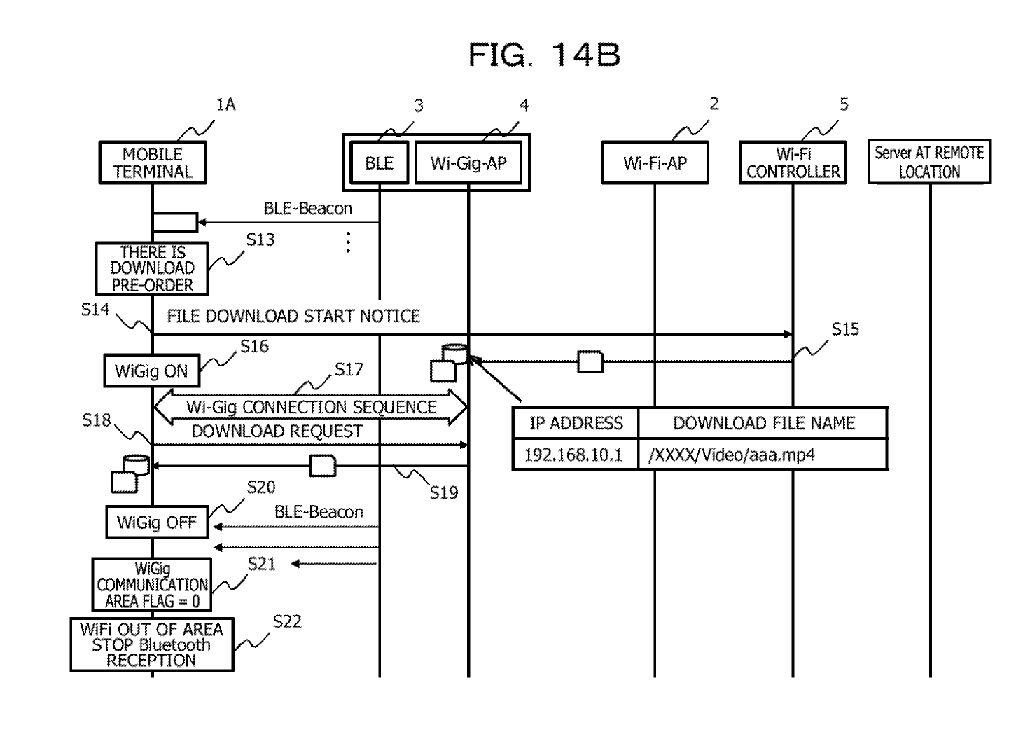

In addition, in OP52, when the file related to the terminal identification information of the mobile terminal 1A is not present in the cache, the WiGig control unit 42 may transmit a download request of a target file to the controller 5 and actively acquire the target file.

<Specific Example of Sequence> FIGS. 14A and 14B are diagrams illustrating an example of a sequence of a service provision process in the communication system 100A according to the first embodiment. FIGS. 14A and 14B illustrate an example of a case in which download pre-order is set for the mobile terminal 1A. FIG. 14A assumes that the mobile terminal 1A is present out of the possible communication range of the WiFi AP 2.

In S1, the mobile terminal 1A performs scanning in a predetermined cycle to search the WiFi AP 2. A scanning cycle is 20 seconds, for example. In S2, the mobile terminal 1A moves and enters the possible communication range of the WiFi AP 2 and through scanning, the mobile terminal 1A detects entry into the possible communication range of the WiFi AP 2. In S3, a connection sequence is performed between the mobile terminal 1A and the WiFi AP 2. In this connection sequence, authentication of the mobile terminal 1A is performed by the controller 5.

In S4, the controller 5 performs an authentication process based on an authentication request of the mobile terminal 1A, relates terminal identification information of the mobile terminal 1A to an IP address, and stores the terminal identification and the IP address in an index of the download data cache 54 (FIG. 11A, OP31). Subsequently, a state is such that the mobile terminal 1A is connected with the WiFi AP 2.

In S5, the controller 5 transmits a WiGig service environment notice to the mobile terminal 1A (FIG. 11A, OP32). The WiGig service environment notice includes BLE beacon identification information used by each BLE terminal 3 associated with each WiGig AP 4 in the communication system 100A. The WiGig service environment notice is received by the mobile terminal 1A by way of WiFi, more specifically, the WiFi AP 2 (FIG. 9A, OP2: YES). The mobile terminal 1A stores the BLE beacon identification information included in the WiGig service environment notice in the information storage unit 19 (FIG. 9A, OP3).

In S6, the mobile terminal 1A determines that download pre-order is set (FIG. 9A, OP4: YES). In S7, the mobile terminal 1A transmits download file information to the controller 5 (FIG. 9A, OP5). The download file information includes a file name of a download target file, a URL, or the like. The download file information is transmitted by way of WiFi since the mobile terminal 1A establishes connection with the WiFi AP 2.

In S8, the controller 5 receives the download file information from the mobile terminal 1A (FIG. 11B, OP34: YES), and transmits a download request of a target file to the corresponding server with the URL included in the download file information (FIG. 11B, OP35). In S9, the controller 5 receives the target file from the corresponding server, associates terminal identification information of the mobile terminal 1A with an IP address, and stores the terminal identification information in the download data cache 54 (FIG. 11B, OP35). FIG. 14A illustrates an example of association of the terminal identification information and the IP address of the mobile terminal 1A and the downloaded file name.

In S10, the mobile terminal 1A causes Bluetooth reception operation to start after transmitting the download file information (FIG. 9A, OP6). In S11, a user of the mobile terminal 1A moves to a direction approaching the BLE terminal 3. When the mobile terminal 1A enters a BLE beacon reachable range of the BLE terminal 3, the mobile terminal 1A receives a BLE beacon from the BLE terminal 3 (FIG. 9B, OP7: YES). Subsequently, the mobile terminal 1A continues to receive a BLE beacon in a predetermined cycle. The mobile terminal 1A measures received signal strength of the received BLE beacon and monitors whether or not the mobile terminal 1A is present in the BLE beacon reachable range of the BLE terminal 3. A broadcasting cycle of BLE beacons is 100 ms, for example.

In S12, since the BLE beacon identification information included in the received BLE beacon matches the BLE beacon identification information 191 notified in the WiGig service environment notice (FIG. 9B, OP8: YES), the mobile terminal 1A sets the WiGig area determination flag 192 to 1 (FIG. 9B, OP9). Since it is indicated that the mobile terminal 1A is present in the possible communication range of the WiGig AP 4, the BLE beacon identification information included in the received BLE beacon matches the BLE beacon identification information 191 notified in the WiGig service environment notice.

In S13 of FIG. 14B, the mobile terminal 1A determines that download pre-order is set (FIG. 9B, OP10: YES). In S14, the mobile terminal 1A transmits a download start notice to the controller 5 by way of WiFi (FIG. 9B, OP11). The download start notice includes a file name of a download target file, a URL, and BLE beacon identification information of a received BLE beacon, for example.

In S15, the controller 5 receives the download start notice from the mobile terminal 1A (FIG. 11B, OP36: YES) and transmits to the WiGig AP 4 a file related to terminal identification information of the mobile terminal 1A, which is stored in the download data cache 54 (FIG. 11B, OP37: YES, OP39). The WiGig AP 4 is identified from the BLE-WiGig association table 55 based on BLE beacon identification information included in the download start notice. The WiGig AP 4 receives a file from the controller 5 (FIG. 12 OP41), relates the received file to an IP address of the mobile terminal 1A, and stores the file in the cache (FIG. 12, OP42: NO, OP44). The IP address of the mobile terminal 1A is transmitted with the file from the controller 5.

In S16, the mobile terminal 1A causes operation of WiGig to start after transmitting the download start notice (FIG. 9B, OP12). In S17, a WiGig connection sequence is performed between the mobile terminal 1A and the WiGig AP 4 (FIG. 9B, OP13). In addition, since authentication in the WiFi sequence in S3 also serves as authentication of WiGig, no authentication is performed in the WiGig connection sequence. In S18, the mobile terminal 1A transmits a download request to the WiGig AP 4 (FIG. 9B, OP14).

In S19, the WiGig AP 4 receives the download request from the mobile terminal 1A (FIG. 13, OP51) and transmits to the mobile terminal 1A a file related to an IP address of the mobile terminal 1A in the cache (FIG. 13, OP52: YES, OP53).

In S20, downloading of the file is completed and the mobile terminal 1A stops the WiGig operation. In step S21, a user of the mobile terminal 1A moves to a direction away from the WiGig AP 4, and exits from the BLE beacon reachable range of the BLE terminal 3. With this, the received signal strength of the BLE beacon drops and the mobile terminal 1A detects that a BLE beacon is no longer received (FIG. 9B, OP7: NO). The mobile terminal 1A sets the WiGig area determination flag 192 to 0 (FIG. 9B, OP16).

In S22, the user of the mobile terminal 1A moves to a direction away from the WiFi AP 2 and exits from the possible communication range of the WiFi AP 2. The mobile terminal 1A detects the exit from the possible communication range of the WiFi AP 2 from the received signal strength of a WiFi beacon from the WiFi AP 2 (FIG. 9B, OP17: YES), and stops the Bluetooth reception operation (FIG. 9B, OP18).

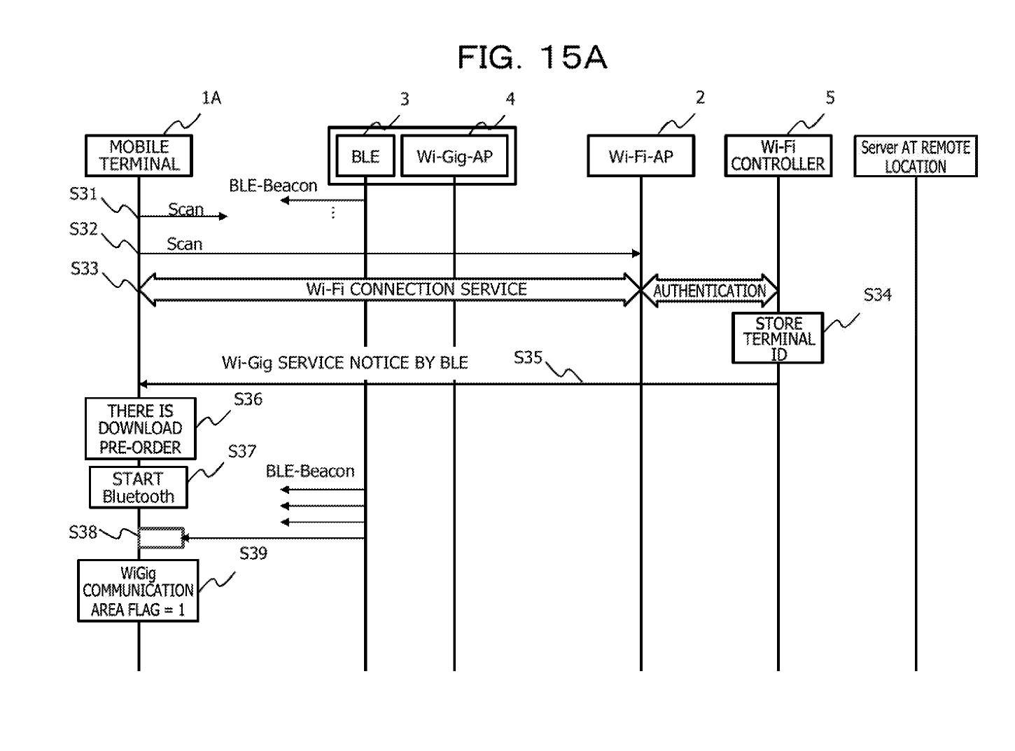

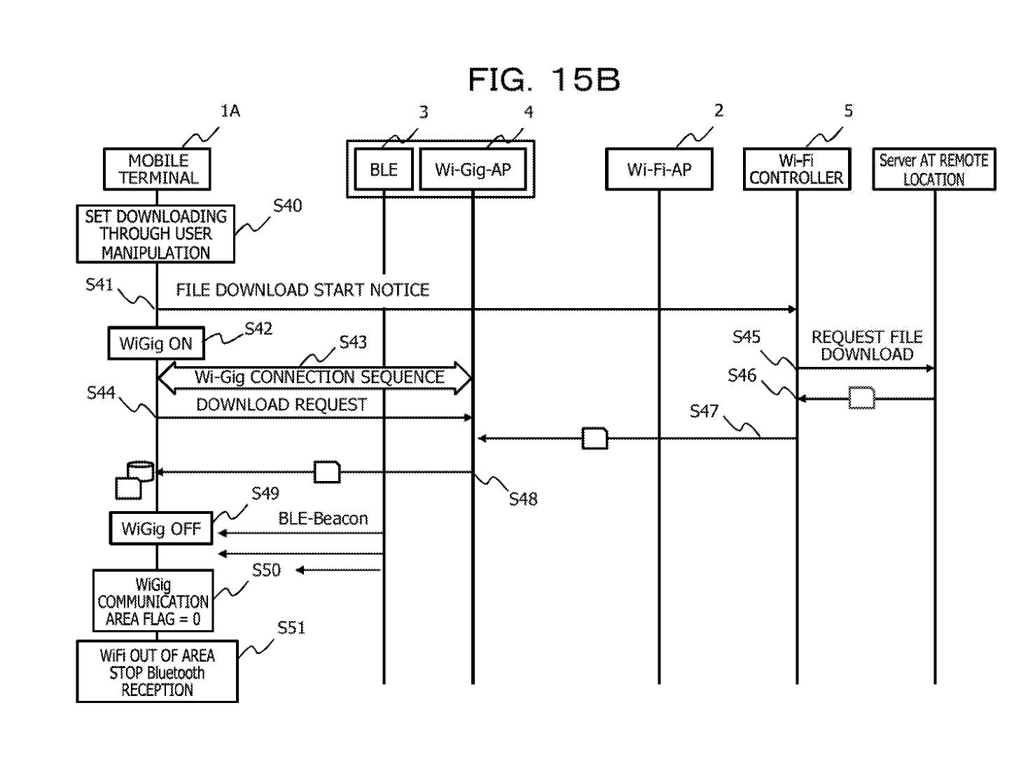

FIGS. 15A and 15B are diagrams illustrating an example of a sequence of a service provision process in the communication system 100A according to the first embodiment. FIGS. 15A and 15B illustrate an example of a case in which no download pre-order is set for the mobile terminal 1A. FIG. 15A assumes that the mobile terminal 1A is present out of the possible communication range of the WiFi AP 2.

S31 to S35 are similar to 51 to S5 in FIG. 14A. More specifically, in S31 to S35, the user of the mobile terminal 1A enters the possible communication range of the WiFi AP 2, and the mobile terminal 1A establishes connection with the WiFi AP 2 and receives a WiGig service environment notice from the controller 5.

In S36, the mobile terminal 1A determines that no download pre-order is set (FIG. 9A, OP4: NO). In S37, the mobile terminal 1A causes the Bluetooth reception operation to start (FIG. 9A, OP6).

In S38, the user of the mobile terminal 1A moves to a direction approaching the BLE terminal 3. When the mobile terminal 1A enters the BLE beacon reachable range of the BLE terminal 3, the mobile terminal 1A receives a BLE beacon from the BLE terminal 3 (FIG. 9B, OP7: YES).

In S39, since BLE beacon identification information included in the received BLE beacon matches the BLE beacon identification information 191 notified in the WiGig service environment notice (FIG. 9B, OP8: YES), the mobile terminal 1A sets the WiGig area determination flag 192 to 1 (FIG. 9B, OP9). Since it is indicated that the mobile terminal 1A is present in the possible communication range of the WiGig AP 4, the BLE beacon identification information included in the received BLE beacon matches the BLE beacon identification information 191 notified in the WiGig service environment notice.

In S40 in FIG. 15B, the mobile terminal 1A accepts input of information on a target file of download pre-order through user manipulation (FIG. 10, OP21: YES). In S41, since the WiGig area determination flag 192 is 1 (FIG. 10, OP22: NO), the mobile terminal 1A transmits a download start notice to the controller 5 by way of WiFi (FIG. 9B, OP11). The download start notice includes a file name of a download target file, a URL, and BLE beacon identification information of a received BLE beacon.

In S42, the mobile terminal 1A causes operation of WiGig to start (FIG. 9B, OP12). In S43, a WiGig connection sequence is performed between the mobile terminal 1A and the WiGig AP 4 (FIG. 9B, OP13). In S44, the mobile terminal 1A transmits a download request to the WiGig AP 4 (FIG. 9B, OP14).

On the other hand, in S45, the controller 5 receives a download start notice from the mobile terminal 1A (FIG. 11B, OP36: YES) and transmits a download request for a target file to a server corresponding to the URL included in the download start notice (FIG. 11B, OP38). This is because no file related to the terminal identification information of the mobile terminal 1A is present in the download data cache 54 (FIG. 11B, OP37: NO).

In S46, the controller 5 completes downloading of the file. In S47, the controller 5 identifies the WiGig AP 4 from the BLE beacon identification information included in the download start notice and transmits the downloaded file to the WiGig AP 4 (FIG. 11B, OP39).

In S48, the WiGig AP 4 receives the file from the controller 5 (FIG. 12, OP41) and transmits the file to the mobile terminal 1A (FIG. 12, OP42: YES, OP43).

After S49, similar to S20 and subsequent steps in FIG. 14B, when downloading of the file is completed, the WiGig operation of the mobile terminal 1A is stopped (S49). The user of the mobile terminal 1A moves to a direction away from the BLE terminal 3, and the mobile terminal 1A exits from the BLE beacon reachable range of the BLE terminal 3. When BLE beacons are no longer received, the WiGig area determination flag 192 is set to 0 (S50). When the mobile terminal 1A exits from the possible communication range of the WiFi AP 2, the Bluetooth reception operation of the mobile terminal 1A is stopped (S51).

<Operation and Effect of First Embodiment> In the first embodiment, utilizing the fact that a possible communication range of WiGig and a BLE beacon reachable range are of almost same size, the BLE terminal 3 is arranged at a same position as the WiGig AP so that the possible communication range of WiGig and the BLE beacon reachable range are in a same geographical range. It may be detected that the mobile terminal 1A enters the possible communication range of the WiGig AP 4, by detecting reception of a BLE beacon transmitted from the BLE terminal 3. More specifically, in the first embodiment, WiGig operation may be started after the mobile terminal 1A receives a BLE beacon, and thus a time period taken to capture the WiGig AP 4 may be shortened. With this, power consumption for the WiGig operation of the mobile terminal 1A may be reduced.

In addition, in the first embodiment, the mobile terminal 1A transmits a download start notice to the controller 5 during a period of time after receiving a BLE beacon and before connection with the WiGig AP 4 is established, irrespective of whether or not there is setting of download pre-order (S14 of FIG. 14B, S41 of FIG. 15B). When receiving the download start notice, the controller 5 transmits a target file to the WiGig AP 4. With this, a state is such that if the download request is transmitted from the mobile terminal 1A, the target file is already cached in the WiGig AP 4 (see FIG. 14B) or the target file is transmitted from the controller 5 to the WiGig AP 4 (see FIG. 15B). Thus, the time period taken for downloading of the mobile terminal 1A, more specifically, WiGig operating time of the mobile terminal 1A may be made shorter.

In addition, in the first embodiment, the mobile terminal 1A has WiGig operation start conditions that a BLE beacon is received from the BLE terminal 3 associated with WiGig service and that download pre-order is set. With this, when download pre-order is not set, the WiGig operation of the mobile terminal 1A is not started even if a BLE beacon is received from the BLE terminal 3 associated with the WiGig service. This may suppress wasteful operation of a WiGig module of the mobile terminal 1A and make the operating time of the WiGig module of the mobile terminal 1A shorter.

In addition, in the first embodiment, when file download is completed, WiGig operation of the mobile terminal 1A is stopped. With this, WiGig operating time of the mobile terminal 1A may be reduced and power consumption may be reduced.

In addition, in the first embodiment, Bluetooth reception operation of the mobile terminal 1A is started upon reception of a WiGig service environment notice after connection with the WiFi AP 2 is established and is stopped upon disconnection with the WiFi AP 2. This may limit Bluetooth reception operating time of the mobile terminal 1A and control power consumption of the mobile terminal 1A.

In addition, in the first embodiment, only the WiGig AP 4, with which the mobile terminal 1A establishes connection, may cache a download target file of the mobile terminal 1A. With this, any cache of the WiGig AP 4 with which the mobile terminal 1A connects may not be used wastefully, and occurrence of any overhead due to communications of unwanted file in the communication system 100A may also be controlled.

<Variation of First Embodiment> In a variation of the first embodiment, taking advantage of the fact that one of pieces of information included in a BLE beacon is transmitted signal strength, the communication system 100A utilizes a function capable of determining a distance from a transmission source device of a BLE beacon, from a difference between the transmitted signal strength and received signal strength of the BLE beacon.

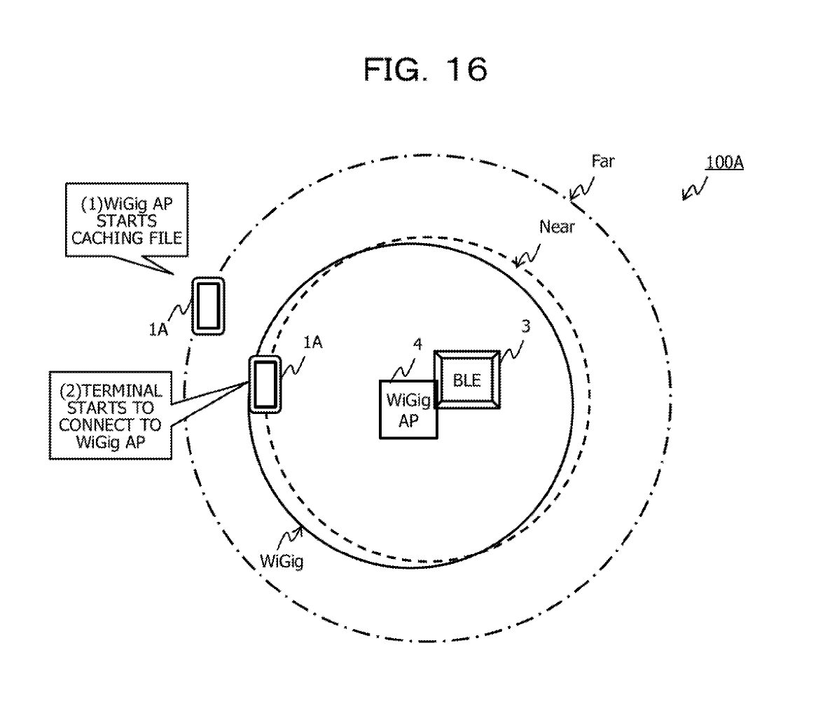

FIG. 16 is a diagram illustrating an example of processing in the communication system 100A according to the variation of the first embodiment. A system configuration of the communication system 100A according to the variation of the first embodiment is similar to the first embodiment.

A BLE beacon transmitted from the BLE terminal 3 includes information such as broadcasted signal strength of a BLE beacon, in addition to UUID, Major, and Minor. The mobile terminal 1A classifies a distance from the BLE terminal 3 into two levels of “Far” and “Near”, based on a difference between the received signal strength of a BLE beacon received from the BLE terminal 3 and the broadcasted signal strength of a BLE beacon included in the BLE beacon. However, the distance between the mobile terminal 1A and the BLE terminal 3 classified based on the difference between the received signal strength of a BLE beacon broadcasted from the BLE terminal 3 and the broadcasted signal strength of a BLE beacon included in the BLE beacon is not limited to the two levels of “Far” and “Near”.

In the following, an area whose distance from the BLE beacon transmission device is determined as “Far” is referred to as a Far area and an area whose distance from the BLE beacon transmission device is determined as “Near” is referred to as a Near area. The Far area is larger than the Near area and encompasses the Near area. The Near area is a range of 1 to 3 meters from the BLE transmitter. The Far area is a range of a distance at which a BLE beacon may be detected from the BLE transmitter. Note that a reachable distance of a BLE beacon is from 2.5 meters to 50 meters, for example, depending on broadcast power.

In the variation of the first embodiment, the Near area is set so that the Near area is of same size as the possible communication range of the WiGig AP 4 or smaller than the possible communication range of the WiGig AP 4. The Far area is set so that the Far area is larger than the possible communication range of the WiGig AP 4. Setting of the Near area and the Far area may be adjusted through setting of a threshold of a difference between the received signal strength and the broadcasted signal strength of the BLE beacon. In FIG. 16, the Far area is depicted by a dot-and-dash line. The Near area is depicted by a dashed line. The possible communication range of the WiGig AP 4 is depicted by a solid line.

Flow of processing of the communication system 100A according to the variation of the first embodiment is as follows.

(1) When the mobile terminal 1A detects entry into the Far area, the mobile terminal 1A transmits a download start notice to the controller 5. When receiving the download start notice, the controller 5 transmits a target file to the WiGig AP 4 and the WiGig AP 4 stores the received target file in a cache.

(2) When the mobile terminal 1A detects entry into the Near area, the mobile terminal 1A causes WiGig operation to start, establishes connection of the WiGig AP 4, and downloads a target file.

There is a time interval of about a few seconds after the user of the mobile terminal 1A enters the Far area and before the user enters the Near area. Thus, by causing caching of the target file into the WiGig AP 4 which is triggered by detection of entry of the mobile terminal 1A into the Far area, the state is such that the target file is held in the cache of the WiGig AP 4 when the mobile terminal 1A enters the Near area. This may shorten the WiGig operating time of the mobile terminal 1A. A hardware configuration and a functional configuration of each device in the variation of the first embodiment are similar to the first embodiment.

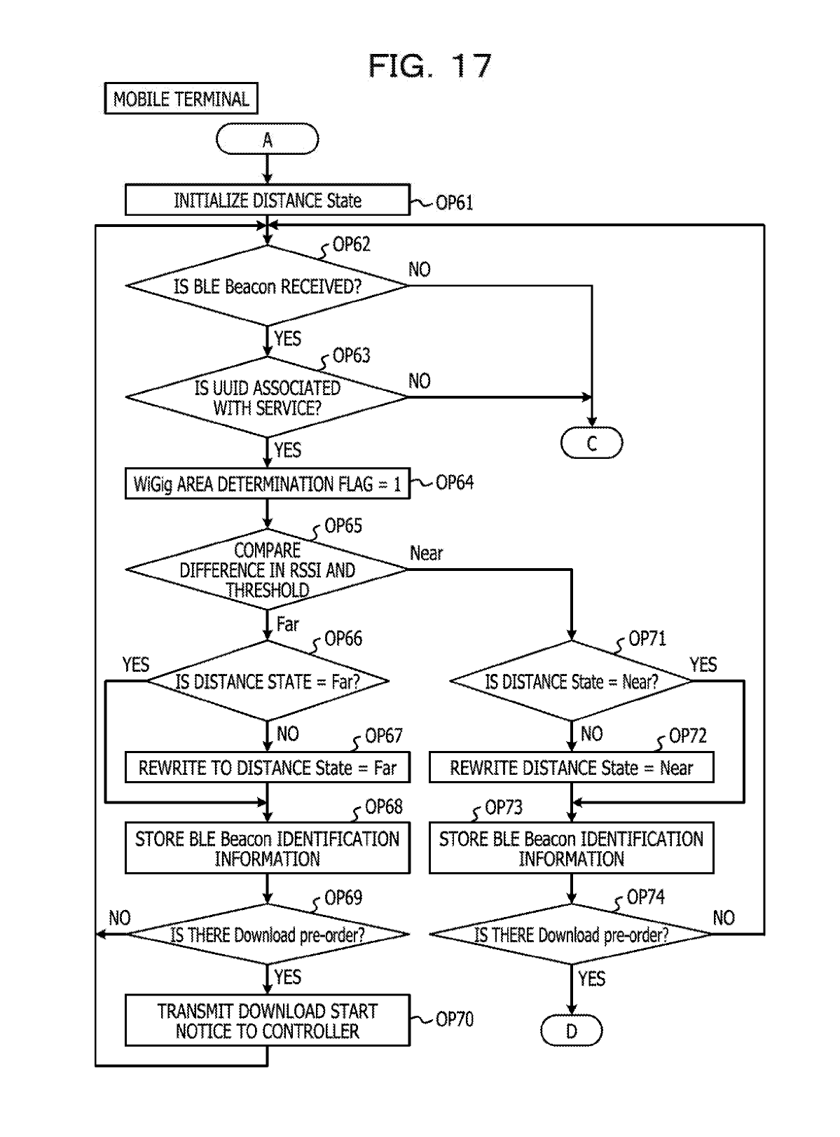

FIG. 17 is an example of a flow chart of processing of the mobile terminal 1A according to the variation of the first embodiment. In the variation of the first embodiment, the mobile terminal 1A performs processing similar to FIG. 9A. The flowchart illustrated in FIG. 17 is the flowchart of processing continuing after OP6 in FIG. 9A.

In OP61, the control unit 14 initializes a distance state. A distance state represents a distance from the BLE terminal 3 and is a value of “Far” or “Near”. An initial value is Null. The distance state is stored in the information storage unit 19 (not illustrated).

In OP62, the control unit 14 waits for reception of a BLE beacon. When the control unit 14 is notified of reception of the BLE beacon by the Bluetooth control unit 18 (OP62: YES), processing proceeds to OP62. When no BLE beacon is received even after a predetermined time elapses (OP62: NO), processing proceeds to OP16 in FIG. 9B.

In OP63, since the control unit 14 receives the BLE beacon, the control unit 14 determines whether BLE beacon identification information included in the BLE beacon is associated with the WiGig service. This determination is made by determining whether or not the BLE beacon identification information included in the BLE beacon matches the BLE beacon identification information 191. When the BLE beacon identification information included in the BLE beacon is associated with the WiGig service (OP63: YES), processing proceeds to OP64. When the BLE beacon identification information included in the BLE beacon is not associated with the WiGig service (OP63: NO), processing proceeds to OP16 in FIG. 9B.

In OP64, since it is indicated that the BLE beacon identification information included in the BLE beacon is associated with the WiGig service and that the mobile terminal 1A is present in the possible communication range of the WiGig AP 4, the control unit 14 sets the WiGig area determination flag 192 to 1.

In OP65, the control unit 14 compares a difference between the received signal strength of the BLE beacon and the broadcasted signal strength included in the BLE beacon with a Far determination threshold and a Near determination threshold and determine whether the distance state with the BLE terminal 3 is Far or Near. A Far determination threshold is a larger value than a Near determination threshold. A Far determination threshold is set below a value of a difference between a threshold of the received signal strength used to detect reception of a BLE beacon and the broadcasted signal strength included in the BLE beacon.

When the difference between the received signal strength of the BLE beacon and the broadcasted signal strength included in the BLE beacon is equal to or larger than the Near determination threshold and less than the Far determination threshold, it is determined that the distance state with the BLE terminal 3 is Far. When the difference between the received signal strength of the BLE beacon and the broadcasted signal strength included in the BLE beacon is less than the Near determination threshold, it is determined that the distance state with the BLE terminal 3 is Near.

When it is determined that the distance state with the BLE terminal 3 is Far (OP65: Far), processing proceeds to OP66. When it is determined that the distance state with the BLE terminal 3 is Near (OP65: Near), processing proceeds to OP71.

OP66 to OP70 are processes to be performed when it is determined that the distance state with the BLE terminal 3 is Far. In OP66, the control unit 14 determines whether or not the distance state in the information storage unit 19 is Far. When the distance state in the information storage unit 19 is Far (OP66: YES), processing proceeds to OP68. When the distance state in the information storage unit 19 is not Far (OP66: NO), processing proceeds to OP67.

In OP67, the control unit 14 rewrites the distance state in the information storage unit 19 with “Far”. In OP68, the control unit 14 rewrites and stores BLE beacon identification information included in the received BLE beacon as the BLE beacon identification information 191 in the information storage unit 19.

In OP69, the control unit 14 determines whether or not there is setting of download pre-order. This determination is made depending on whether or not a download target file is stored in the download pre-order list 193 in the information storage unit 19. When there is setting of download pre-order (OP69: YES), processing proceeds to OP70. When there is no setting of download pre-order (OP69: NO), processing proceeds to OP62.

In OP70, the control unit 14 transmits a download start notice from the WiFi transmission and reception unit 12 to the controller 5. The download start notice includes a file name of a download target file, a URL, and BLE beacon identification information included in a received BLE beacon, for example. Then, processing proceeds to OP62.

OP71 to OP74 are processes to be performed when it is determined that the distance state with the BLE terminal 3 is Near. In OP71, the control unit 14 determines whether or not the distance state in the information storage unit 19 is Near. When the distance state in the information storage unit 19 is Near (OP71: YES), processing proceeds to OP73. When the distance state in the information storage unit 19 is not Near (OP71: NO), processing proceeds to OP72.

In OP72, the control unit 14 rewrites the distance state in the information storage unit 19 with “Near”. In OP73, the control unit 14 rewrites and stores the BLE beacon identification information included in the received BLE beacon as the BLE beacon identification information 191 in the information storage unit 19.

In OP74, the control unit 14 determines whether or not there is setting of download pre-order. When there is setting of download pre-order (OP74: YES), processing proceeds to OP12 in FIG. 9B. When there is no setting of download pre-order (OP74: NO), processing proceeds to OP62.

Note that in the example illustrated in FIG. 17, Far or Near is determined based on a difference between the received signal strength of a BLE beacon and the broadcasted signal strength included in the BLE beacon. However, the Far or Near determination is not limited to this. Under the assumption that the broadcasted signal strength of the BLE beacon of the BLE terminal 3 is fixed at all times, a determination may be made based on the received signal strength of the BLE beacon.

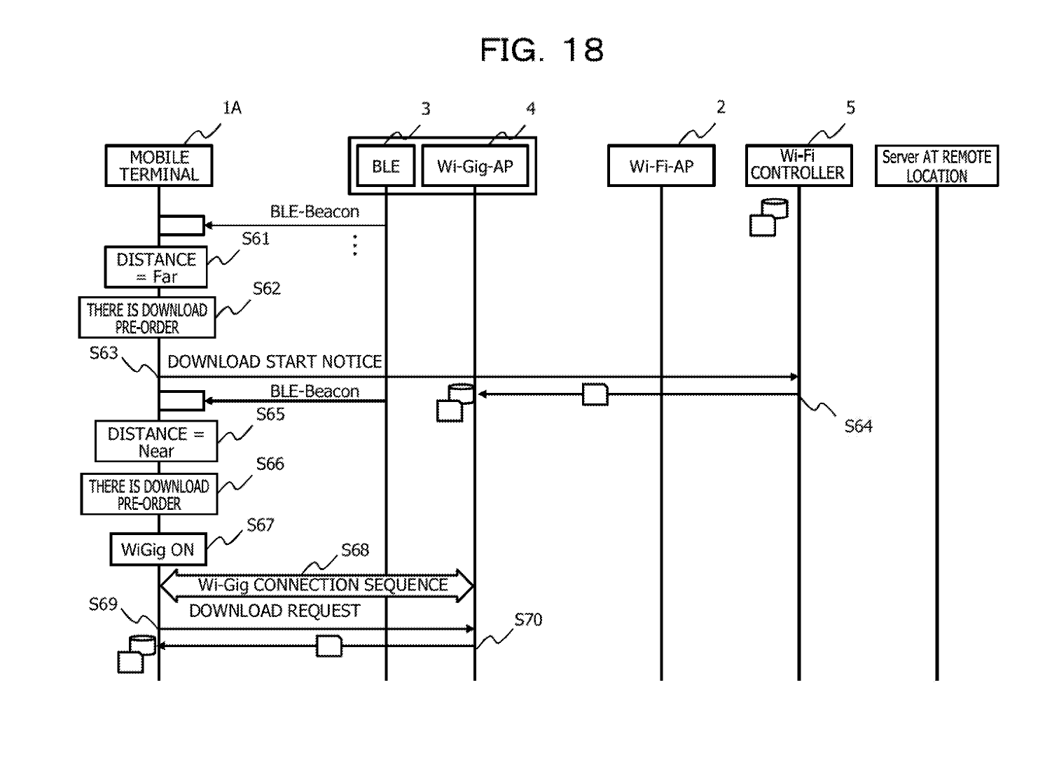

FIG. 18 is a diagram illustrating an example of a sequence of a service provision process in the communication system 100A according to the variation of the first embodiment. FIG. 18 illustrates an example of a case in which download pre-order is set for the mobile terminal 1A. FIG. 18 illustrates processing subsequent to S12 in FIG. 14A. More specifically, FIG. 18 assumes that the mobile terminal 1A establishes connection with the WiFi AP 2, is present in the BLE beacon reachable area of the BLE terminal 3, and receives a BLE beacon broadcasted from the BLE terminal 3.

In S61, the user of the mobile terminal 1A moves to a direction approaching the BLE terminal 3 and the mobile terminal 1A enters the Far area. The mobile terminal 1A determines from the received signal strength of the received BLE beacon that the distance state is Far (FIG. 17, OP62 to OP65: Far).

In S62, the mobile terminal 1A determines that download pre-order is set (FIG. 17, OP69: YES). In S63, the mobile terminal 1A transmits a download start notice to the controller 5 by way of WiFi (FIG. 17, OP70). The download start notice includes a file name of a download target file, a URL, and BLE beacon identification information of the received BLE, for example.

In S64, the controller 5 receives a download start notice from the mobile terminal 1A (FIG. 11B, OP36: YES) and transmits to the WiGig AP 4 a file related to terminal identification information of the mobile terminal 1A, which is stored in the download start notice in the download data cache 54 (FIG. 11B, OP37: YES, OP39). The WiGig AP 4 is identified from the BLE-WiGig association table 55, based on the BLE beacon identification information included in the download start notice. The WiGig AP 4 receives a file from the controller 5 (FIG. 12, OP41) and relates the received file to an IP address of the mobile terminal 1A and stores the file in a cache (FIG. 11, OP42; NO, OP44). The IP address of the mobile terminal 1A is transmitted with the file from the controller 5.

In S65, the user of the mobile terminal 1A moves and further approaches the BLE terminal 3, and the mobile terminal 1A enters the Near area of the BLE terminal 3. The mobile terminal 1A determines from the received signal strength of the received BLE beacon that the distance state is Near (FIGS. 17, OP62 to OP65: Near). In addition, there is a time interval of a few seconds or longer after transmission of the download start notice of S63 and before entry of the Near area of S65, and during this period, downloading of the target file to the WiGig AP 4 is completed.

In S66, the mobile terminal 1A determines that download pre-order is set (FIG. 17, OP74: YES). In S67, the mobile terminal 1A causes WiGig operation to start (FIG. 9B, OP12). In S68, a WiGig connection sequence is performed between the mobile terminal 1A and the WiGig AP 4 (FIG. 9B, OP13). In S69, the mobile terminal 1A transmits a download request (FIG. 9B, OP14).

In S70, the WiGig AP 4 receives the download request from the mobile terminal 1A (FIG. 13, OP51) and transmits to the mobile terminal 1A a file related to an IP address of the mobile terminal 1A in the cache (FIG. 13, OP52: YES, OP53). Subsequently, processing similar to S20 and subsequent steps in FIG. 14B is performed.

<Operation and Effect of Variation of First Embodiment> In the variation of the first embodiment, a distance between the mobile terminal 1A and the BLE terminal 3 is classified into two levels of Far and Near based on the received signal strength of the BLE beacon. When it is determined that a distance between the mobile terminal 1A and the BLE terminal 3 is “Far”, a download start notice is transmitted from the mobile terminal 1A, and a target file is cached to the WiGig AP 4. When it is determined that the distance between the mobile terminal 1A and the BLE terminal 3 is “Near”, the mobile terminal 1A causes WiGig operation to start, and downloads the target file from the WiGig AP 4. When it is determined that the distance between the mobile terminal 1A and the BLE terminal 3 is “Near”, the target file is cached in the WiGig AP 4. Thus, a time period taken for the mobile terminal 1A to download the target file may be reduced by a time period for the target file to be transmitted from an original server to the controller 5 and then from the controller 5 to the WiGig AP 4. Consequently, the WiGig operating time of the mobile terminal 1A may be shortened and power consumption of the mobile terminal 1A may be kept low.

<Second Embodiment> In a second embodiment, a mobile terminal is equipped with a function to broadcast a BLE beacon and a BLE terminal to be arranged at a same position as a WiGig AP acts as a receiver of a BLE beacon. In the second embodiment, a description which is common to the first embodiment is omitted.

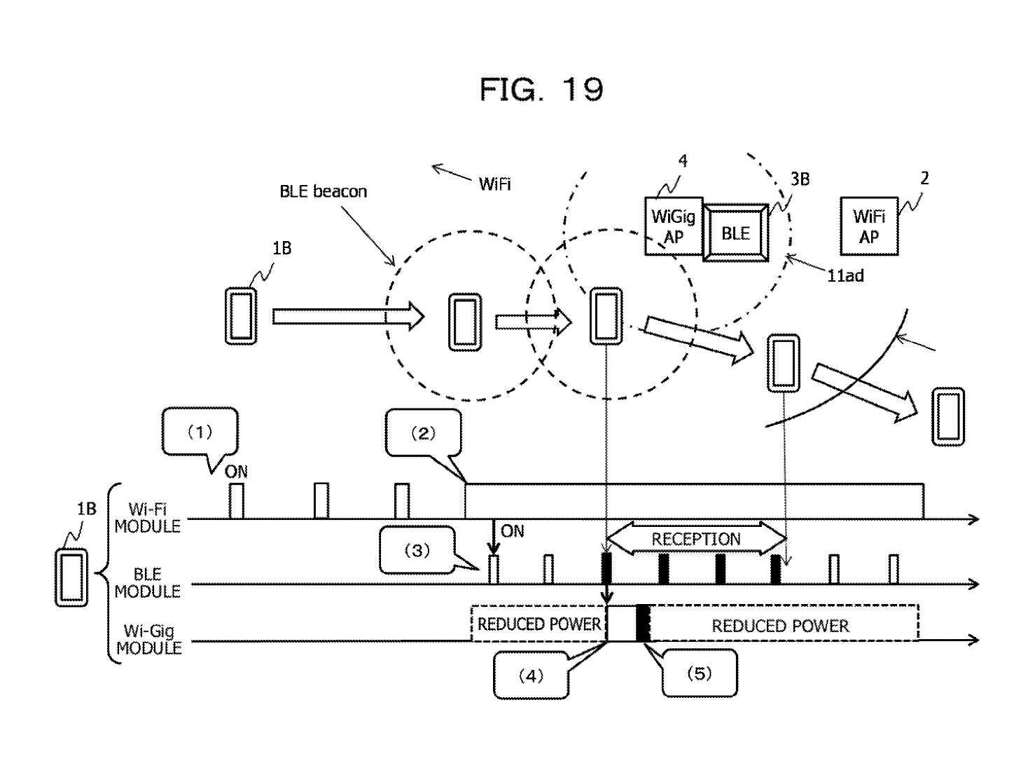

FIG. 19 is a diagram illustrating an example of a timing chart of operation of each communication module of a mobile terminal 1B according to the second embodiment. FIG. 19 illustrates a timing chart of three modules, a WiFi module, a BLE module, and a WiGig module, as a communication module of the mobile terminal 1B. The BLE module is a Bluetooth module having the function to broadcast a BLE beacon.

A communication system of the second embodiment includes the mobile terminal 1B, a WiFi AP 2, a BLE terminal 3B, and a WiGig AP 4. The BLE terminal 3B is a BLE beacon receiver. In FIG. 19, of the communication system, the WiFi AP2, a pair of the BLE terminal 3B and the WiGig AP 4, and one mobile terminal 1B are extracted and illustrated. Arcs by solid lines in FIG. 19 represent the possible communication range of the WiFi AP 2. Circles by dashed lines in FIG. 19 represent a reachable range of a BLE beacon broadcasted by the mobile terminal 1B. Arcs by dot-and-dash lines in FIG. 19 represent the possible communication range of the WiGig AP 4.

The BLE terminal 3B is arranged at an almost same position as the WiGig AP 4. With this, a BLE beacon detectable range (not illustrated) of the BLE terminal 3B and the possible communication range of WiGig AP 4 are set in common. The BLE beacon detectable range of the BLE terminal 3B is a range in which the BLE terminal 3B may receive a BLE beacon at detectable received signal strength, and is a range of a distance of approximately 10 meters from the BLE terminal 3B, for example. The BLE terminal 3B is an example of a “receiver”.

(1) When the mobile terminal 1B is present out of the possible communication range of the WiFi AP 2, the WiFi module of the mobile terminal 1B searches for WiFi AP 2 in a predetermined cycle. A cycle in which the mobile terminal 1B searches for a WiFi AP of the WiFi module is 3 minutes, for example.

(2) When the mobile terminal 1B enters the possible communication range of the WiFi AP 2, a connection sequence is started between the mobile terminal 1B and the WiFi AP 2, and authentication of the mobile terminal 1B is performed. Also in the second embodiment, the controller 5 shall operate as an authentication server. In the second embodiment, authentication of WiGig is also performed together with authentication of WiFi for the mobile terminal 1B. When connection of the mobile terminal 1B and the WiFi AP 2 is established, the controller 5 notifies the mobile terminal 1B by way of the WiFi AP 2 of a WiGig service environment notice that WiGig service is provided in the possible communication range of the WiFi AP 2. The WiGig service environment notice includes BLE beacon identification information, such as UUID or the like, that the mobile terminal 1B is allowed to use.

(3) Upon receipt of the WiGig service environment notice, the mobile terminal 1B causes reception operation of the BLE module to start. Broadcast operation of the BLE module is operation to broadcast a BLE beacon in a predetermined cycle, for example. A broadcasting cycle of BLE beacons is 100 ms, for example. In addition, operating time for broadcasting a BLE beacon per session is a few milliseconds. A BLE beacon includes BLE beacon identification information include in the WiGig service environment notice.

(4) When a user of the mobile terminal 1B moves to a direction approaching the BLE terminal 3B and the BLE terminal 3B receives a BLE beacon broadcasted from the mobile terminal 1B, the BLE terminal 3B transmits to the controller 5 BLE beacon identification information included in the BLE beacon from the mobile terminal 1B. The controller 5 determines whether BLE beacon identification information distributed to the mobile terminal 1B matches the BLE beacon identification information notified by the BLE terminal 3B. If so, the controller 5 notifies the mobile terminal 1B that the mobile terminal 1B is present in the possible communication range of the WiGig AP 4. When receiving from the controller 5 the notice that the mobile terminal 1B is present in the possible communication range of the WiGig AP 4, the mobile terminal 1B causes operation of the WiGig module to start.

(5) The connection sequence is started between the mobile terminal 1B and the WiGig AP 4, and data such as a moving image file, or the like is downloaded. When the downloading is completed, the mobile terminal 1B stops the operation of the WiGig module.

Then, when the mobile terminal 1B detects exit from the possible communication range of the WiFi AP 2, the mobile terminal 1B stops broadcast operation of the BLE module.

In addition, power consumption for reception operation of the Bluetooth module is 100 mW, for example. On the other hand, power consumption for broadcast operation of the BLE module is 1 mW on average. In addition, also as for operating time per session, the reception operation of the Bluetooth module is 30 ms and the broadcast operation of the BLE module is a few milliseconds. Thus, the broadcast operation of the BLE module is shorter. Therefore, in the second embodiment, the mobile terminal 1B broadcasting a BLE beacon, the power consumption of the mobile terminal 1B may be further reduced.

In the second embodiment, a hardware configuration of the mobile terminal 1B is similar to the hardware configuration of the first embodiment. However, a Bluetooth communication unit 115 shall have a function to broadcast a BLE beacon. In addition, a hardware configuration of the BLE terminal 3B is similar to the hardware configuration (see FIG. 5) of the BLE terminal 3 of the first embodiment. In addition, in the second embodiment, the BLE terminal 3B shall have a network interface and connect to a LAN 50. In addition, a hardware configuration of the WiFi AP 2, the WiGig AP 4, and the controller 5 is also similar to the first embodiment.

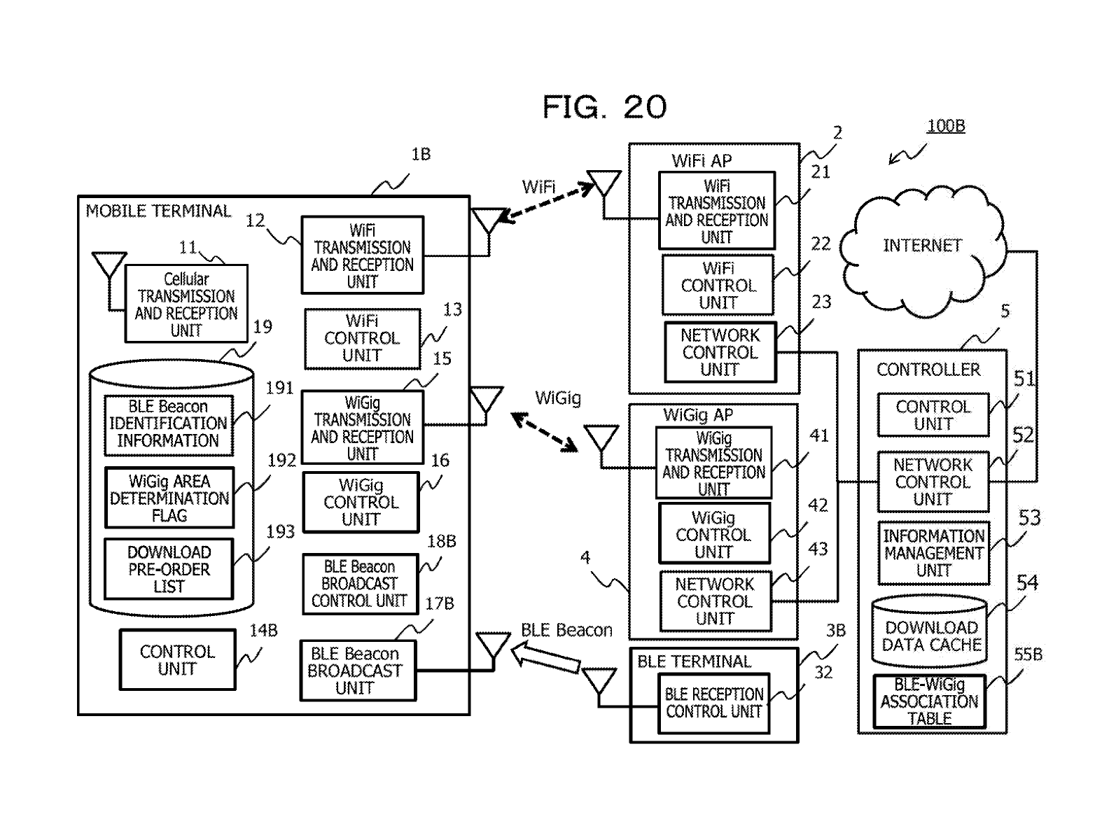

FIG. 20 is a diagram illustrating an example of a functional configuration of a communication system 100B according to the second embodiment. The mobile terminal 1B includes, as a functional configuration, a cellular transmission and reception unit 11, a WiFi transmission and reception unit 12, a WiFi control unit 13, a control unit 14B, a WiGig transmission and reception unit 15, a WiGig control unit 16, a BLE beacon broadcast unit 17B, a BLE beacon broadcast control unit 18B, and an information storage unit 19. Since the cellular transmission and reception unit 11, the WiFi transmission and reception unit 12, the WiFi control unit 13, the WiGig transmission and reception unit 15, the WiGig control unit 16, and the information storage unit 19 are similar to the first embodiment, a description is omitted.

The BLE beacon broadcast unit 17B has a functional configuration corresponding to the Bluetooth communication unit 115 and the Bluetooth antenna 116. The BLE beacon broadcast control unit 18B has a functional configuration that is achieved by a CPU 101 executing a BLE-related module included in an OS. The BLE beacon broadcast control unit 18B controls the BLE beacon broadcast unit 17B. More specifically, the BLE beacon broadcast control unit 18B instructs the BLE beacon broadcast unit 17B to start and stop the broadcast operation of a BLE beacon.

The control unit 14B has a functional configuration that is achieved by the CPU 101 executing a service benefit program. The control unit 14B controls starting and stopping of operation of the BLE beacon broadcast unit 17B and the WiGig transmission and reception unit 15. More specifically, if a starting condition or stopping condition of the broadcast operation of a BLE beacon is satisfied, the control unit 14B instructs the BLE beacon broadcast control unit 18B to start or stop the broadcast operation of the BLE broadcast unit 17B.

The starting condition of the BLE beacon broadcast operation is, for example, that connection with the WiFi AP 2 is established, and that there is a WiGig service environment in the possible communication range of the WiFi AP 2. The stopping condition of the BLE beacon broadcast operation is, for example, that connection with the WiFi AP 2 is disconnected.

When a starting condition or stopping condition of a WiGig operation is satisfied, the control unit 14B instructs the WiGig control unit 16 to start or stop an operation of the WiGig transmission and reception unit 15. The starting condition of the WiGig operation is that the mobile terminal 1B is present in the possible communication range of the WiGig AP 4, and that download pre-order a predetermined file is set. In the second embodiment, presence in the possible communication range of the WiGig AP 4 is synonymous with reception of a notice that the mobile terminal 1B is present in the possible communication range of the WiGig AP 4. However, the starting condition of WiGig reception operation is not limited to this, and setting of download pre-order of a predetermined file may not be included in the condition. The notice that the mobile terminal 1B is present in the possible communication range of the WiGig AP 4 is given by the controller 5 that is notified of reception of the BLE beacon by the BLE terminal 3B that receives the BLE beacon broadcasted from the mobile terminal 1B (Details are described below).

The stopping condition of the WiGig operation in the second embodiment is completion of downloading of a pre-ordered file. However, the stopping condition of the WiGig reception operation is not limited to this, and may be reception from the controller 5 of a notice that the mobile terminal 1B is out of the possible communication range of the WiGig AP 4. The notice that the mobile terminal 1B is out of the possible communication range of the WiGig AP 4 is described below.

The BLE terminal 3B has a BLE reception control unit 32 as a functional configuration. The BLE reception control unit 32 has a functional configuration that is achieved by a CPU incorporated in the BLE terminal 3B executing an OS. The BLE reception control unit 32 controls a Bluetooth reception circuit. More specifically, the BLE reception control unit 32 causes a Bluetooth reception circuit to perform an intermittent reception operation at all times or in a predetermined cycle.

When receiving a BLE beacon, the BLE reception control unit 32 extracts BLE beacon identification information included in the received BLE beacon. The BLE reception control unit 32 determines whether or not the BLE beacon identification information is new. When the BLE beacon identification information is new, the BLE reception control unit 32 transmits the BLE beacon identification information to the controller 5.

In addition, the BLE reception control unit 32 monitors reception of BLE beacons, detects identification information of a BLE beacon that is no longer received, and notifies the controller 5.

A functional configuration of the controller 5 is similar to the first embodiment. In the second embodiment, a control unit 51 of the controller 5 receives an authentication request of the mobile terminal 1B, and notifies the mobile terminal 1B of a WiGig service environment notice when the authentication succeeds. In the second embodiment, the WiGig service environment notice includes BLE beacon identification information, for example, that the mobile terminal 1B is allowed to use.

In addition, when receiving from the BLE terminal 3B the BLE beacon identification information included in the BLE beacon received by the BLE terminal 3B, the control unit 51 determines whether the received BLE beacon identification information matches the BLE beacon identification information notified with the WiGig service environment notice. When the received BLE beacon identification information matches the BLE beacon identification information notified with the WiGig service environment notice, the control unit 51 transmits to the mobile terminal 1B a notice that the mobile terminal 1B is present in the possible communication range of the WiGig AP 4. A notice of presence in or out of the possible communication range of the WiGig AP 4 is hereinafter referred to as a WiGig area notice.

In addition, when receiving BLE beacon identification information corresponding to a BLE beacon of which reception is cut off, from the BLE terminal 3, the control unit 51 determines whether or not the received BLE beacon identification information matches the BLE beacon identification information notified with the WiGig service environment notice. When the received BLE beacon identification information matches the BLE beacon identification information notified with the WiGig service environment notice, the control unit 51 transmits to the mobile terminal 1B the WiGig area notice notifying that the mobile terminal 1B is in the possible communication range of the WiGig AP 4.

Note that processing of the control unit 51 when receiving information on a download file from the mobile terminal 1B through the WiFi AP 2 or a download start notice from the mobile terminal 1B through the WiGig AP 4 is similar to the first embodiment.

Since a functional configuration of the WiFi AP 2 and the WiGig AP 4 is similar to the first embodiment, a description is omitted.

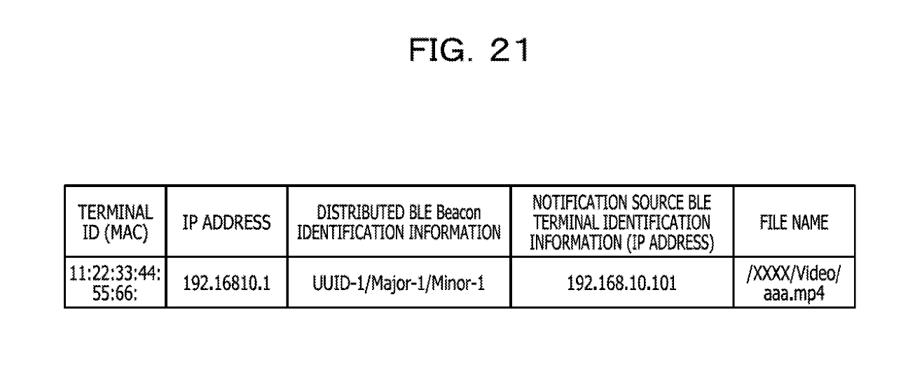

FIG. 21 is a diagram illustrating an example of an index to be stored in a download data cache 54 of the controller 5 according to the second embodiment. In the second embodiment, BLE beacon identification information and an IP address of the BLE terminal 3B of a notification source are associated and stored in an index of the download data cache 54, in addition to terminal identification information and an IP address of the mobile terminal 1B, and a file name of a download target file.

BLE beacon identification information is BLE beacon identification information distributed by the controller 5 to the mobile terminal 1B. An IP address of the BLE terminal 3B of the notification source is an IP address of the BLE terminal 3B that receives a BLE beacon broadcasted from the mobile terminal 1B and notifies the BLE beacon identification information.

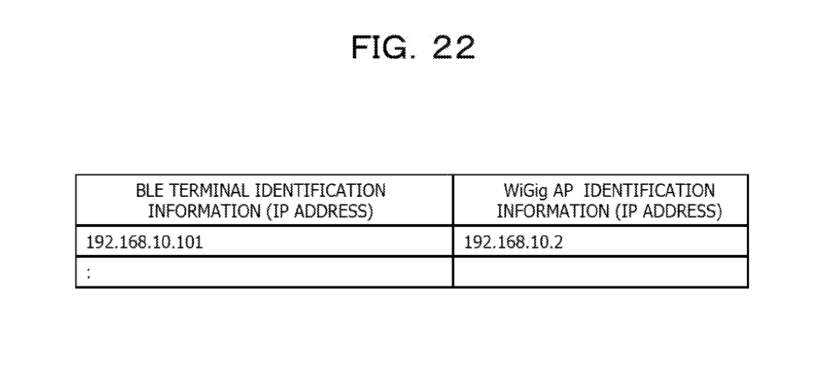

FIG. 22 is an example of a BLE-WiGig association table 55B held by the controller 5 according to the second embodiment. In the second embodiment, the IP address of the BLE terminal 3B is used as BLE terminal identification information. Information included in the BLE-WiGig association table 55B is registered in advance in the communication system 100B by an administrator.

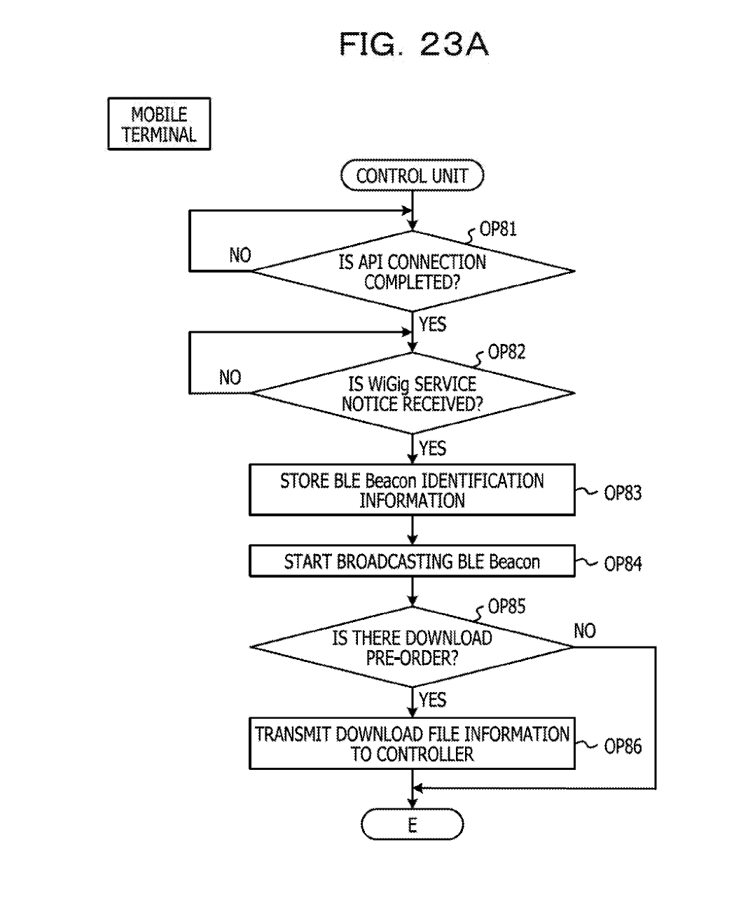

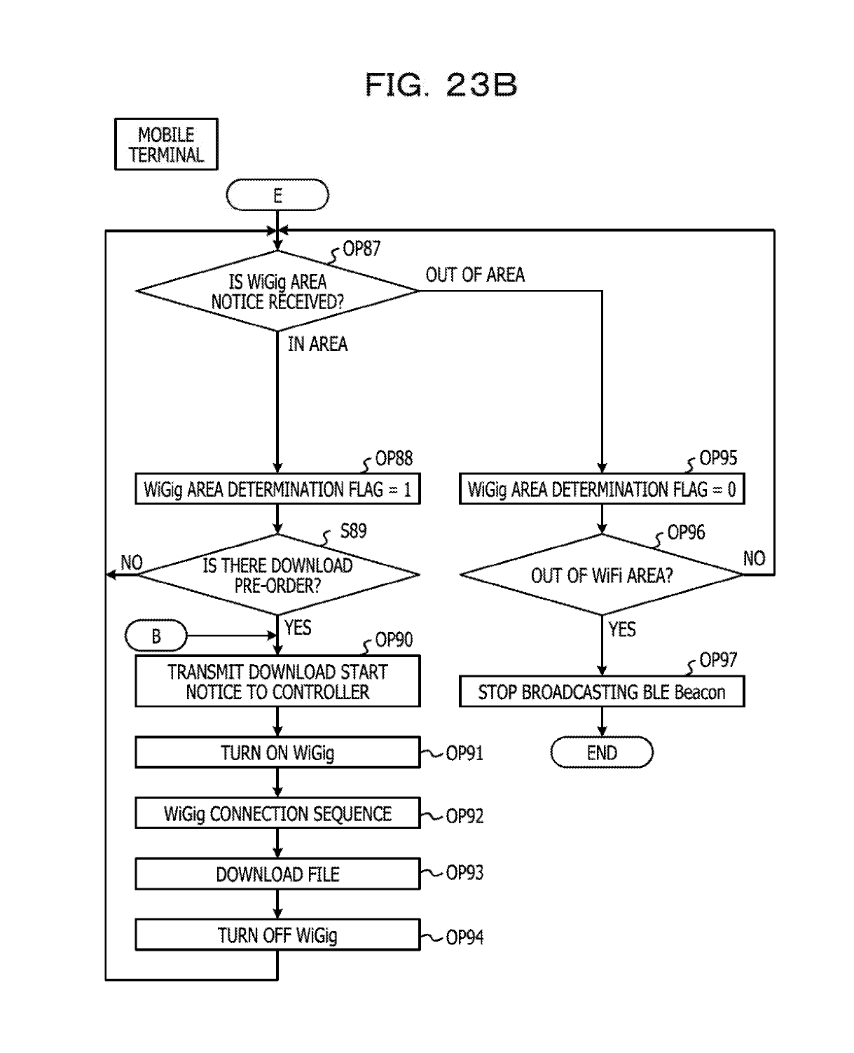

FIGS. 23A and 23B are an example of a flow chart of processing of the control unit 14B of the mobile terminal 1B. Processing illustrated in FIGS. 23A and 23B is started when the WiFi control unit 13 notifies the control unit 14B of establishment of connection with the WiFi AP 2.

In OP81, the control unit 14B is in a state waiting for reception of a notice from the WiFi control unit 13 that establishment of connection with the WiFi AP 2 is completed. When the control unit 14B is notified by the WiFi control unit 13 that establishment of connection with the WiFi AP 2 is completed (OP81: YES), processing proceeds to OP82.

In OP82, the control unit 14B waits for reception of a WiGig service environment notice from the controller 5 by way of WiFi. When the control unit 14B receives the WiGig service environment notice by way of the WiFi control unit 13 (OP82: YES), processing proceeds to OP83. For example, when the WiGig service environment notice is not received even if a predetermined time elapses after establishment of connection with the WiFi AP 2 is completed, processing illustrated in FIG. 23A ends (OP82: NO).

In OP83, the control unit 14B stores BLE beacon identification information included in the received WiGig service environment notice, as BLE beacon identification information 191, in the information storage unit 19.

In OP84, the control unit 14B instructs the BLE beacon broadcast control unit 18B to start broadcast operation of a BLE beacon. Upon receiving this instruction, the BLE beacon broadcast control unit 18B causes the BLE beacon broadcast unit 17B to start the broadcast operation of the BLE beacon.

In OP85, the control unit 14B determines whether or not there is setting of download pre-order. When there is setting of download pre-order (OP85: YES), processing proceeds to OP86. When there is no setting of download pre-order (OP85: NO), processing proceeds to OP87.

In OP86, since there is setting of download pre-order, the control unit 14B reads information on a download target file held in a download pre-order list 193 and transmits the information on the download target file as download file information from the WiFi transmission and reception unit 12 to the controller 5. The download file information includes a file name of the download target file, URL, or the like.

In OP87 in FIG. 23B, the control unit 14B waits for receiving a WiGig area notice. When the WiGig area notice inputted from the WiFi control unit 13 indicates that the mobile terminal 1B is in the possible communication range of the WiGig AP 4 (OP87: In area), processing proceeds to OP88. When the WiGig area notice inputted from the WiFi control unit 13 indicates that the mobile terminal 1B is out of the possible communication range of the WiGig AP 4 (OP87: Out of area), processing proceeds to OP95.

In OP88, since the WiGig area notice notifies that the mobile terminal 1B is in the possible communication range of the WiGig AP 4, the control unit 14B sets a WiGig area determination flag 192 to 1.

Processing in OP89 to OP94 to start WiGig operation, download a target file, and stop WiGig operation is similar to the processing of the control unit 14 of the first embodiment (OP10 to OP15 in FIG. 9B), a description is omitted.

In OP95, since the WiGig area notice notifies that the mobile terminal 1B is out of the possible communication range of the WiGig AP 4, the control unit 14B sets the WiGig area determination flag 192 to 0.

In OP96, the control unit 14B whether or not the mobile terminal 1B is present out of the possible communication range of the WiFi AP 2. This determination is made depending on whether or not the control unit 14B is notified by the WiFi control unit 13 of disconnection of connection with the WiFi AP 2. When the mobile terminal 1B is present out of the possible communication range of the WiFi AP 2 (OP96: YES), processing proceeds to OP97. When the mobile terminal 1B is present in the possible communication range of the WiFi AP 2 (OP96: NO), processing proceeds to OP87.

In OP97, since the mobile terminal 1B is located out of the possible communication range of the WiFi AP 2, the control unit 14B instructs the BLE beacon broadcast control unit 18B to stop broadcast operation of a BLE beacon. Upon receiving the instruction from the control unit 14B, the BLE beacon broadcast control unit 18B stops broadcast operation of a BLE beacon of the BLE beacon broadcast unit 17B. Then, processing illustrated in FIG. 23B ends.

Note that processing illustrated in FIGS. 23A and 23B is an example, and order of performing processes depends on an embodiment. For example, an instruction to start the broadcast operation of a BLE beacon in OP84 may be provided immediately after processing of OP86.

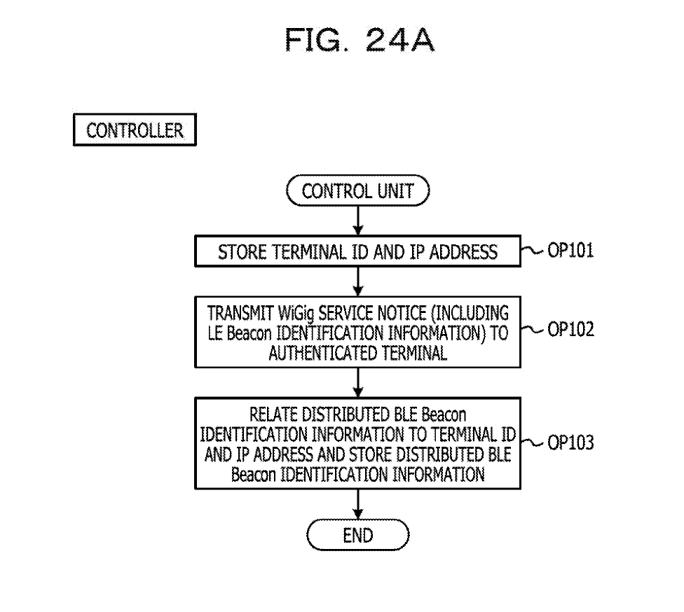

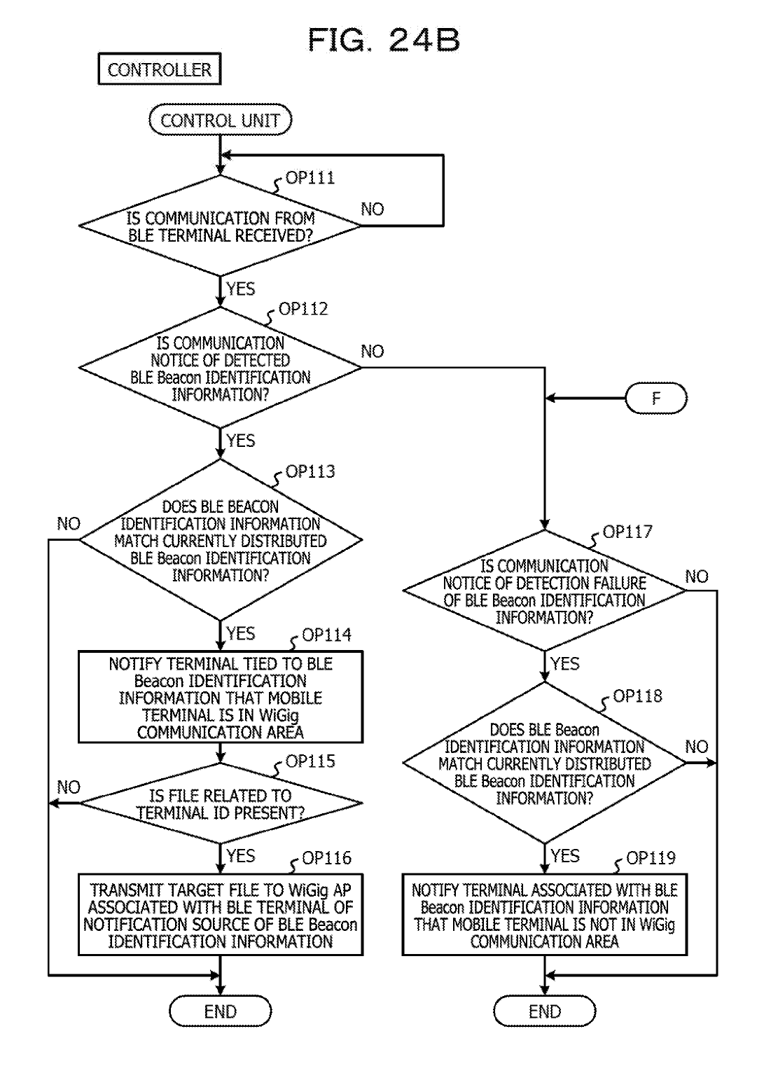

FIG. 24A is an example of a flow chart of processing to be performed by the controller 5 according to the second embodiment after authentication of the mobile terminal 1B is completed. Processing illustrated in FIG. 24A is started when authentication of the mobile terminal 1B succeeds.

In OP101, the control unit 51 relates terminal identification information to an IP address of the mobile terminal 1B authentication of which succeeds and stores the terminal identification information and the IP address in an index of the download data cache 54. The terminal identification information of the mobile terminal 1B is a MAC address, for example.

In OP102, the control unit 51 transmits a WiGig service environment notice to the mobile terminal 1B. The WiGig service environment notice includes BLE beacon identification information that the mobile terminal 1B is allowed to use. The WiGig service environment notice is delivered to the mobile terminal 1B by way of the WiFi AP 2.

In OP103, the control unit 51 relates the BLE beacon identification information, which is distributed to the mobile terminal 1B, to the terminal identification information and the IP address of the mobile terminal 1B and stores the BLE beacon identification and the IP address in an index of the download data cache 54. Then, processing illustrated in FIG. 24A ends.

FIG. 24B is an example of a flow chart of processing of the controller 5 according to the second embodiment when receiving communication from a BLE terminal 3B. Processing illustrated in FIG. 24B is started when the controller 5 receives communication from the BLE terminal 3B.

In OP111, the control unit 51 waits for communication from the BLE terminal 3B. When the control unit 51 receives communication from the BLE terminal 3B (OP111: YES), processing proceeds to OP112.

In OP112, the control unit 51 determines whether or not the communication from the BLE terminal 3B is a notice of the BLE beacon identification information newly detected by the BLE terminal 3B. When the communication from the BLE terminal 3B is the notice of the BLE beacon identification information newly detected by the BLE terminal 3B (OP112: YES), processing proceeds to OP113. When the communication from the BLE terminal 3B is not a notice of the BLE beacon identification information newly detected by the BLE terminal 3B (OP112: NO), processing proceeds to OP117.

Processing from OP113 to OP116 is processing when a notice of BLE beacon identification information that the BLE terminal 3B newly detects is received. In OP113, the control unit 51 determines whether or not BLE beacon identification information notified by the BLE terminal 3B matches the BLE beacon identification information being distributed to the mobile terminal 1B. The BLE beacon identification information being distributed to the mobile terminal 1B is stored in the index of the download data cache 54. When the BLE beacon identification information notified by the BLE terminal 3B matches the BLE beacon identification information being distributed to the mobile terminal 1B (OP113: YES), processing proceeds to OP114. When the BLE beacon identification information notified by the BLE terminal 3B does not match the BLE beacon identification information being distributed to the mobile terminal 1B (OP113: NO), processing illustrated in FIG. 24B ends.

In OP114, the control unit 51 identifies terminal identification information related to the BLE beacon identification information that matches the BLE beacon identification information received from the BLE terminal 3B, in the index of the download data cache 54. The control unit 51 transmits to the mobile terminal 1B associated with the identified terminal identification information the WiGig area notice notifying that the mobile terminal 1B is in the possible communication range of the WiGig AP 4. The control unit 51 relates an IP address of the BLE terminal 3B of a notification source of the BLE beacon identification information to the terminal identification information of the identified mobile terminal 1B and stores the IP address in the index of the download data cache 54.

In OP115, the control unit 51 determines whether or not the file related to the terminal identification information identified in OP114 is stored in the download data cache 54. When the file related to the terminal identification information identified in OP114 is present in the download data cache 54 (OP115: YES), processing proceeds to OP116. When the file related to the terminal identification information identified in OP114 is not present in the download data cache 54 (OP115: NO), processing illustrated in FIG. 24B ends.

In OP116, the control unit 51 transmits the file related to the terminal identification information identified in OP114 to the WiGig AP 4 associated with the BLE terminal 3B that is the notification source of the BLE beacon identification information. The WiGig AP 4 associated with the BLE terminal 3B is identified based on the BLE-WiGig association table 55B. Then, processing illustrated in FIG. 24B ends.

In OP117, the control unit 51 determines whether or not communication from the BLE terminal 3B is a notice of BLE beacon identification information that may no longer be detected. When the communication from the BLE terminal 3B is the notice of BLE beacon identification information that may no longer be detected (OP117: YES), processing proceeds to OP118. When the communication from the BLE terminal 3B is not the notice of BLE beacon identification information that may no longer be detected (OP117: NO), processing illustrated in FIG. 24B ends.

In OP118, the control unit 51 determines whether or not the BLE beacon identification information notified by the BLE terminal 3B matches the BLE beacon identification information being distributed to the mobile terminal 1B. The BLE beacon identification information being distributed to the mobile terminal 1B is stored in the download data cache 54. When the BLE beacon identification information notified by the BLE terminal 3B matches the BLE beacon identification information being distributed to the mobile terminal 1B (OP118: YES), processing proceeds to OP119. When the BLE beacon identification information notified by the BLE terminal 3B does not match the BLE beacon identification information being distributed to the mobile terminal 1B (OP118: NO), processing illustrated in FIG. 24B ends.

In OP119, the control unit 51 identifies in the download data cache 54 terminal identification information related to the BLE beacon identification information that matches the BLE beacon identification information received from the BLE terminal 3B. The control unit 51 transmits to the mobile terminal 1B associated with the identified terminal identification information the WiGig area notice notifying that the mobile terminal 1B is out of the possible communication range of the WiGig AP 4. Then, processing illustrated in FIG. 24B ends. Note that also in the second embodiment, the controller 5 performs the processing in FIG. 9B even when receiving communication from the mobile terminal 1B.

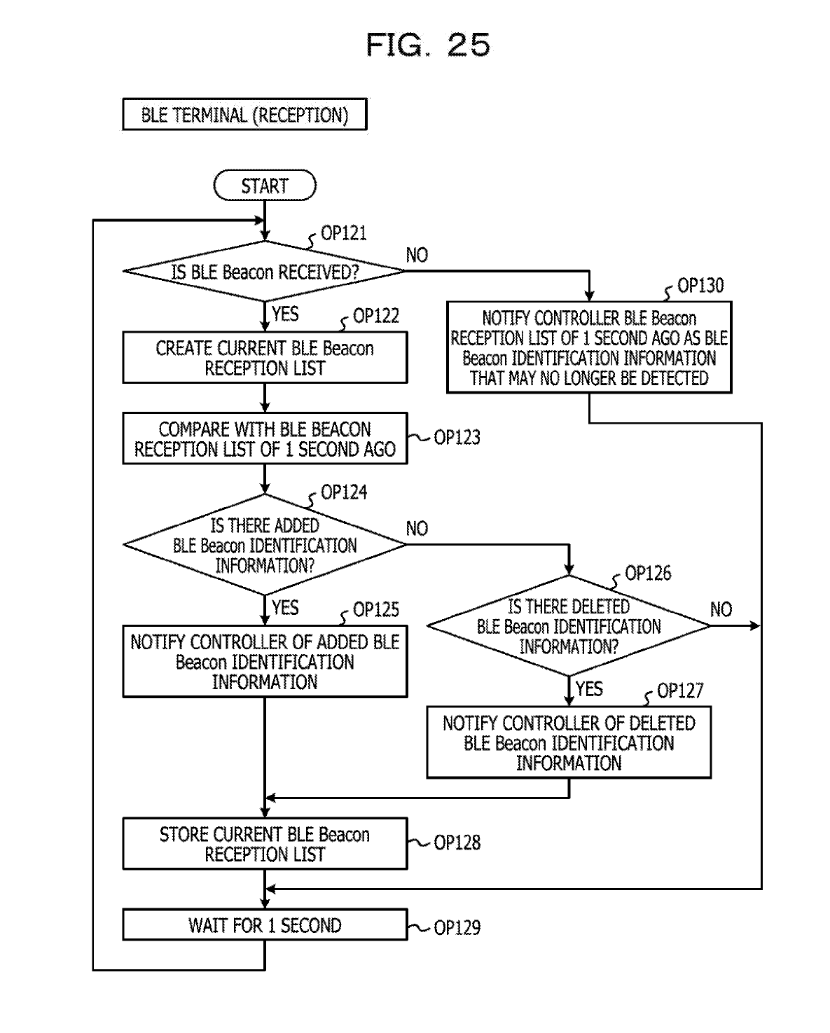

FIG. 25 is an example of a flow chart of processing of the BLE terminal 3B. Processing illustrated in FIG. 25 is started when the BLE terminal 3B receives a BLE beacon. While a main entity of the processing in FIG. 25 is a CPU of the BLE terminal 3B, for convenience, a description is given, assuming that the BLE reception control unit 32, which has a functional configuration, is a main entity.

In OP121, the BLE reception control unit 32 waits for reception of a BLE beacon. Reception of a BLE beacon is detected when received signal strength is equal to or larger than a threshold. When the BLE reception control unit 32 detects reception of a BLE beacon (OP121: YES), processing proceeds to OP122. When the BLE reception control unit 32 does not detect reception of the BLE beacon even after a predetermined time elapses (OP121: NO), processing proceeds to OP130. A waiting time for detection of reception of a BLE beacon is 1 second, for example.

In OP122, the BLE reception control unit 32 creates a current BLE beacon reception list. The BLE beacon reception list includes BLE beacon identification information included in the BLE beacon received in OP121. The BLE beacon reception list is stored in a RAM of the BLE terminal 3B, for example.

In OP123, the BLE reception control unit 32 compares a BLE beacon reception list of 1 second ago with the current BLE beacon reception list. When there is no BLE beacon reception list of 1 second ago, processing proceeds to OP125.

In OP124, the BLE reception control unit 32 determines whether or not newly added BLE beacon identification information, that is not included in the BLE beacon reception list of 1 second ago, is in the current BLE beacon reception list. When the newly added BLE beacon identification information is in the current BLE beacon reception list (OP124: YES), processing proceeds to OP125. When the newly added BLE beacon identification information is not in the current BLE beacon reception list (OP124: NO), processing proceeds to OP126.

In OP125, since the newly added BLE beacon identification information is in the current BLE beacon reception list, the BLE reception control unit 32 notifies the controller 5 of the newly added BLE beacon identification information as newly detected BLE beacon identification information.

In OP126, the BLE reception control unit 32 determines whether or not there is BLE beacon identification information that is included in the BLE beacon reception list of 1 second ago, that is not included in the current BLE beacon reception list, and that is deleted from the BLE beacon reception list of 1 second ago. When there is the BLE beacon identification information deleted from the BLE beacon reception list of 1 second ago (OP126: YES), processing proceeds to OP127. When there is neither BLE beacon identification information added from the BLE beacon reception list of 1 second ago nor deleted BLE beacon identification information (OP126: NO), processing proceeds to OP129.

In OP127, the BLE reception control unit 32 notifies the controller 5 of the deleted BLE beacon identification information, as BLE beacon identification information that may no longer be detected.

In OP128, the BLE reception control unit 32 stores the current BLE beacon reception list. Then, the BLE beacon reception list may also be stored by overwriting.

In OP129, the BLE reception control unit 32 waits for 1 second. Then, processing proceeds to OP121. In OP121, if a BLE beacon is received while the BLE reception control unit 32 is waiting for 1 second (OP121: YES), a current BLE beacon reception list is created for the received BLE beacon. If no BLE beacon is received while the BLE reception control unit 32 is waiting for 1 second (OP121: NO), processing proceeds to OP130.

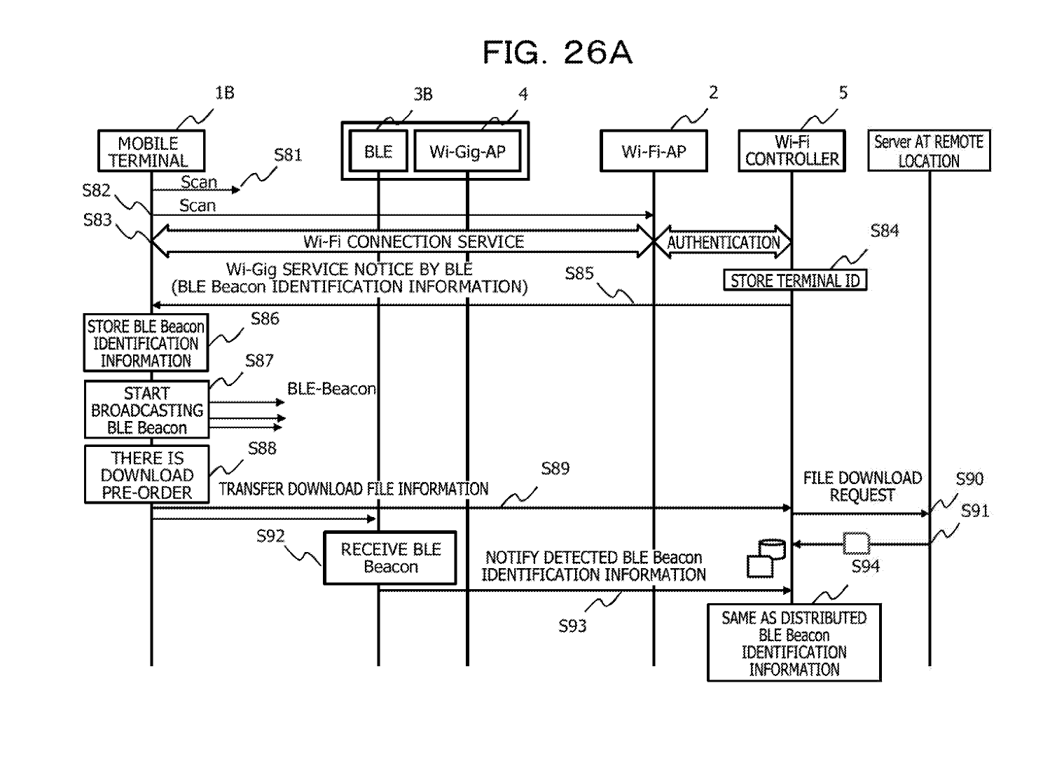

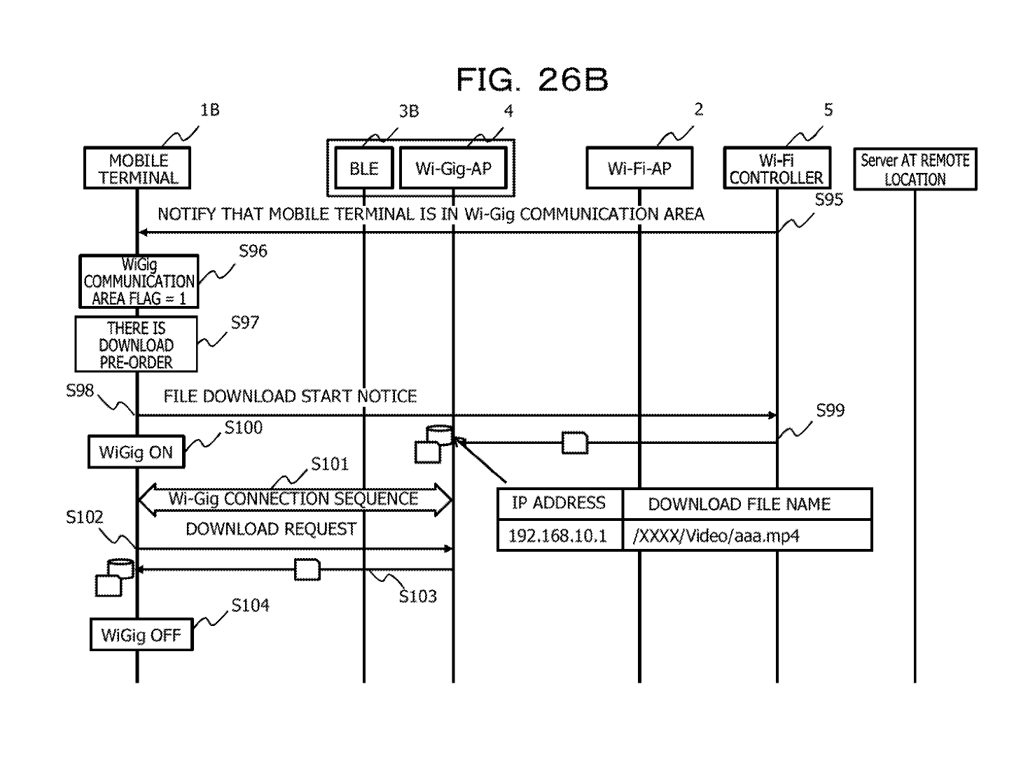

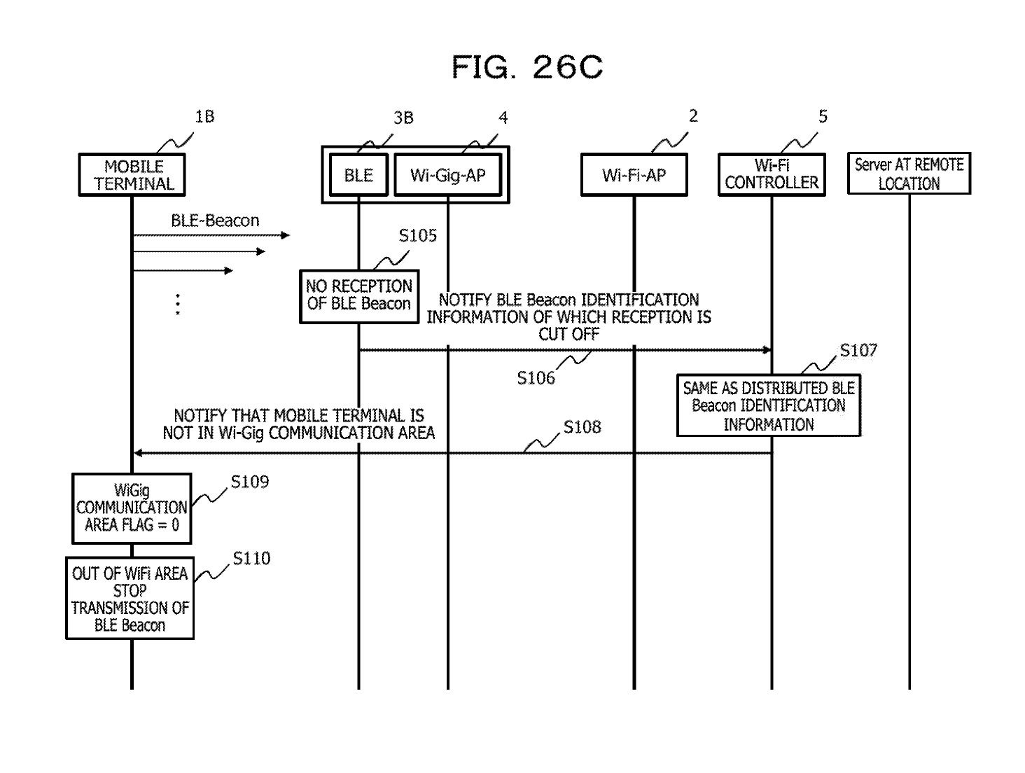

In OP130, since the BLE beacon is not received while the BLE reception control unit 32 is waiting for 1 second, the BLE reception control unit 32 notifies the controller 5 of BLE beacon identification information included in the BLE beacon reception list of 1 second ago as BLE beacon identification information that may no longer be detected. Then, processing proceeds to OP129. In OP130, when no BLE beacon reception list of 1 second ago does not exist, the BLE reception control unit 32 notifies the controller 5 of nothing.

<Specific Example of Sequence of Second Embodiment> FIGS. 26A to 26C are diagrams illustrating an example of a sequence of a service provision process in the communication system 100B according to the second embodiment. FIGS. 26A to 26C illustrates an example of a case in which download pre-order is set for the mobile terminal 1B. In FIG. 26A, it is assumed that the mobile terminal 1B is present out of the possible communication range of the WiFi AP 2.

In S81, since the mobile terminal 1B performs scanning in a predetermined cycle to search for the WiFi AP 2. A scanning cycle is 20 seconds, for example. In S82, the mobile terminal 1B moves to enter the possible communication range of the WiFi AP 2, and the mobile terminal 1B detects the WiFi AP 2 through scanning. In S83, a connection sequence is performed between the mobile terminal 1B and the WiFi AP 2. In this connection sequence, authentication of the mobile terminal 1B is performed by the controller 5.

In S84, the controller 5 performs an authentication process based on an authentication request of the mobile terminal 1B, relates terminal identification information to an IP address of the mobile terminal 1B, and stores the terminal identification information and the IP address in the download data cache 54 (FIG. 24A, OP101).

In S85, the controller 5 transmits a WiGig service environment notice to the mobile terminal 1B (FIG. 24A, OP102). The WiGig service environment notice includes BLE beacon identification information that the mobile terminal 1B is allowed to use. The controller 5 relates the BLE beacon identification information distributed to the mobile terminal 1B to the terminal identification information and the IP address of the mobile terminal 1B and stores the BLE beacon identification information in an index of the download data cache 54 (FIG. 24A, OP103).

The WiGig service environment notice is received by the mobile terminal 1B by way of WiFi, more specifically, by way of the WiFi AP 2 (FIG. 23A, OP82: YES). In S86, the mobile terminal 1B stores the BLE beacon identification information included in the WiGig service environment notice in the information storage unit 19 as the BLE beacon identification information 191 (FIG. 23A, OP83).

In S87, the mobile terminal 1B causes broadcast operation of a BLE beacon to start (FIG. 23A, OP84). A BLE beacon broadcasted from the mobile terminal 1B includes the BLE beacon identification information 191, more specifically, the BLE beacon identification information notified with the WiGig service environment notice.

In S88, the mobile terminal 1B determines that download pre-order is set (FIG. 23A, OP85: YES). In S89, the mobile terminal 1B transmits download file information to the controller 5 (FIG. 23A, OP86). The download file information includes a file name of a download target file and a URL. Since the mobile terminal 1B establishes connection with the WiFi AP 2, the download file information is transmitted by way of WiFi.

In S90, the controller 5 receives the download file information from the mobile terminal 1B (FIG. 11B, OP34: YES) and transmits a download request of a target file to a corresponding server of the URL included in the download file information (FIG. 11B, OP35). In S91, the controller 5 receives the target file from the corresponding server, associates the target file with terminal identification information and an IP address of the mobile terminal 1B and distributed BLE beacon identification information, and stores the target file in the download data cache 54 (FIG. 11B, OP35).

In S92, the user of the mobile terminal 1B moves to a direction approaching the BLE terminal 3B. When the BLE terminal 3B is included in the BLE beacon reachable range of the mobile terminal 1B, the BLE terminal 3B receives a BLE beacon broadcasted from the mobile terminal 1B (FIG. 25, OP121: YES). The BLE terminal 3B shall not receive a BLE beacon from anything other than the mobile terminal 1B.

In S93, the BLE terminal 3B notifies the controller 5 of the BLE beacon identification information included the BLE beacon broadcasted by the mobile terminal 1B, as newly detected BLE beacon identification information (FIG. 25, OP124: YES, OP125).

In S94, the controller 5 determines that the BLE beacon identification information received from the BLE terminal 3B matches the BLE beacon identification information distributed (FIG. 24B, OP113: YES).

In S95 of FIG. 26B, the controller 5 acquires from the download data cache 54 terminal identification information of the mobile terminal 1B related to BLE beacon identification information that is same as the BLE beacon identification information received from the BLE terminal 3B. The controller 5 transmits to the mobile terminal 1B a WiGig area notice notifying that the mobile terminal 1B is in the possible communication range of the WiGig AP 4 (FIG. 24B, OP114). The controller 5 registers an IP address of the BLE terminal 3B of a notification source in an entry of an index of the download data cache 54 that matches the received BLE beacon identification information.

In the example illustrated in FIG. 26B, at this point in time, the controller 5 holds a file related to the terminal identification information of the mobile terminal 1B in the download data cache 54 (FIG. 24B, OP115: YES). Thus, the controller 5 may transmit a target file to the WiGig AP 4 (FIG. 24B, OP116). In FIG. 26B, these processes shall not be performed for the purpose of illustration.

In S96, the mobile terminal 1B receives a WiGig area notice notifying that the mobile terminal 1B is in the possible communication range of the WiGig AP 4 (FIG. 23B, OP87: In area), the mobile terminal 1B sets the WiGig area setting flag 192 to 1 (FIG. 23B, OP88).

In S97, the mobile terminal 1B determines that download pre-order is set (FIG. 23B, OP89: YES). In S98, the mobile terminal 1B transmits a download start notice to the controller 5 by way of WiFi (FIG. 23B, OP90). The download start notice includes a file name of a download target file and a URL, for example.

In S99, the controller 5 receives the download start notice from the mobile terminal 1B (FIG. 11B, OP36: YES) and transmits to the WiGig AP 4 a file that is stored in the download data cache 54 and related to terminal identification information of the mobile terminal 1B (FIG. 11B, OP37: YES, OP39). The WiGig AP 4, which is a file transmission destination, is identified as follows. The controller 5 identifies an IP address of the BLE terminal 3B associated with terminal identification information of the mobile terminal 1B, in the index of the download data cache 54. The controller 5 identifies the WiGig AP 4, which is the file transmission destination, by identifying an IP address of the WiGig AP 4 associated with the IP address of the identified BLE terminal 3B, in the BLE-WiGig association table 55B.

The WiGig AP 4 receives the file from the controller 5 (FIG. 12, OP41), relates the received file to an IP address of the mobile terminal 1B, and stores the file in a cache (FIG. 12, OP42: NO, OP44). The IP address of the mobile terminal 1B is transmitted with the file from the controller 5.

In S100, the mobile terminal 1B causes WiGig operation to start after transmitting the download start notice (FIG. 23B, OP91). In S101, a WiGig connection sequence is performed between the mobile terminal 1B and the WiGig AP 4 (FIG. 23B, OP92). Note that since authentication in WiFi sequence in S83 also serves as authentication of WiGig, authentication is not performed in the WiGig connection sequence. In S102, the mobile terminal 1B transmits a download request (FIG. 23B, OP93).

In S103, the WiGig AP 4 receives the download request from the mobile terminal 1B (FIG. 13, OP51) and transmits to the mobile terminal 1B a file related to the IP address of the mobile terminal 1B in a cache (FIG. 13, OP52: YES, OP53).

In S104, the mobile terminal 1B completes downloading of the file and stops the WiGig operation (FIG. 23B, OP94).

In S105 in FIG. 26C, the user of the mobile terminal 1B moves to a direction away from the WiGig AP 4 and the BLE terminal 3B moves out of a BLE beacon reachable range of the mobile terminal 1B. With this, the received signal strength of a BLE beacon from the mobile terminal 1B in the BLE terminal 3B drops and the BLE terminal 3B detects that a BLE beacon from the mobile terminal 1B is no longer received (FIG. 25, OP121: NO).

In S106, the BLE terminal 3B notifies the controller 5 of the BLE beacon identification information included in the BLE beacon broadcasted from the mobile terminal 1B as BLE beacon identification information that may no longer be detected (FIG. 25, OP130).

In S107, the controller 5 determines that the BLE beacon identification information received from the BLE terminal 3B matches the distributed BLE beacon identification information (FIG. 24B, OP118: YES).

In S108, the controller 5 acquires from the download data cache 54 terminal identification information of the mobile terminal 1B related to the BLE beacon identification information that is same as the BLE beacon identification information received from the BLE terminal 3B. The controller 5 transmits to the mobile terminal 1B a WiGig area notice notifying the mobile terminal 1B is out of the possible communication range of the WiGig AP 4 (FIG. 24B, OP119).

In S109, the mobile terminal 1B receives a WiGig area notice notifying that the mobile terminal 1B is out of the possible communication range of the WiGig AP 4 (FIG. 23B, OP87: Out of area) and sets the WiGig area determination flag 192 to 0 (FIG. 23B, OP95).

In S110, the user of the mobile terminal 1B moves to a direction away from the WiFi AP 2 and exits from the possible communication range of the WiFi AP 2. The mobile terminal 1B detects the exit from the possible communication range of the WiFi AP 2 based on the received signal strength of the WiFi beacon from the WiFi AP 2 (FIG. 23B, OP96: YES) and stops the broadcast operation of a BLE beacon (FIG. 23B, OP97).

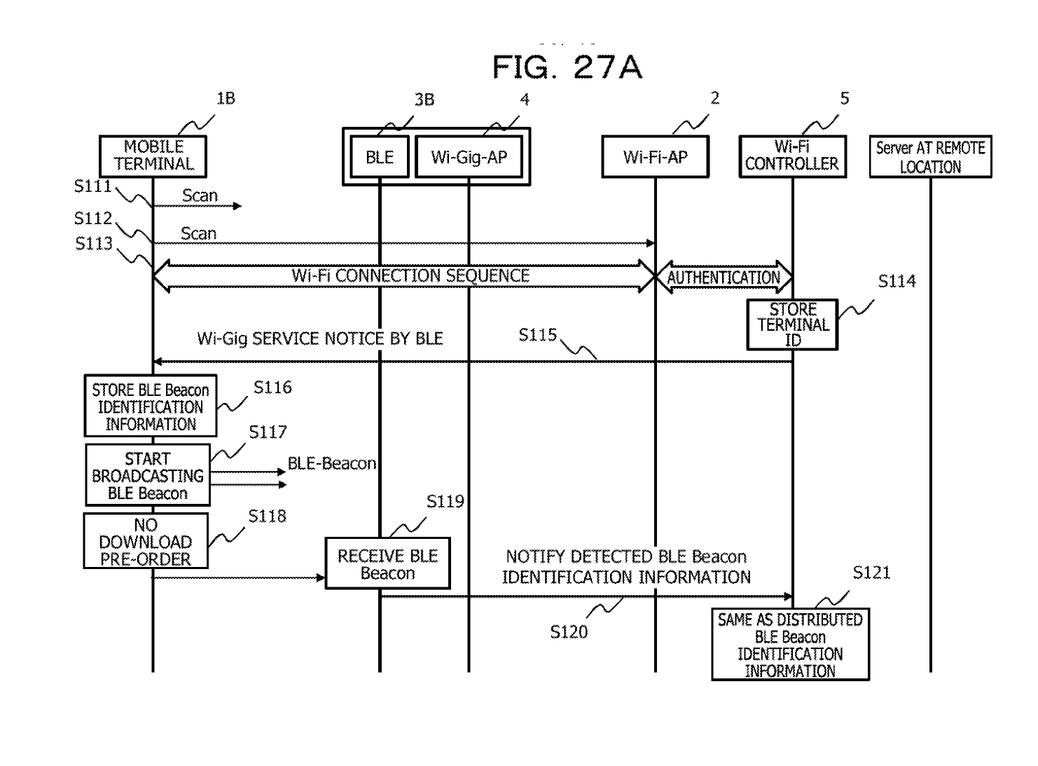

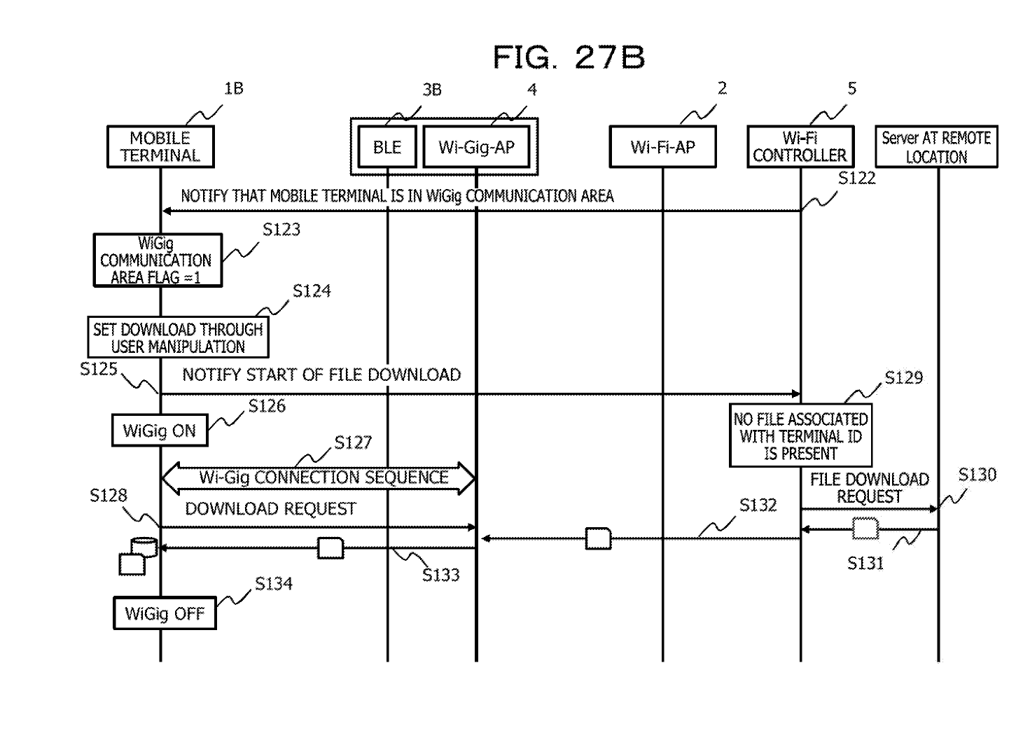

FIGS. 27A and 27B are diagrams illustrating an example of a sequence of the service provision process in the communication system 100B according to the second embodiment. FIGS. 27A and 27B illustrates an example of a case in which download pre-order is not set for the mobile terminal 1B. In FIG. 27A, it is assumed that the mobile terminal 1B is present out of the possible communication range of the WiFi AP 2.

the processing from S111 to S117 is similar to S81 to S87 in FIG. 26A. More specifically, in S111 to S117, the user of the mobile terminal 1B enters the possible communication range of the WiFi AP 2. The mobile terminal 1B establishes connection with the WiFi AP 2, receives a WiGig service environment notice from the controller 5 and starts broadcast operation of the BLE beacon.

In S118, the mobile terminal 1B determines that download pre-order is not set (FIG. 23B, OP89: NO).

In S119, the user of the mobile terminal 1B moves to a direction approaching the BLE terminal 3B. When the BLE terminal 3B is included in the reachable range a BLE beacon of the mobile terminal 1B, the BLE terminal 3B receives a BLE beacon broadcasted from the mobile terminal 1B (FIG. 25, OP121: YES). The BLE terminal 3B shall not receive a BLE beacon from anything other than the mobile terminal 1B.

In S120, the BLE terminal 3B notifies the controller 5 of BLE beacon identification information included in a BLE beacon broadcasted by the mobile terminal 1B, as newly detected BLE beacon identification information (FIG. 25, OP124: YES, OP125).

In S121, the controller 5 determines that the BLE beacon identification information received from the BLE terminal 3B matches the distributed BLE beacon identification information (FIG. 24B, OP113: YES).

In S122 of FIG. 27B, the controller 5 acquires from the download data cache 54 terminal identification information of the mobile terminal 1B related to BLE beacon identification information which is same as the BLE beacon identification information received from the BLE terminal 3B. The controller 5 transmits to the mobile terminal 1B a WiGig area notice notifying that the mobile terminal 1B is in the possible communication range of the WiGig AP 4 (FIG. 24B, OP114). The controller 5 registers an IP address of the BLE terminal 3B of a notification source in an entry of an index of the download data cache 54 that matches the received BLE beacon identification information.

In S123, since the mobile terminal 1B receives the WiGig AP 4 notifying that the mobile terminal 1B is in the possible communication range of the WiGig AP 4 (FIG. 23B, OP87: In area), the mobile terminal 1B sets the WiGig area determination flag 192 to 1 (FIG. 23B, OP88).

In S124, the mobile terminal 1B receives input of download pre-order through user manipulation (FIG. 12, OP21: YES). In S125, since the WiGig area determination flag 192 is 1 (FIG. 12, OP22: NO), the mobile terminal 1B transmits a download start notice to the controller 5 by way of WiFi (FIG. 23B, OP90). The download start notice includes a file name of a download target file, and URL, for example.

In S126, the mobile terminal 1B causes WiGig operation to start (FIG. 23B, OP91). In S127, a WiGig connection sequence is performed between mobile terminal 1B and the WiGig AP 4 (FIG. 23B, OP92). In S128, the mobile terminal 1B transmits a download request (FIG. 23B, OP93).

On the other hand, in S129, the controller 5 receives the download start notice from the mobile terminal 1B (FIG. 11B, OP36: YES) and determines that a file related to the terminal identification information of the mobile terminal 1B is not present in the download data cache 54 (FIG. 11B, OP37: NO). In S130, the controller 5 transmits a download request of a target file to a server corresponding to the URL included in the download start notice (FIG. 11B, OP38).

In S131, the controller 5 completes downloading of the file. In S132, the controller 5 identifies the BLE terminal 3B associated with the terminal identification information of the mobile terminal 1B in the download data cache 54 and identifies the WiGig AP 4 associated with the BLE terminal 3B identified in the BLE-WiGig association table 55B. The controller 5 transmits the downloaded file to the identified WiGig AP 4 (FIG. 11, OP38).

In S133, the WiGig AP 4 receives the file from the controller 5 (FIG. 12, OP41) and transmits the file to the mobile terminal 1B (FIG. 12, OP42: YES, OP43).

After S134, similar to S104 and subsequent steps in FIG. 26B, when downloading of the file completes, WiGig operation of the mobile terminal 1B is stopped (S104). When a BLE beacon is no longer received, the WiGig area determination flag 192 is set to 0 (S109). When the mobile terminal 1B exits from the possible communication range of the WiFi AP 2, Bluetooth reception operation of the mobile terminal 1B is stopped (S110).

<Operation and Effect of Second Embodiment> In the second embodiment, the mobile terminal 1B broadcasts a BLE beacon, and the BLE terminal 3B configured to receive a BLE beacon is arranged at an almost same position as the WiGig AP 4. Since power consumption of broadcast operation of a BLE beacon is smaller than Bluetooth reception operation, power consumption of the mobile terminal 1B may be further reduced.

<Variation of Second Embodiment> In a variation of the second embodiment, similar to the variation of the first embodiment, caching of a target file to the WiGig AP 4 is performed in a step-by-step manner, according to “Far” or “Near”, which is a distance state of the mobile terminal 1B with the BLE terminal 3B. In the variation of the second embodiment, a system configuration of the communication system 100B as well as a hardware configuration and a functional configuration of each device are similar to the second embodiment.

In the variation of the second embodiment, based on received signal strength of a BLE beacon from the mobile terminal 1B, the BLE terminal 3B determines whether a distance from the mobile terminal 1B is “Far” or “Near”. The BLE terminal 3B notifies the controller 5 of a distance state with the mobile terminal 1B. When the distance state of the mobile terminal 1B with the BLE terminal 3B, which is notified by the BLE terminal 3B, is “Far”, the controller 5 transmits a target file to the WiGig AP 4 and causes the WiGig AP 4 to cache the target file.

When the distance state of the mobile terminal 1B with the BLE terminal 3B, which is notified by the BLE terminal 3B, is “Near”, the controller 5 notifies the mobile terminal 1B a WiGig service environment notice notifying that the mobile terminal 1B is in the possible communication range of the WiGig AP 4. Similar to the second embodiment, when receiving the WiGig service environment notice notifying that the mobile terminal 1B is in the possible communication range of the WiGig AP 4, the mobile terminal 1B causes WiGig operation to start and starts downloading of the target file.

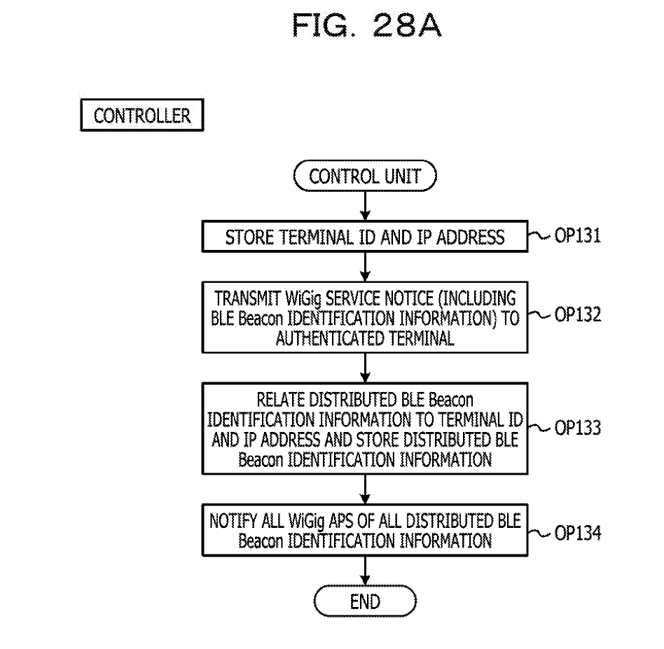

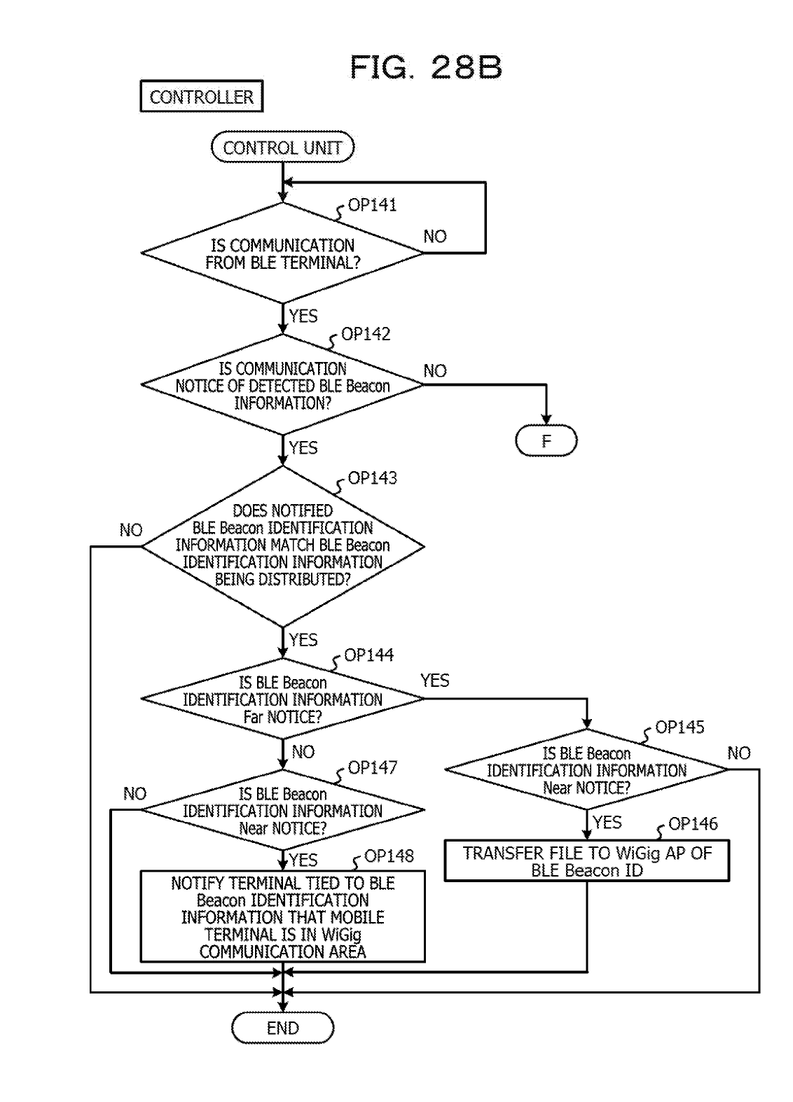

FIG. 28A is an example of a flow chart of processing to be performed by the controller 5 according to the variation of the second embodiment after authentication of the mobile terminal 1B is completed. Processing illustrated in FIG. 28A is started when authentication of the mobile terminal 1B succeeds.

Processing from OP131 to OP133 is similar to the processing from OP101 to OP103 in FIG. 24A. The control unit 51 stores information on the mobile terminal 1B authentication of which succeeds and transmits a WiGig service environment notice to the mobile terminal 1B.

In OP134, the control unit 51 notifies the BLE terminal 3B of the communication system 100B of all BLE beacon identification information distributed to mobile terminal 1B in the communication system 100B. Then, processing illustrated in FIG. 28A ends.

FIG. 28B is an example of a flow chart of processing of the controller 5 according to the variation of the second embodiment when receiving communication from the BLE terminal 3B. Processing illustrated in FIG. 28B is started when the controller 5 receives communication from the BLE terminal 3B.

In OP141, the control unit 51 waits for communication from the BLE terminal 3B. When the control unit 51 receives the communication from the BLE terminal 3B (OP141: YES), processing proceeds to OP142.

In OP142, the control unit 51 determines whether or not the communication from the BLE terminal 3B is a notice of BLE beacon identification information newly detected by the BLE terminal 3B. The notice of the BLE beacon identification information newly detected by the BLE terminal 3B includes a distance state for the mobile terminal 1B. When the communication from the BLE terminal 3B is the notice of the BLE beacon identification information newly detected by the BLE terminal 3B (OP142: YES), processing proceeds to OP143. Then, the control unit 51 registers an IP address of the BLE terminal 3B of a notification source in an entry that matches the received BLE beacon identification information in an index of the download data cache 54. When the communication from the BLE terminal 3B is not the notice of the BLE beacon identification information newly detected by the BLE terminal 3B (OP142: NO), processing to OP117 in FIG. 24B.

Processing from OP143 to OP148 is processing when the notice of the BLE beacon identification information newly detected by the BLE terminal 3B is received. In OP143, the control unit 51 determines whether or not the BLE beacon identification information notified by the BLE terminal 3B matches BLE beacon identification information being distributed to the mobile terminal 1B. The BLE beacon identification information being distributed to the mobile terminal 1B is stored in an index of the download data cache 54. When the BLE beacon identification information notified by the BLE terminal 3B matches the BLE beacon identification information being distributed to the mobile terminal 1B (OP143: YES), processing proceeds to OP144. When the BLE beacon identification information notified by the BLE terminal 3B does not match the BLE beacon identification information being distributed to the mobile terminal 1B (OP143: NO), processing illustrated in FIG. 28B ends.

In OP144, the control unit 51 determines whether a distance state included in the received notice of the BLE beacon identification information is “Far”. When the distance state included in the received notice of the BLE beacon identification information is “Far” (OP144: YES), processing proceeds to OP145. When the distance state included in the received notice of the BLE beacon identification information is not “Far” (OP144: NO), processing proceeds to OP147.

OP145 and OP146 are processing when the distance state is “Far”. In OP145, the control unit 51 identifies terminal identification information related to BLE beacon identification information that matches the BLE beacon identification information received from the BLE terminal 3B, in the index of the download data cache 54. The control unit 51 determines whether or not a file related to the identified terminal identification information is stored in the download data cache 54. When the file related to the identified terminal identification information is stored in the download data cache 54 (OP145: YES), processing proceeds to OP146. When the file related to the identified terminal identification information is not present in the download data cache 54 (OP145: NO), processing illustrated in FIG. 28B ends.

In OP146, the control unit 51 transmits the file related to the identified terminal identification information to the WiGig AP 4 associated with the BLE terminal 3B, which is the notification source of the BLE beacon identification information. The WiGig AP 4 associated with the BLE terminal 3B is identified based on the BLE-WiGig association table 55B. Then, processing illustrated in FIG. 28B ends.

In OP147, the control unit 51 determines whether or not a distance state included in the notice of the received BLE beacon identification information is “Near”. When the distance state included in the notice of the received BLE beacon identification information is “Near” (OP147: YES), processing proceeds to OP148. When the distance state included in the notice of the received BLE beacon identification information is not “Near” (OP147: NO), processing illustrated in FIG. 28B ends.

In OP148, the control unit 51 identifies terminal identification information related to BLE beacon identification information that matches the BLE beacon identification information received from the BLE terminal 3B, in the index of the download data cache 54. The control unit 51 transmits a WiGig area notice notifying that the mobile terminal 1B is in the possible communication range of the WiGig AP 4 to the mobile terminal 1B associated with the identified terminal identification information. Then, processing illustrated in FIG. 28B ends.

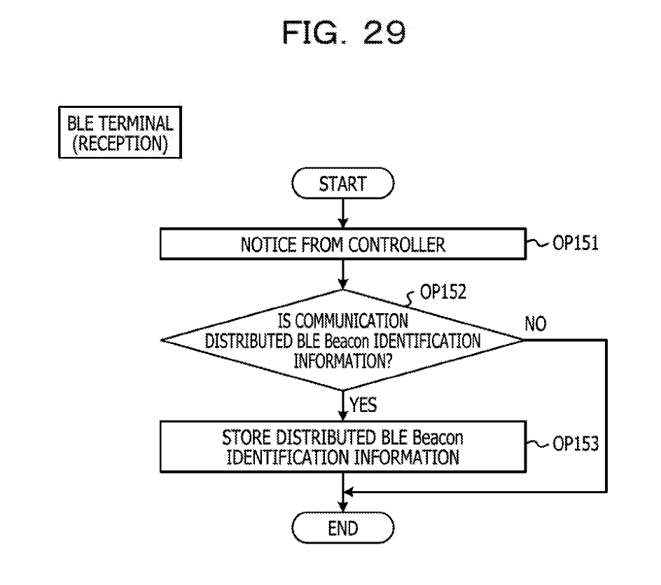

FIG. 29 is a flow chart of processing of the BLE terminal 3B according to the variation of the second embodiment when receiving communication from the controller 5. Processing illustrated in FIG. 29 is started when the BLE terminal 3B receives communication from the controller 5.

In OP151, the BLE reception control unit 32 receives communication from the controller 5. In OP152, the BLE reception control unit 32 determines whether or not the communication from the controller 5 is a notice of distributed BLE beacon identification information. When the communication from the controller 5 is the notice of the distributed BLE beacon identification information (OP152: YES), processing proceeds to OP153. When the communication from the controller 5 is not the notice of the distributed BLE beacon identification information (OP152: NO), processing illustrated in FIG. 29 ends.

In OP153, the BLE reception control unit 32 stores in a non-volatile memory the distributed BLE beacon identification information that is received. Then, processing illustrated in FIG. 29 ends.

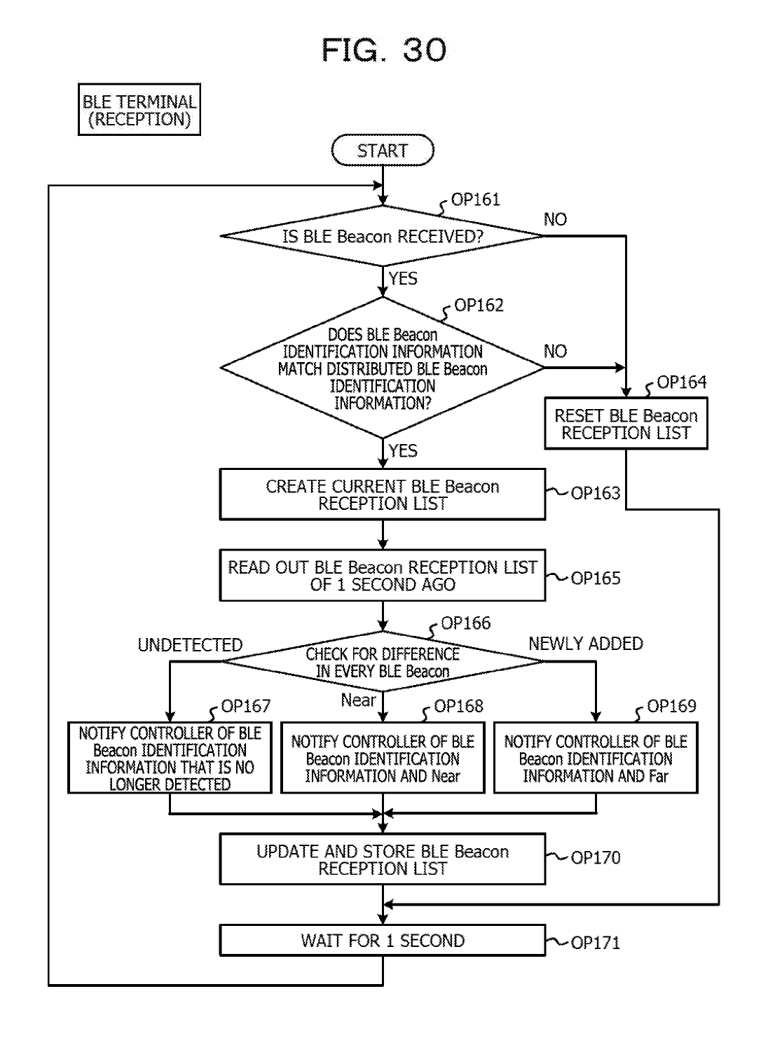

FIG. 30 is an example of a flow chart of processing of the BLE terminal 3B according to the variation of the second embodiment when receiving a BLE beacon. Processing illustrated in FIG. 30 is started when the BLE terminal 3B receives a BLE beacon.

In OP161, the BLE reception control unit 32 waits for reception of a BLE beacon. When the BLE reception control unit 32 detects reception of a BLE beacon (OP161: YES), processing proceeds to OP162. When the BLE reception control unit 32 does not detect reception of a BLE beacon even after a predetermined time elapses (OP161: NO), processing proceeds to OP164. A waiting time for detection of reception of a BLE beacon is 1 second, for example. In addition, when receiving a BLE beacon, the BLE terminal 3B determines from received signal strength whether the distance state is “Far” or “Near”.

In OP162, the BLE reception control unit 32 determines whether or not BLE beacon identification information included a BLE beacon received while waiting matches the distributed BLE beacon identification information. When there is any BLE beacon identification information that is included in the BLE beacon received while waiting and that matches the distributed BLE beacon identification information (OP162: YES), processing proceeds to OP163. When there is no BLE beacon identification information that is included in the BLE beacon received while waiting and that matches the distributed BLE beacon identification information (OP162: NO), processing proceeds to OP164.

In OP163, the BLE reception control unit 32 creates a current BLE beacon reception list with distributed BLE beacon identification information of received BLE beacons. A BLE beacon reception list is stored in a RAM of the BLE terminal 3B, for example. In the variation of the second embodiment, BLE beacon identification information and distance state are recorded in the BLE beacon reception list.

In OP164, since there is no BLE beacon that is received while waiting and that includes BLE beacon identification information that matches the distributed BLE beacon identification information, the BLE reception control unit 32 resets the BLE beacon reception list. Then, processing proceeds to OP171. The fact that there is no BLE beacon that is received while waiting and that includes BLE beacon identification information that matches the distributed BLE beacon identification information indicates that no mobile terminal 1B using WiGig service is present in a signal receivable range of the BLE terminal 3B.

In OP165, the BLE reception control unit 32 reads out a BLE beacon reception list of 1 second ago. In OP166, from the BLE beacon reception list of 1 second ago and the current BLE beacon reception list, the BLE reception control unit 32 checks for a difference in respective BLE beacon identification information.

For BLE beacon identification information that is included in the BLE beacon reception list of 1 second ago and not included in the current BLE beacon reception list (OP166: Undetected), the processing in OP167 is performed. In OP167, the BLE reception control unit 32 notifies the controller 5 the BLE beacon identification information that is included in the BLE beacon reception list of 1 second ago and not included in the current BLE beacon reception list, as BLE beacon identification information that is no longer detected.

For BLE beacon identification information for which distance state is “Far” in the BLE beacon reception list of 1 second ago and for which the distance state is “Near” in the current BLE beacon reception list (OP166: Near), the processing in OP168 is performed. In OP168, the BLE reception control unit 32 notifies the controller 5 of the corresponding BLE beacon identification information and the distance state “Near”.

For BLE beacon identification information that is not included in the BLE beacon reception list of 1 second ago and included in the BLE current beacon reception list (OP166: Newly added), the processing in OP169 is performed. In OP169, the BLE reception control unit 32 notifies the controller 5 of the corresponding BLE beacon identification information as newly detected BLE beacon identification information.

In OP170, the BLE reception control unit 32 stores the current BLE beacon reception list. Then, the BLE beacon reception list is stored by overwriting.

In OP171, the BLE reception control unit 32 waits for 1 second. Then, processing proceeds to OP161. In OP161, if a BLE beacon is received while the BLE reception control unit 32 is waiting for 1 second (OP161: YES), a current BLE beacon reception list is created for the received BLE beacon. In OP161, if a BLE beacon is not received while the BLE reception control unit 32 is waiting for 1 second (OP161: NO), processing proceeds to OP164.

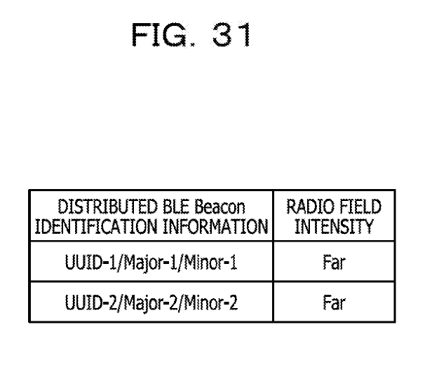

FIG. 31 is an example of a BLE beacon reception list according to the variation of the second embodiment. The BLE beacon reception list stores BLE beacon identification information that is received by the BLE terminal 3B and that matches BLE beacon identification information distributed by the controller 5 and distance state.

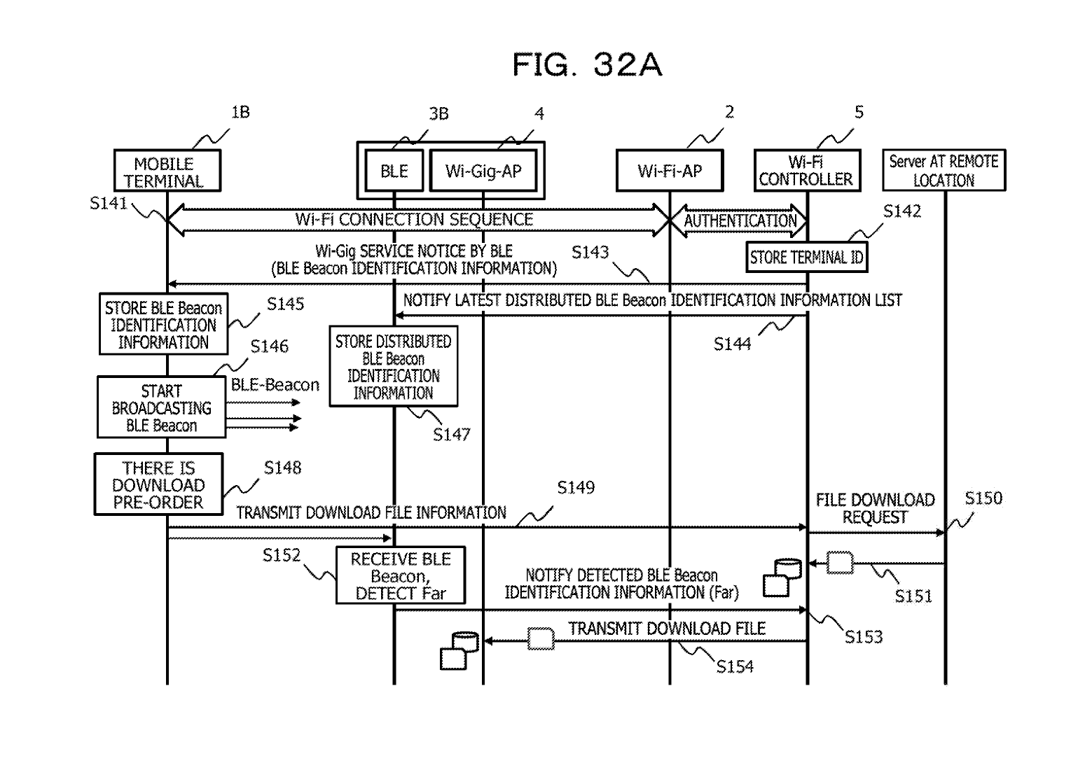

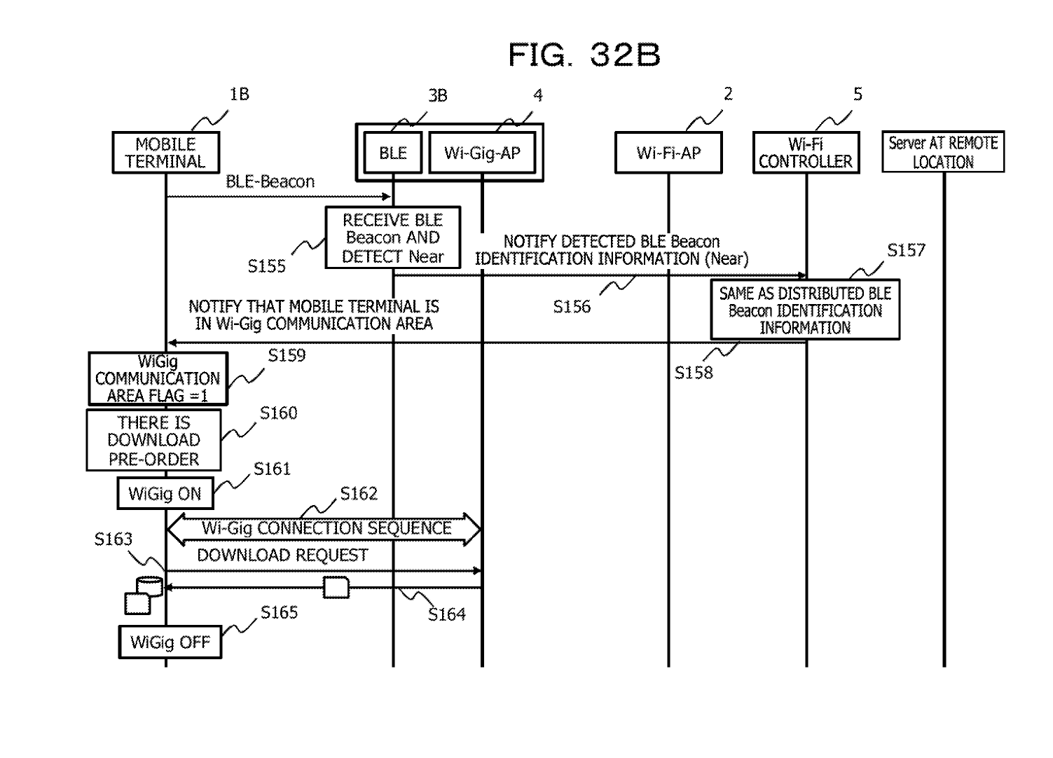

FIGS. 32A and 32B are a diagram illustrating an example of a sequence of a service provision process of the communication system 100B according to the variation of the second embodiment. FIGS. 32A and 32B illustrate an example of a case in which download pre-order is set for the mobile terminal 1B.

In S141, a connection sequence is performed between the mobile terminal 1B and the WiFi AP 2. In this connection sequence, authentication of the mobile terminal 1B is performed by the controller 5.

In S142, the controller 5 performs an authentication process based on an authentication request of the mobile terminal 1B, relates terminal identification information of the mobile terminal 1B to an IP address, and stores the terminal identification information and the IP address in the download data cache 54 (FIG. 28A, OP131).

In S143, the controller 5 transmits a WiGig service environment notice to the mobile terminal 1B (FIG. 28A, OP132). The WiGig service environment notice includes BLE beacon identification information that the mobile terminal 1B is allowed to use. The controller 5 relates BLE beacon identification information distributed to the mobile terminal 1B to the terminal identification information and the IP address of the mobile terminal 1B, and stores the BLE beacon identification information in an index of the download data cache 54 (FIG. 28A, OP133).

In S144, the controller 5 notifies all BLE terminals 3B in the communication system 100B of all distributed BLE beacon identification information (FIG. 28A, OP134). In S145, the BLE terminal 3B stores the distributed BLE beacon identification information that is received from the controller 5 (FIG. 29, OP153).

In S146, the mobile terminal 1B stores in the information storage unit 19 BLE beacon identification information included in the WiGig service environment notice that is received from the controller 5, as BLE beacon identification information 191 (FIG. 23A, OP83).

In S147, the mobile terminal 1B causes broadcast operation of a BLE beacon to start (FIG. 23A, OP84). A BLE beacon broadcasted from the mobile terminal 1B includes the BLE beacon identification information 191, more specifically, BLE beacon identification information notified by the WiGig service environment notice.

In S148, the mobile terminal 1B determines that download pre-order is set (FIG. 23A, OP85: YES). In S149, the mobile terminal 1B transmits download file information to the controller 5 (FIG. 23A, OP86). The download file information includes a file name of a file for which download pre-order is set, and a URL. The download file information is transmitted by way of WiFi since the mobile terminal 1B establishes connection with the WiFi AP 2.

In S150, the controller 5 receives the download file information from the mobile terminal 1B (FIG. 11B, OP34: YES) and transmits a download request of a target file to a corresponding server of the URL included in the download file information (FIG. 11B, OP35). In S151, the controller 5 receives a target file from the corresponding server, associates the target file with the terminal identification information and the IP address of the mobile terminal 1B and the distributed BLE beacon, and stores the target file in the download data cache 54 (FIG. 11B, OP35).

In S152, the user of the mobile terminal 1B moves to a direction approaching the BLE terminal 3B. When the BLE terminal 3B is included in a Far area of the mobile terminal 1B, the BLE terminal 3B receives a BLE beacon broadcasted from the mobile terminal 1B (FIG. 30, OP161: YES). In addition, the mobile terminal 1B determines that a distance state is “Far”. The BLE terminal 3B does not receive a BLE beacon from anything other than the mobile terminal 1B.

In S153, the BLE beacon terminal 3B notifies the controller 5 of BLE beacon identification information included in the BLE beacon received as newly detected BLE beacon identification information and the distance state “Far” (FIG. 30, OP169).

In S154, the controller 5 transmits to the WiGig AP 4 a file associated with the received BLE beacon identification information (FIG. 28B, OP144: YES, OP145: YES, OP146).

In S155 of FIG. 32B, the user of the mobile terminal 1B moves to a direction further approaching the BLE terminal 3B. When the BLE terminal 3B is included in a Near area of the mobile terminal 1B, the BLE terminal 3B determines that a distance state with the mobile terminal 1B is “Near”.

In S156, the BLE beacon terminal 3B notifies the controller of BLE beacon identification information included in the received BLE beacon and the distance state “Near” (FIG. 30, OP168).

In S157, the controller 5 determines that the received BLE beacon identification information is distributed (FIG. 28B, OP143: YES). In S158, the controller 5 transmits to the mobile terminal 1B a WiGig area notice notifying that the mobile terminal 1B is in the possible communication range of the WiGig AP 4 (FIG. 28B, OP147: YES, OP148).

In S159, since the mobile terminal 1B receives the WiGig area notice notifying that the mobile terminal 1B is in the possible communication range of the WiGig AP 4 (FIG. 23B, OP87: In area), the mobile terminal 1B sets the WiGig area determination flag 192 to 1 (FIG. 23B, OP88).

In S160, the mobile terminal 1B determines that download pre-order is set (FIG. 23B, OP89: YES). In S161, the mobile terminal 1B WiGig operation to start (FIG. 23B, OP91). In S162, a WiGig connection sequence is performed between the mobile terminal 1B and the WiGig AP 4 (FIG. 23B, OP92). In S163, the mobile terminal 1B transmits a download request (FIG. 23B, OP93).

In S164, the WiGig AP 4 receives the download request from the mobile terminal 1B (FIG. 13, OP51) and transmits to the mobile terminal 1B a file related to the IP address of the mobile terminal 1B in the cache (FIG. 13, OP52: YES, OP53).

In S165, downloading of the file is completed, and the mobile terminal 1B stops the WiGig operation (FIG. 23B, OP94).

According to the variation of the second embodiment, even when the mobile terminal 1B broadcasts a BLE beacon and the BLE terminal 3B receives the BLE beacon, a file download process may be performed in a step-by-step manner, depending on “Far” or “Near”, a distance of the mobile terminal 1B with the BLE terminal 3B. In addition, power consumption of the mobile terminal 1B may be further reduced.

Note that in the second embodiment, the mobile terminal 1B has a function to broadcast a BLE beacon. Even if the mobile terminal 1B does not have the function to broadcast a BLE beacon, the second embodiment may be embodied by connecting and linking a BLE terminal having the function to broadcast a BLE beacon and the mobile terminal 1B through Bluetooth.

<Others> In the first embodiment and the second embodiment are described the communication systems in which a combination of WiFi, WiGig, and BLE is adopted as a wireless communication scheme. A combination of wireless communication schemes that the communication system 100A and the communication system 100B may adopt is not limited to WiFi, WiGig, and BLE. The communication system 100A and the communication system 100B may adopt a combination of a cellular wireless communication scheme such as 4G or 5G in place of WiFi, WiGig, and BLE. In this case, the embodiments may be implemented by causing a small cell base station associated with 4G or 5G to have the capability of the WiFi AP 2 and the controller 5.

In addition, in place of WiGig and BLE, a high-speed wireless communication scheme and an energy-saving wireless communication scheme with size of a possible communication range being about a few meters to 10 meters may be adopted.

<Recording Medium> A program that causes a computer, other machines, or devices (hereinafter referred to as a computer or the like) to implement any of the functions described above may be recorded in a recording medium that is readable by the computer or the like. The functions may be provided by causing the computer or the like to read and execute a program of the recording medium.

Here, a computer readable recording medium refers to a non-transitory recording medium that may accumulate information such as data or a program or the like through electric, magnetic, optical, mechanical, or chemical action and read the information from a computer or the like. Of such recording media, recording media that are removable from a computer or the like include, for example, a flexible disk, a magnetic optical disk, a CD-ROM, a CD-R/W, a DVD, a blue ray disk, a DAT, an 8mm-tape, a memory card such as a flash memory, or the like. In addition, recording media fixed in a computer or the like includes a hard disk, a read only memory (ROM) or the like. In addition, a solid state drive (SSD) may also be used as a recording medium fixed to a computer or the like, also as a recording medium that may be removed from a computer or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention. For example, the steps recited in any of the method or process descriptions may be executed in any order and are not limited to the order presented.

What is claimed is:

1. A communication system comprising:
a mobile terminal;
a first relay device configured to communicate via a first wireless communication scheme; and
a transmitter configured to form a signal reachable range set such that the signal reachable range coincides with a possible communication range of the first relay device, via a third wireless communication scheme, and to broadcast a signal including identification information; and
wherein the mobile terminal comprises:
a first communication circuit configured to connect with the first relay device via the first wireless communication scheme;
a third communication circuit configured to receive a signal including the identification information used by the transmitter via the third wireless communication scheme; and
a control circuit configured to instruct the first communication circuit to start operation, when the signal including the identification information used by the transmitter is received via the third wireless communication scheme.

2. The communication system according to claim 1, further comprising:
a second relay device configured to form a possible communication range encompassing the possible communication range of the first relay device and the signal reachable range of the transmitter, via a second wireless communication scheme, and to transmit the identification information used by the transmitter to the mobile terminal via the second wireless communication scheme,
wherein the mobile terminal further comprises:
a second communication circuit configured to receive the identification information used by the transmitter via the second wireless communication scheme;
wherein the control circuit of the mobile terminal is configured to instruct the first communication circuit to start operation, when the identification information included in the signal received via the third wireless communication scheme matches the identification information included in the signal received via the second wireless communication scheme.

3. The communication system according to claim 1,
wherein the control circuit of the mobile terminal is configured to instruct the first communication circuit to stop the operation when reception of a download target file via the first wireless communication scheme is completed.

4. The communication system according to claim 1,
wherein the control circuit of the mobile terminal is configured to instruct the third communication circuit to start signal reception operation via the third wireless communication scheme, when the identification information of the transmitter is received via the second wireless communication scheme.

5. The communication system according to claim 4,
wherein the control circuit of the mobile terminal is configured to instruct the third communication circuit to stop the reception operation when connection with the second relay device via the second wireless communication scheme is disconnected.

6. The communication system according to claim 1,
wherein the control circuit of the mobile terminal configured to instruct the first communication circuit to start downloading of a download target file, when the signal including the identification information of the transmitter is received via the third wireless communication scheme and information on the file is inputted in the received signal.

7. The communication system according to claim 1, further comprising:
a management device configured to transmit the identification information to the mobile terminal,
wherein the control circuit of the mobile terminal is configured to transmit to the management device a download start notice for a download target file, when the signal including the identification information used by the transmitter is received via the third wireless communication scheme and information on the file is included in the received signal,
the management device is configured to transmit the file to the first relay device when receiving the download start notice for the file, and
the first relay device is configured to receive the file and transmit the file to the mobile terminal via the first wireless communication scheme.

8. The communication system according to claim 1, further comprising:
a management device configured to transmit the identification information used by the transmitter to the mobile terminal,
wherein the mobile terminal further comprises a storage circuit configured to store information on a download target file,
wherein the control circuit is configured to
detect the mobile terminal entering a first range of a first distance or shorter from the transmitter, and a second range of a second distance or shorter from the transmitter, based on received signal strength of the signal including the identification information of the transmitter that is received via the third wireless communication scheme, the second distance being shorter than the first distance,
transmit to the management device a download start notice for the file when detecting the mobile terminal entering the first range,
when detecting the mobile terminal entering the second range, instruct the first communication circuit to start downloading of the file and cause the first communication circuit to receive the file from the first relay device via the first wireless communication scheme,
wherein the management device is configured to transmit the file to the first relay device when receiving the download start notice for the file, and
wherein the first relay device is configured to receive the file from the management device and transmit the file to the mobile terminal.

9. A communication system comprising:
a mobile terminal;
a first relay device configured to communicate via a first wireless communication scheme;
a second relay device configured to form a possible communication range encompassing a possible communication range of the first relay device via a second wireless communication scheme and to transmit to the mobile terminal identification information that identifies a broadcast source of a signal via a third wireless communication scheme;
a receiver configured to receive a signal including the identification information via the third wireless communication scheme in a signal detectable range that is encompassed by the possible communication range of the second relay device and is set to coincide with the possible communication range of the first relay device, and to transmit the identification information included in the received signal to a management device; and
the management device configured to transmit the identification information of the broadcast source of the signal via the third wireless communication scheme to the mobile terminal, and to transmit to the mobile terminal a notice that a current position is in the possible communication range of the first relay device, when the identification information received from the receiver matches the identification information transmitted to the mobile terminal,
wherein the mobile terminal comprises:
a first communication circuit configured to connect with the first relay device via the first wireless communication scheme;
a second communication circuit configured to receive, via the second wireless communication scheme, the identification information of the broadcast source of the signal via the third wireless communication scheme and the notice that the current position is in the possible communication range of the first relay device;
a third communication circuit configured to broadcast a signal including the received identification information via the third wireless communication scheme; and
a control circuit configured to instruct the first communication circuit to start operation when the notice that the current position is in the possible communication range of the first relay device is received from the management device.

10. The communication system according to claim 9,
wherein the control circuit of the mobile terminal instructs the first communication circuit to stop the operation when reception of a download target file via the first wireless communication scheme is completed.

11. The communication system according to claim 9,
wherein the control circuit of the mobile terminal instructs the third communication circuit to start broadcast operation of a signal via the third wireless communication scheme, when the identification information of the broadcast source of the signal via the third wireless communication scheme is received via the second wireless communication scheme.

12. The communication system according to claim 11,
wherein the control circuit instructs the third communication circuit to stop the broadcast operation, when connection with the second relay device via the second wireless communication scheme is disconnected.

13. The communication system according to claim 9,
wherein the control circuit of the mobile terminal instructs the first communication circuit to start downloading of a download target file, when a notice that a current position is in the possible communication range of the first relay device is received via the second wireless communication scheme from the management device, and information on the file is inputted.

14. The communication system according to claim 9,
wherein the control circuit of the mobile terminal transmits a download start notice for a download target file to the management device, when a notice that a current position is in the possible communication range of the first relay device is received via the second wireless communication scheme from the management device, and information on the file is inputted,
the management device transmits the file to the first relay device when receiving the download start notice for the file, and
the first relay device receives the file and transmits the file to the mobile terminal via the first wireless communication scheme.

15. The communication system according to claim 9,
wherein the mobile terminal further comprises a storage circuit configured to store information on a download target file,
the control circuit transmits a download start notice for the file to the management device via the second wireless communication scheme,
the receiver detects whether a distance from the mobile terminal is in a first range or a second range based on received signal strength of a signal from the mobile terminal via the third wireless communication scheme, and transmits the detection result to the management device, the first range being of a distance equal to or longer than a second distance but shorter than a first distance, the second range being of a distance shorter than the second distance, and
the management device transmits the file to the first relay device when the distance between the receiver and the mobile terminal is in the first range, and transmits to the mobile terminal a notice that a current position is in the possible communication range of the first relay device when detecting the distance between the receiver and the mobile terminal changing from the first range to the second range.

16. A mobile terminal comprising:
a first communication circuit configured to connect with a first relay device via a first wireless communication scheme;
a third communication circuit configured to receive a signal from a transmitter forming a signal reachable range that is set to coincide with a possible communication range of the first relay device via a third wireless communication scheme, the signal including identification information used by the transmitter; and
a control circuit configured to instruct the first communication circuit to start operation, when the signal including the identification information of the transmitter via the third wireless communication scheme is received.

17. The mobile terminal according to claim 16, further comprising:
a second communication circuit configured to receive, via a second wireless communication scheme, and
wherein the control circuit of the mobile terminal is configured to instruct the first communication circuit to start operation, when the identification information included in the signal received via the third wireless communication scheme matches the identification information included in the signal received via the second wireless communication scheme.

18. A mobile terminal comprising:
a first communication circuit configured to connect with a first relay device via a first wireless communication scheme;
a second communication circuit configured to receive, via a second wireless communication scheme from a second relay device, identification information via a third wireless communication scheme;
a third communication circuit configured to broadcast a signal including the identification information received by the second communication circuit, via the third wireless communication scheme; and
a control circuit configured to instruct the first communication circuit to start operation, when a notice that a current position is in a possible communication range of the first relay device is received from a management device via the second wireless communication scheme,
wherein the management device is configured to transmit to the mobile terminal the identification information via the third wireless communication scheme, and transmit the notice that the current position is in the possible communication range of the first relay device, when the identification information of the broadcast source received from the receiver matches the transmitted identification information,
the receiver is configured to receive, via the third wireless communication scheme, a signal including the identification information in a signal detectable range that is encompassed by a possible communication range of the second relay device and is set to coincide with the possible communication range of the first relay device, and transmit to the management device the identification information included in the received signal, and
the second relay device forms the possible communication range encompassing the possible communication range of the first relay device and a signal detectable range of the receiver.

19. A communication method implemented in a communication system, the method comprising:
under control of a transmitter of the communication system,
forming a signal reachable range set to coincide with a possible communication range of a first relay device that communicates via a first wireless communication scheme, and
broadcasting a signal including identification information of a broadcast source via a third wireless communication scheme;
under control of a second relay device of the communication system,
forming a possible communication range encompassing the possible communication range of the first relay device and the signal reachable range of the transmitter, in accordance with a second wireless communication scheme, and
transmitting to the mobile terminal identification information used by the transmitter, via the second wireless communication scheme; and
under control of the mobile terminal of the communication system,
receiving the identification information used by the transmitter via the second wireless communication scheme, and
instructing the first communication circuit connected with the first relay device via the first wireless communication scheme to start operation, when receiving a signal including the identification information used by the transmitter via the third wireless communication scheme.

20. A communication method implemented in a communication system, the method comprising:
under control of a second relay device of the communication system,
forming a possible communication range in accordance with a second wireless communication scheme, the possible communication range encompassing a possible communication range of a first relay device that communicates via a first wireless communication scheme, and
transmitting to a mobile terminal identification information that identifies a broadcast source of a signal via a third wireless communication scheme;
under control of a receiver of the communication system,
receiving a signal including the identification information via the third wireless communication scheme in a signal detectable range that is encompassed by the possible communication range of the second relay device and set to coincide with the possible communication range of the first relay device, and
transmitting the identification information included in the received signal to a management device,
under control of the management device of the communication system,
transmitting the identification information of the broadcast source of the signal via the third wireless communication scheme to the mobile terminal, and
transmitting to the mobile terminal a notice that a current position is in the possible communication range of the first relay device, when the identification information received from the receiver matches the identification information transmitted to the mobile terminal;
under control of the mobile terminal of the communication system,
receiving, via the second wireless communication scheme, the identification information of the broadcast source of the signal via the third wireless communication scheme, and the notice that the current position is in the possible communication range of the first relay device,
broadcasting a signal including the received identification information via the third wireless communication scheme, and
instructing a first communication circuit, which is connected with the first relay device via the first wireless communication scheme, to start operation, when a notice that a current position is in the possible communication range of the first relay device is received from the management device.
